(19) United States
(12) Patent Application Publication
(10) Pub. No.: US 2026/0289474 A1
(43) Pub. Date: Sep. 24, 2026

(54) System

(71) Applicant: Softbank Group Corp., Tokyo (JP)

(72) Inventor: Masahiko Hatakeyama, Tokyo (JP)

(21) Appl. No.: 19/083,692

(22) Filed: Mar. 19, 2025

(51) Int. Cl. G06Q 10/0639; G06V 40/16; G09B 5/06; G10L 15/18

(52) U.S. Cl. CPC G06Q 10/06398; G09B 5/065; G06V 40/174; G10L 15/18

(57) ABSTRACT

The system includes: first means for displaying information including work procedures, equipment images, and past accident cases on a smart glass worn by a worker; second means for receiving voice input from said worker regarding said work; third means for generating a prompt sentence for outputting the next work procedure based on the content of the voice input by said worker; fourth means for generating said next work procedure by inputting the generated prompt sentence into a generating AI model; and fifth means for generating said next work procedure by inputting said generated prompt sentence into said smart glass display. The third means for generating the next work procedure, the fourth means for generating the next work procedure by inputting the generated prompt sentence into a generative AI model, and the fifth means for displaying the generated next work procedure on the display of the smart glasses.

### TECHNICAL FIELD

The technology of this disclosure relates to a system.

### BACKGROUND TECHNOLOGY

JP 2022-180282 discloses a persona chatbot control method, carried out by at least one processor, comprising the steps of: receiving a user utterance; adding said user utterance to a prompt containing a description of the chatbot character and associated instructions The method is disclosed, including the steps of adding the prompt to a prompt, encoding said prompt, and inputting said encoded prompt into a language model to generate a chatbot utterance in response to said user utterance.

Currently, when some kind of work is performed at a facility, one operator and one checker (whether on-site or remotely) are required, and this creates a problem of manpower shortage and operational errors.

### SUMMARY

The system provides a system that learns in advance the information necessary for the work (procedures, equipment images, past accident cases, etc.), and when performing the work, by voice inputting the operation screen and procedures to be performed through the smart glasses, it judges whether the work is OK or NG and displays the answer on the smart glasses. This system reduces the number of personnel needed to check and prevents operational errors.

### BRIEF DESCRIPTION OF THE DRAWINGS

Exemplary embodiments of the present disclosure will be described in detail based on the following figures, wherein: a. The number of the present disclosure will be based on the number of the present disclosure.

FIG. 1 is a conceptual diagram showing an example of implement of a data processing system.

FIG. 2 is a conceptual diagram showing an example of the key functions of the data processing device and smart device of the first exemplary embodiment.

FIG. 3 is a conceptual diagram showing an example of implement of a data processing system for the second exemplary embodiment.

FIG. 4 is a conceptual diagram showing an example of the key functions of the data processing device and smart glasses of the second exemplary embodiment.

FIG. 5 is a conceptual diagram showing an example of implement of a data processing system for the third exemplary embodiment.

FIG. 6 is a conceptual diagram showing an example of the key functions of the data processing device and headset-type terminal for the third exemplary embodiment.

FIG. 7 is a conceptual diagram showing an example of implement of a data processing system for the fourth exemplary embodiment.

FIG. 8 is a conceptual diagram showing an example of the key functions of the data processing device and robot of the fourth exemplary embodiment.

FIG. 9 shows an emotion map where multiple emotions are mapped.

FIG. 10 shows an emotion map where multiple emotions are mapped.

FIG. 11 is a sequence diagram showing the flow of data processing system processing in Example 1 of implement example.

FIG. 12 is a sequence diagram showing the flow of data processing system processing in example of application 1 of example of implement.

FIG. 13 is a sequence diagram showing the flow of data processing system processing in Example 2 of implement example.

FIG. 14 shows the sequence of the data processing system in example of application 2 of example of implement.

FIG. 15 is a sequence diagram showing the flow of data processing system processing in Example 3 of implement example.

FIG. 16 is a sequence diagram showing the flow of data processing system processing in example of application 3 of implement.

FIG. 17 is a sequence diagram showing the flow of data processing system processing in Example 1 of embodiment when the emotional engine is combined.

FIG. 18 is a sequence diagram showing the flow of data processing system processing in example of application 1 of example of implement when combined with an emotion engine.

FIG. 19 is a sequence diagram showing the flow of data processing system processing in Example 2 of exemplary embodiment when the emotional engine is combined.

FIG. 20 is a sequence diagram showing the flow of data processing system processing in example of application 2 of example of implement when combined with an emotion engine.

FIG. 21 is a sequence diagram showing the flow of data processing system processing in Example 3 of exemplary embodiment when the emotional engine is combined.

FIG. 22 is a sequence diagram showing the flow of data processing system processing in example of application 3 of example of implement when combined with an emotion engine.

### DETAILED DESCRIPTION

The following is an example of implementations of systems for the technology of the present disclosure according to the accompanying drawings.

First, let us explain the wording used in the following description.

In the following exemplary embodiments, a signed processor (hereinafter simply referred to as “processor”) may be one arithmetic device or a combination of multiple arithmetic devices. The processor may be one type of computing device or a combination of multiple types of computing devices. An example of an arithmetic device is a CPU (Central Processing Unit),

GPU (Graphics Processing Unit), GPGPU (General-Purpose computing on Graphics Processing Units), APU (Accelerated Processing Unit), or TPU (Tensor PROCESSING UNIT (registered trademark)), etc.

In the following exemplary embodiment, signed RAM (Random Access Memory) is a memory in which information is temporarily stored and is used by the processor as work memory.

In the following exemplary embodiments, the signed storage is one or more non-volatile storage devices that store various programs and various parameters, etc. Examples of non-volatile storage devices include flash memory (SSD (Solid State Drive)), magnetic disks (e.g.,

(hard disk), or magnetic tape.

In the following exemplary embodiments, the signed communication interface (Interface) is a communication processor and

The interface includes a computer and an antenna, etc. Communication I/F is responsible for communication between multiple computers. Examples of communication standards applicable to the communication I/F include wireless communication standards including 5G (5th Generation Mobile Communication System), Wi-Fi (registered trademark), or Bluetooth (registered trademark).

In the following exemplary embodiments, “A and/or B” is synonymous with “at least one of A and B”. In other words, “A and/or B” means that it may be only A, only B, or a combination of A and B. The same concept as “A and/or B” also applies when three or more matters are expressed in this document by linking them together with “and/or”.

### First Exemplary Embodiment

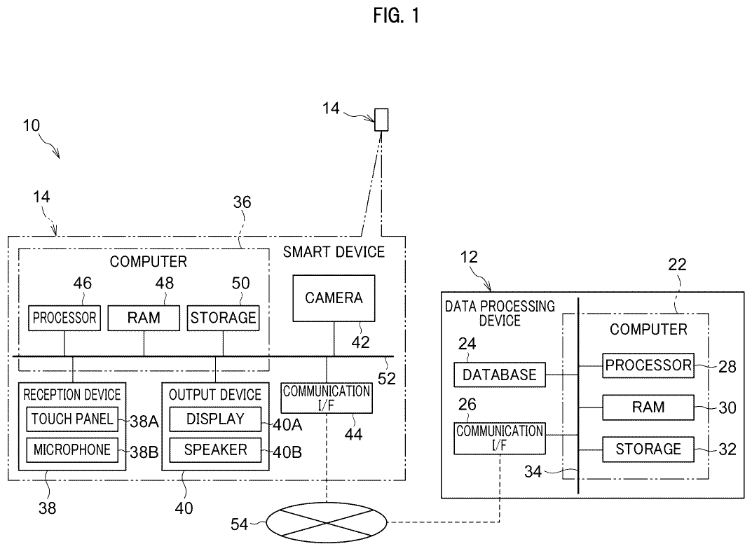

FIG. 1 shows an example of implement of a data processing system 10.

As shown in FIG. 1, data processing system 10 has data processing device 12 and smart device 14. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Smart device 14 has a computer 36, reception device 38, output device 40, camera 42, and communication I/F 44. The computer 36 has a processor 46, RAM 48, and storage 50. The processor 46, RAM 48, and storage 50 are connected to a bus 52. The reception device 38, output device 40, and camera 42 are also connected to the bus 52.

The reception device 38 is equipped with a touch panel 38A and a microphone 38B, etc., and is used by the user.

The touch panel 38A accepts user input. The touch panel 38A detects the touch of an indicating body (e.g., pen or finger) and accepts user input by the touch of an indicating body. Microphone 38B accepts user input by voice by detecting the user's voice. The control unit 46A transmits data indicating the user input accepted by the touch panel 38A and microphone 38B to the data processing device 12. In the data processing device 12, the specific processing unit 290 obtains the data indicating the user input.

The output device 40 is equipped with a display 40A and a speaker 40B, etc., and presents data to the user 20 by outputting the data in a form of representation (e.g., audio and/or text) that can be perceived by the user 20. Display 40A displays text, images, and other visible information in accordance with instructions from processor 46. Speaker 40B outputs audio in accordance with instructions from processor 46. Camera 42 has an optical system, such as a lens, aperture, and shutter, and a CMOS (Complementary Metal-Oxide-Semiconductor) image sensor or CC.

A compact digital camera equipped with an image sensor such as a 3D (Charge Coupled Device) image sensor and an image pickup device.

It is a camera.

The communication I/F 44 is connected to the network 54. The communication I/F 44 and 26 are responsible for transferring and receiving various types of information between the processor 46 and the processor 28 via the network 54.

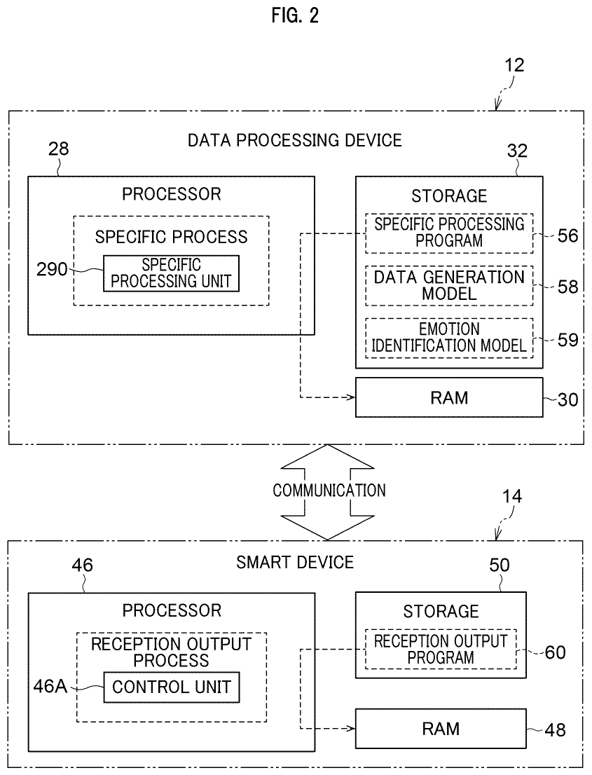

FIG. 2 shows an example of the key functions of data processing device 12 and smart device 14.

As shown in FIG. 2, specific processing is performed by processor 28 in data processing device 12. The specific processing program 56 is stored in the storage 32. The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executing on the RAM 30.

The data generation model 58 and emotion identification model 59 are stored in storage 32. The data generation model 58 and emotion identification model 59 are used by the specific processing unit 290.

In smart device 14, the reception output process is performed by processor 46. The reception output program 60 is stored in storage 50. The reception output program 60 is used by the data processing system 10 in conjunction with the specific processing program 56.

Processor 46 reads reception output program 60 from storage 50 and executes the read reception output program 60 on RAM 48. The reception output process is realized by the processor 46 operating as the control unit 46A according to the reception output program 60 executing on RAM 48.

Next, the specific processing by the specific processing unit 290 of the data processing device 12 is described.

### Example of Implement 1.″

One exemplary embodiment of this invention is a system in which workers wear smart glasses and learn in advance information such as work procedures, equipment images, and past accidents. The worker can view the operation screen through the smart glasses and can input voice instructions. The system determines whether work is OK or NG based on the worker's voice input and displays the results on the smart glasses' display.

### Example of Implement 2.″

As a concrete example, consider the case where a worker performs maintenance work on equipment. The worker wears the smart glasses and inputs the maintenance work procedure by voice. The system determines whether the input procedure is correct and displays the result on the Smart Glasses' display. In this way, the worker can proceed with the work while checking whether his/her work is correct.

### Example of Implement 3.″

The system can also use artificial intelligence to learn work information. The artificial intelligence learns patterns from past work data and accident cases, and judges whether work is OK/NG based on these patterns. This allows the system's judgment accuracy to improve over time, further enhancing worker work efficiency and safety.

The following is a description of the process flow for each example of implement.

### Example of Implement 1.″

Step 1: The worker wears the smart glasses.
Step 2: Smart glasses learn the information necessary for the work (procedures, equipment images, past accidents, etc.) in advance.
Step 3: The operator can view the operation screen through smart glasses and input instructions by voice.
Step 4: The system determines if the work is OK/NG based on the worker's voice input and displays the results on the smart glasses' display.

### Example of Implement 2.″

Step 1: When a worker performs maintenance work on equipment, he or she first puts on the smart glasses.
Step 2: The operator voice-enters the maintenance procedure.
Step 3: The system determines if the entered procedure is correct and displays the result on the smart glasses display.
Step 4: Workers proceed based on system feedback.

### Example of Implement 3.″

Step 1: The system learns work information using artificial intelligence.
Step 2: Artificial intelligence learns patterns from past work data and accident cases.
Step 3: Based on the learned patterns, the system determines if the work is OK/NG.
Step 4: The results of the decision are displayed on the smart glasses display, and the worker proceeds based on the feedback.

### Example 1

The following is an example of exemplary embodiment of implement. In the following description, data processing device 12 is referred to as the “server” and smart device 14 is referred to as the “terminal.

In conventional work support systems, it was difficult for workers to efficiently learn information such as procedures, equipment images, and past accident cases, and to receive appropriate instructions during work. There were also issues with the accuracy of voice input instructions and the speed of OK/NG decisions for work. This could reduce work efficiency and safety.

The specific processing by the specific processing unit 290 of the data processing device 12 in Example 1 is realized by the following means. In this invention, the server has the means to learn in advance the information necessary for the work (procedures, equipment images, past accident cases, etc.), the means to input the operation screen and the procedures to be performed by voice through the smart glasses when performing the work, the means to judge whether the work is OK or NG and display the answer on the smart glasses, the means to analyze the voice The system includes means to analyze the data and convert it to text, to generate prompt sentences using a generation AI model, and to judge whether the task is OK or NG. This enables the operator to efficiently learn information, improve the accuracy of voice input instructions, and quickly determine the OK/NG of work.

Information necessary for the work” refers to knowledge and data necessary to perform the work, such as procedures, equipment images, and past accident examples.

A “means of learning” is a method or device by which a worker learns in advance the information necessary to perform a task.

Smart glasses” are wearable devices that are worn by workers to display operational screens and information.

The “operation screen” is a screen displayed on the smart glasses that shows information such as work procedures and instructions.

A “means of voice input” is a method or device that allows a worker to input instructions or information using voice.

Means to determine OK/NG” is a method or device used to evaluate the progress or results of work and determine if it is appropriate or not.

Means for analyzing speech data and converting it to text” refers to methods and devices for converting speech data to text using speech recognition technology.

The “Generative AI Model” is a model that uses artificial intelligence to generate prompt sentences and determine if the work is OK/NG.

A “prompt sentence” is an instruction sentence to be input into the generated AI model, and is used as the basis for the OK/NG judgment of the work.

### Exemplary Embodiment of the Invention

This invention is a system in which workers wear smart glasses and learn information such as work procedures, equipment images, and past accident cases in advance. The worker can view the operation screen through the smart glasses and can input voice instructions. The system determines whether work is OK or NG based on the worker's voice input and displays the results on the smart glasses' display.

### 1. Program Generation

The server generates a program for workers to wear smart glasses to learn information such as work procedures, equipment images, and past accident cases in advance. This program includes a function that allows the worker to view the operation screen through the smart glasses and input instructions by voice.

### Explanation of Program Processing

The server installs the generated program in the smart glasses. When worn by a worker, the smart glasses display information such as work procedures, equipment images, and past accidents. The work contractor can view this information through the Smart Glasses' display.

When a worker inputs voice instructions, the smart glasses transmit the voice data to the server. The server converts the voice data into text using voice recognition software (e.g., speech recognition technology). It then uses a generative AI model (e.g., artificial intelligence model) to generate prompt sentences to determine whether the input instructions are OK/NG for the task.

The server inputs the generated prompt sentences to the AI model and obtains the results to determine if the work is OK/NG. The acquired results are sent to the smart glasses and displayed on the smart glasses' display.

### 3. Examples of Specific Examples and Prompt Sentences

As a concrete example, consider the case where a worker enters voice instructions, “Please tell me the next work procedure.” In this case, the server generates the following prompt sentence:

### Example of a Prompt Statement:

The worker wants to know what the next step is. “Please tell me what the next step is.”

The server inputs this prompt sentence to the generative AI model to retrieve the next work procedure. The retrieved work procedure is displayed on the smart glasses display.

In this way, workers can check information such as work procedures, equipment images, and past accident cases through smart glasses, and judge whether work is OK or NG by inputting voice instructions.

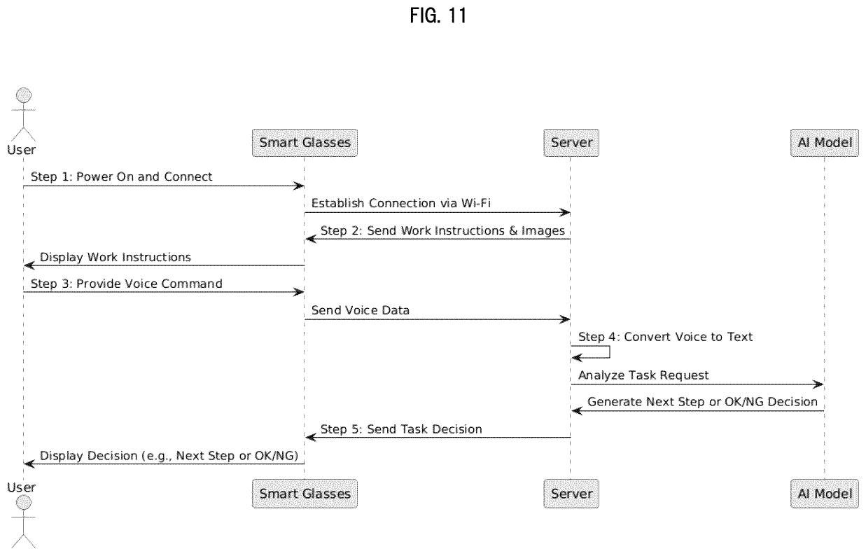

The flow of the identification process in Example 1 is described in FIG. 11.

### Step 1:

### Smart Glass Activation and Connection

The user puts on the smart glasses and turns them on.

The terminal (smart glasses) connects to the server through Wi-Fi.

Input: Smart Glass power on, Wi-Fi connection information

Output: Connection established with server

### Step 2:

### Display of Work Procedures and Information

The server recognizes the worker's ID and sends information such as related work procedures, equipment images, and past accidents to the smart glasses.

The terminal displays the received information on its display. For example, a list of work procedures and images of equipment are displayed.

Input: Worker's ID, relevant information

Output: Work procedures and equipment images displayed on smart glasses

### Step 3:

### Input of Voice Instructions

The user enters voice instructions into the smart glasses. For example, he/she says, “Please tell me the next step in the workflow.”

Input: User's voice instructions

Output: Audio data

### Step 4:

### Transmission and Analysis of Voice Data

The terminal sends the user's voice data to the server.

The server uses speech recognition software (e.g., speech recognition technology) to convert voice data into text.

Input: Voice data

Output: Text data

### Step 5:

### OK/NG Judgment of Work

The server generates prompt statements based on the converted text. For example, “The worker wants to know the next work procedure. Please tell me what the next step is.” The server generates the prompt sentence “The worker wants to know the next step.”

The server inputs this prompt statement to the generating AI model (e.g., artificial intelligence model) to obtain the next work procedure and the OK/NG decision for the work.

Input: text data, prompt statements

Output: Work procedures and OK/NG decisions

### Step 6:

### Display of Judgment Results

The server sends the retrieved results to the smart glasses.

The terminal displays the results received on its display. For example, “The next work step is to install part A.” or “The work is OK.” will be displayed.

Input: work procedures and OK/NG decisions

Output: Results displayed on smart glasses

### Example of Application 1

Next, example of application 1 of example of implement 1 will be described. In the following description, data processing device 12 will be referred to as the “server” and smart device 14 will be referred to as the “terminal.”

In conventional factory operations, workers spent a lot of time and effort to check procedures and equipment conditions. In addition, it was difficult to refer to past accident cases, and work safety was not sufficiently ensured. Furthermore, the lack of a means to report and properly evaluate the progress of work in real time reduced work efficiency. To solve these problems, there is a need for a system that enables workers to work efficiently and safely using smart glasses.

The specific processing by the specific processing unit 290 of the data processing device 12 in example of application 1 is realized by the following means.

In this invention, the server has means to learn in advance the information necessary for the work (procedures, equipment images, past accident cases, etc.), means to input the operation screen and the procedures to be performed by voice through the smart glasses when performing the work, means to judge whether the work is OK or NG and display the answer on the smart glasses, means to display the real-time status of the equipment The system includes means to display the real-time status of the equipment, means to display past accident cases and alert the operator, means to report the progress of the work based on voice input, means to judge whether the work is OK or NG based on the progress of the work, and means to display the results on the smart glasses display. This enables the worker to obtain the necessary information in real time and perform the work efficiently and safely.

“Information necessary for the work” refers to information necessary to perform the work, such as work procedures, equipment images, and past accident examples.

A “means of learning in advance” is a means of acquiring and understanding the information needed to perform a task in advance.

“Smart glasses” are eyeglass-shaped devices worn by workers to display information.

The “operation screen” is the interface that the operator can see through the smart glasses.

A “voice input means” is a means by which a worker inputs instructions or information using voice.

The “means to determine OK/NG” is a means to evaluate the progress and results of the work and to determine if they are appropriate or not.

The “means of displaying the answer on the smart glasses” is the means of displaying the judgment result on the display of the smart glasses.

“Means for displaying the real-time status of equipment” means a means for displaying the current status of equipment in real time.

The “means of displaying past accident cases and alerting the operator” is a means of displaying past accident cases and alerting the operator.

A “means for reporting work progress based on voice input” means a means for reporting work progress based on a worker's voice input.

The “means to determine whether work is OK/NG based on the progress of the work” is a means to evaluate the progress of the work and to determine whether the work is being performed properly.

The “means for displaying on the smart glasses display” is a means for displaying the judgment results and other information on the smart glasses display.

The system for implementing this invention allows workers to wear smart glasses and check information such as work procedures, equipment conditions, and past accidents in real time. An exemplary embodiment of this system is described below.

### Hardware and Software Used

Smart glasses: A glasses-type device worn by the worker and used to display information.

Microphone: Device used to capture the operator's voice input.

Server: A computer system that manages the information needed to do a job and processes voice input.

speech_recognition library: Software for converting spoken input into text.

smart_Glass (registered trademark) es_display module: custom software for displaying information on smart glasses displays.

factory_system module: Custom software to obtain work procedures, equipment status, and past accident cases from the factory system to determine if work is OK/NG.

### System Operation

1. display of work procedures: The server displays the necessary procedures for a task on the Smart Glasses' display. This allows the operator to see, in real time, what needs to be done next.

Confirmation of equipment status: The server obtains the real-time status of the equipment and displays it on the smart glasses. This allows workers to proceed with their work while keeping track of the current status of the equipment.

3. display of past accidents: The server displays past accidents on the smart glasses to alert the operator. This allows workers to refer to past mistakes and work safely.

4. capturing voice input: A worker enters spoken instructions through a microphone.

The server converts the voice into text using the speech_recognition library.

5. work progress reporting: Based on the worker's voice input, the server reports the progress of the work. This allows the worker to report progress without using his/her hands.

6. work OK/NG judgment: The server judges work OK/NG based on voice input using the factory_system module.

Display of results: The results of the evaluation are displayed on the Smart Glasses' display. This allows the operator to check the evaluation of the work in real time.

### Concrete Example

When a worker wears the smart glasses and performs maintenance work on equipment, the following steps are used in the application.

1. voice input to the smart glasses, “Display the next work procedure”.

2. voice input to the smart glasses, “Check the condition of the equipment”.

3. voice input to Smart Glasses, “Show past accident cases”.

4. when the work is completed, voice input “work completed”.

The server determines whether the work is OK or NG and displays the results on the smart glasses.

### Example of Prompt Text

Show next steps.

Check the condition of the equipment.”

“View past accidents.”

Work completed.”

Thus, the use of smart glasses can significantly improve work efficiency and safety in the factory.

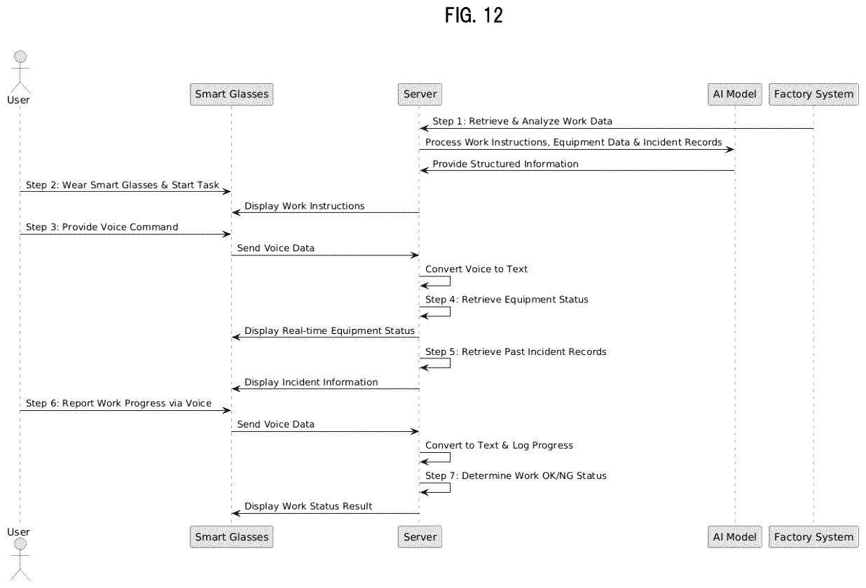

The flow of the identification process in Example of Application 1 is described in FIG. 12.

### Step 1:

The server learns in advance the information required for the work (e.g., procedures, equipment images, past accidents, etc.). This includes acquiring data from the factory system and using artificial intelligence to organize and analyze the information. The input is data from the factory system, and the output is the organized and analyzed work procedures, equipment images, and past accident cases.

### Step 2:

The user puts on the smart glasses and starts working. The server displays the work procedure on the smart glasses display. The input is the work procedure data from the server and the output is the work procedure displayed on the smart glasses display.

### Step 3:

The user inputs spoken instructions through a microphone. The server converts the voice into text using the speech_recognition library. The input is the user's voice instructions and the output is the instructions in text format.

### Step 4:

The server obtains the real-time status of the equipment based on the text form instructions and displays it on the smart glasses. The input is the text-format instruction and the output is the real-time status of the facility displayed on the smart glasses.

### Step 5:

The server retrieves past accident cases and displays them on the smart glasses. The input is the user's voice instructions, and the output is the past accident cases displayed on the smart glasses display.

### Step 6:

A user reports the progress of his/her work by voice. The server converts the voice into text using the speech_recognition library and records the work progress. The input is the user's voice report and the output is the progress report in text format.

### Step 7:

The server judges the work OK/NG based on the progress report in text format. The input is the progress report in text format, and the output is the OK/NG judgment result of the work.

### Step 8:

The server displays the decision results on the smart glasses display. The input is the OK/NG judgment result of the work, and the output is the judgment result displayed on the smart glasses display.

### Example 2

Next, example 2 of exemplary embodiment of implement will be described. In the following description, data processing device 12 is referred to as the “server” and smart device 14 is referred to as the “terminal.”

In conventional maintenance work, workers are required to accurately grasp and execute procedures, but it is sometimes difficult to check procedures and determine their accuracy. In addition, workers need to use their hands to check procedures during work, which is problematic and reduces work efficiency. Furthermore, even when voice input is used, accurate analysis of voice data and determination of procedures is difficult, and real-time feedback may not be obtained. To solve these problems, there is a need for a system that uses voice input to confirm procedures and provide real-time feedback.

The specific processing by the specific processing unit 290 of the data processing device 12 in Example 2 is realized by the following means.

In this invention, the server has means to learn in advance the information necessary for the work (procedures, equipment images, past accident cases, etc.), means to input the operation screen and the procedure to be performed through the smart glasses by voice when performing the work, means to judge whether the work is OK or NG and display the answer on the smart glasses, means to convert voice means to convert the data into text data, means to analyze the text data to determine the accuracy of the procedure, means to transmit the results of the determination to the smart glasses, and means to display the results of the determination on the smart glasses' display. This allows the operator to check the procedure using voice input and receive real-time feedback while accurately performing the maintenance task.

“Information necessary for the work” refers to information necessary to perform maintenance work, such as procedures, equipment images, and past accidents.

The “means of learning” are the methods and techniques used to obtain and understand the information needed for a task in advance.

“Smart glasses” are wearable devices with built-in displays and microphones that enable voice input and information display.

The “operation screen” is a screen on the smart glasses' display that allows the user to review work procedures and other information.

The term “voice input means” refers to methods and techniques that allow operators to use their voice to input information about operating screens and procedures to be performed.

“Means to determine OK/NG” is a method or technique to determine if an input procedure is correct or not.

The “means of displaying the answers” is the method or technique used to display the judgment results on the smart glasses' display.

“Means for converting voice data to text data” refers to methods and techniques for converting voice input to text format.

“Means for analyzing text data to determine the accuracy of a procedure” refers to methods and techniques for analyzing text data and determining whether the entered procedure is correct.

“Means for transmitting judgment results to smart glasses” refers to methods and techniques for transmitting judgment results of procedure accuracy to smart glasses.

The “means for displaying the judgment result on the smart glasses display” is a method or technique for displaying the judgment result on the smart glasses display.

### Exemplary Embodiment of the Invention

This invention is a system that allows workers to voice input procedures using smart glasses when performing maintenance work on equipment, and determines the accuracy of the procedures in real time. An exemplary embodiment of this system is described below.

### Hardware and Software Used

Smart Glasses: Wearable devices with built-in displays and microphones that allow voice input and information display.

Server: A computer system that analyzes audio data, determines procedures, and transmits the results.

Speech recognition technology for converting voice data to text data.

Generative AI model (e.g., GPT-4 (registered trademark) of OpenAI (registered trademark)): an artificial intelligence model for analyzing textual data and determining the accuracy of procedures.

### System Operation

### 1. Voice Input: 1.

The user wears the smart glasses and voice inputs maintenance procedures. For example, the user voice inputs a procedure such as “remove the filter.”

### 2. Transmission of Voice Data: (1)

The terminal (smart glasses) captures voice data through the built-in microphone and transmits the data to the server. Wi-Fi (registered trademark) and Bluetooth (registered trademark) are used for communication.

### 3. Audio Data Conversion

The server converts the received voice data into text data using a predefined API. This API provides highly accurate speech recognition.

### 4. Procedure Determination:

The server uses a generation AI model (e.g., OpenAI's GPT-4) to determine if the maintenance procedures retrieved as text data are correct. This determination includes a process of checking against a predefined database of correct procedures.

Transmission of judgment result: 5.

The server determines the accuracy of the procedure and sends the results to the smart glasses. Wi-Fi and Bluetooth are again used for communication.

### 6. Display of Results:

The terminal (smart glasses) displays the received decision on its display. For example, “The procedure is correct. Please proceed to the next step.” and so on.

### Concrete Example

As a concrete example, consider the case where a worker changes the filter of an air conditioner.

1. the user puts on the smart glasses and voice-types “remove filter”.

The terminal (smart glasses) sends this voice data to the server.

The server converts the voice data into text data “remove filter” using a predefined API. 3.

4. the server uses the data generation AI model to determine if this text data is the correct procedure. For example, it will check to see if the procedure “remove filter” exists in the database.

5. the server sends the judgment result “the procedure is correct” to the smart glasses.

6. the terminal (smart glasses) displays the result of this decision on its display and tells the user, “The procedure is correct. Please proceed to the next step.” and informs the user, “Please proceed to the next step.”

### Example of Prompt Text

User: “Remove the filter.”

Server: “The procedure is correct. Please proceed to the next step.”

User: “Install new filter”

Server: “The procedure is correct. Maintenance work has been completed.”

In this way, users can accurately proceed with maintenance tasks while receiving real-time feedback.

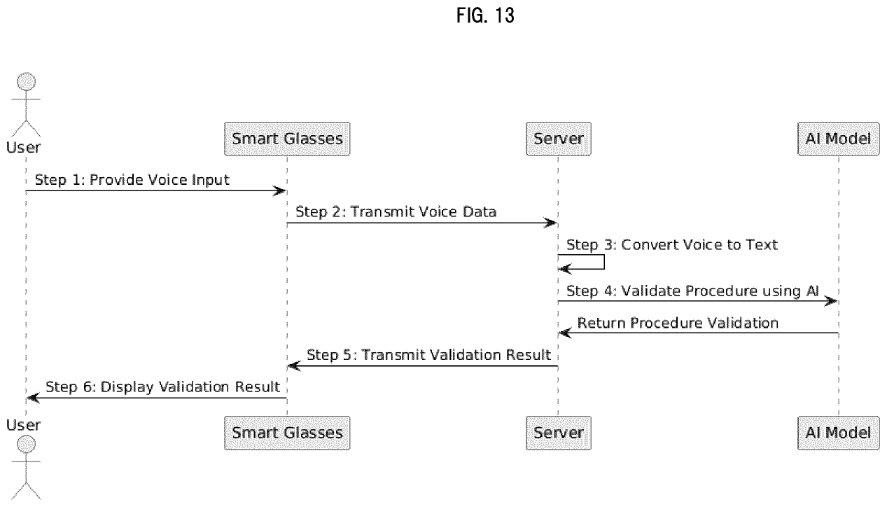

The flow of the identification process in Example 2 is described in FIG. 13.

### Program Processing Flow

### Step 1: Voice Input

The user wears the smart glasses and voice inputs maintenance procedures. For example, the user voice inputs a procedure such as “remove the filter.”

Input: User's voice instructions

Output: Audio data captured by the Smart Glass microphone

### Step 2: Transmission of Voice Data

The terminal (smart glasses) sends the captured voice data to the server through the built-in microphone. Wi-Fi and Bluetooth are used for communication.

Input: Audio data captured by the Smart Glasses' microphone

Output: Audio data sent to server

### Step 3: Convert Audio Data

The server converts the received voice data into text data using a predefined API. This API provides highly accurate speech recognition.

Input: Audio data sent to the server

Output: text data (e.g., “remove filter”)

### Step 4: Determination of Procedure

The server uses a generation AI model (e.g., OpenAI's GPT-4) to determine if the maintenance procedures retrieved as text data are correct. This determination includes a process of checking against a predefined database of correct procedures.

Input: text data (e.g., “remove filter”)

Output: Judgment result (e.g., “The procedure is correct.”)

### Step 5: Transmission of Judgment Results

The server determines the accuracy of the procedure and sends the results to the smart glasses. Wi-Fi and Bluetooth are again used for communication.

Input: Judgment result (e.g., “The procedure is correct.”)

Output: Judgment results sent to Smart Glass

### Step 6: Display Results

The terminal (smart glasses) displays the received decision on its display. For example, “The procedure is correct. Please proceed to the next step.” and so on.

Input: Judgment results sent to Smart Glass

Output: A message on the Smart Glass display (e.g., “The procedure is correct. Please proceed to the next step.”)

### Examples of Specific Actions

User: Speech: “Remove filter”.

Terminal (smart glasses): Transmits voice data to the server.

Server: Converts voice data to text data using a specified API.

4. server: analyze text data using the data generation model to determine the accuracy of the procedure.

Server: Transmits judgment results to smart glasses.

6. terminal (smart glasses): the result of the decision is shown on the display and the message “The procedure is correct. Please proceed to the next step.” and informs the user.

In this way, users can accurately proceed with maintenance tasks while receiving real-time feedback.

### Example of Application 2

Next, example of application 2 of example of implement 2 will be described. In the following description, data processing device 12 is referred to as the “server” and smart device 14 is referred to as the “terminal.”

In conventional maintenance work, operators are required to accurately understand and implement procedures, but lack of a means to confirm procedures and the accuracy of work in real time can lead to work errors and loss of efficiency. In addition, there is a need for a system that allows workers to voice input procedures and immediately check their accuracy. The challenge is to improve work efficiency and accuracy by this.

The specific processing by the specific processing unit 290 of the data processing device 12 in example of application 2 is realized by the following means.

In this invention, the server includes means to learn in advance the information required for the work (procedures, equipment images, past accident cases, etc.), means to input the operation screen and the procedures to be performed through the smart glasses by voice when performing the work, means to judge whether the work is OK/NG and display the answer on the smart glasses, and means to display the voice means for judging the inputted procedure in real time and displaying the result on the smart glasses display. This allows the operator to efficiently proceed with maintenance work while confirming the accuracy of the work in real time.

“Information necessary for the work” refers to information required to perform maintenance work, such as procedures, equipment images, and past accident examples.

The “means of learning” is a means of learning in advance the information necessary for a task, which is done using artificial intelligence.

“Smart glasses” are eyeglass-shaped devices worn by the operator that display an operation screen and the procedures to be performed, and accept voice input.

The “operation screen” is a screen displayed on the smart glasses that the operator refers to when performing maintenance tasks.

A “voice input means” is a means for a worker to input maintenance procedures using voice, and is performed using voice recognition technology.

The “means to determine OK/NG” is a means to determine whether the entered maintenance procedure is correct or not.

The “means of displaying the answers” is a means for displaying the judgment results on the smart glasses' display.

The “real-time judging means” is a means for immediately judging the voice-input procedure and displaying the results in real time.

The “display” is a display device mounted on the smart glasses that shows the judgment results and operation screens.

The system for implementing this invention is such that when a worker wears the smart glasses and performs a maintenance task, the system inputs the procedure by voice, determines in real time whether the procedure is correct, and displays the result on the smart glasses' display.

### System Configuration

The system consists of the following major components

Smart glasses: These are eyeglass-shaped devices worn by the operator and equipped with a display that shows the operation screen and judgment results. They are also equipped with a microphone that accepts voice input.

2. server: processes the input procedure using speech recognition technology and artificial intelligence to determine the input procedure.

3. speech recognition software: Software for converting voice input into text, e.g., using Google's speech recognition API.

4. artificial intelligence model: This model is used to learn the information required for a task in advance and to determine whether the input procedure is correct or not.

### Program Processing

The server operates as follows

1. acquisition of voice input: the operator's voice is acquired through the microphone of the smart glasses.

2. speech recognition: Acquired speech is converted into text using speech recognition software.

3. procedure determination: The converted text is input into the artificial intelligence model to determine if the procedure is correct.

4. display of the result: The result of the judgment is displayed on the smart glasses display.

### Hardware and Software Used

Hardware: Smart glasses, microphone

Software: Python (registered trademark), SpeechRecognition library, Smart Glass SDK, artificial intelligence models (e.g. TENSORFLOW (registered trademark))

### Concrete Example

For example, when a technician performs maintenance work on a robot, he or she can voice-activate the robot, remove the cover, and inspect the internal components. This voice is captured through the microphone of the smart glasses and converted into text by the voice recognition software. The converted text is sent to the server, where an artificial intelligence model determines the accuracy of the procedure. The result of the judgment is shown on the smart glasses' display as “The procedure is correct.”

### Example of Prompt Text

Turn off the robot, remove the cover, and inspect the internal components.

In this way, workers can efficiently proceed with maintenance work while checking the accuracy of the work in real time.

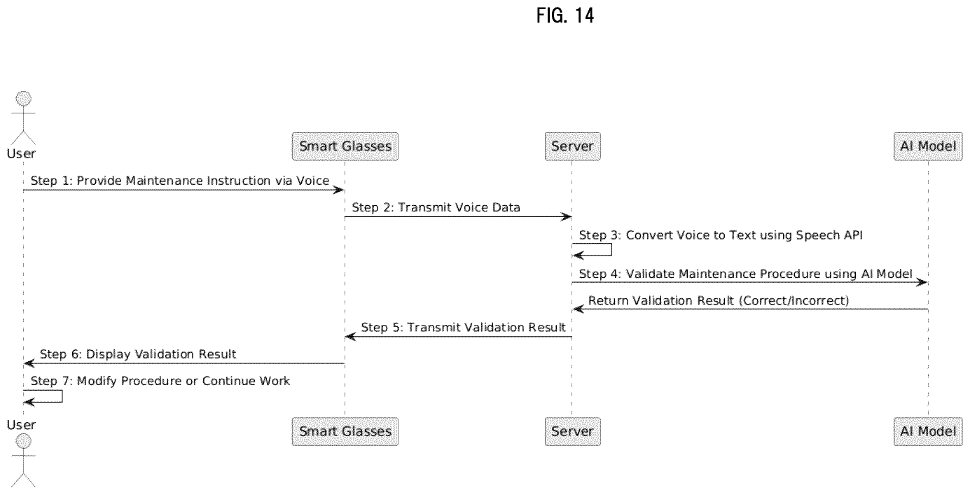

The flow of the identification process in example of application 2 is described in FIG. 14.

### Step 1:

The user puts on the smart glasses and begins the maintenance procedure. The user voice inputs the maintenance procedure into the microphone of the smart glasses. The voice input is a specific procedure, for example, “Turn off the robot, remove the cover, and inspect the internal parts. Input: User's voice. Output: voice data.

### Step 2:

The smart glasses send the acquired voice data to the server. The server uses speech recognition software (e.g., Google's speech recognition API) to convert the voice data into text data. Input: voice data. Output: text data.

### Step 3:

The server inputs the converted text data to the artificial intelligence model. The artificial intelligence model checks the data against a database of maintenance procedures learned in advance to determine if the input procedure is correct. Input: text data. Output: Judgment result (correct/wrong).

### Step 4:

The server sends the judgment results to the smart glasses. The smart glass displays the judgment result on its display. For example, messages such as “The procedure is correct” or “The procedure is incorrect. Please reconfirm.” Messages such as “The procedure is correct” or “The procedure is incorrect.” Input: Judgment result. Output: Message shown on the display.

### Step 5:

The user checks the results of the decision on the smart glasses display and corrects the procedure if necessary. If the correct procedure is displayed, the user continues with the work.

Input: A message displayed on the display. Output: user action (correct procedure or continue working).

In this way, users can check the accuracy of maintenance procedures in real time.

### Example 3

Next, example 3 of exemplary embodiment of implement will be described. In the following description, data processing device 12 is referred to as the “server” and smart device 14 is referred to as the “terminal.”

Conventional work support systems required operators to manually determine the safety and efficiency of work, which entailed a high risk of work errors and accidents. In addition, there was a lack of means to effectively utilize past accident cases and work data, and work improvements and safety measures were not sufficiently implemented. Furthermore, it was difficult to provide real-time work support, which placed a heavy burden on workers.

The specific processing by the specific processing unit 290 of the data processing device 12 in Example 3 is realized by the following means.

In this invention, the server includes means for acquiring past work data and accident cases from a database and pre-processing them, means for training an artificial intelligence model using the pre-processed data, and means for inputting new work data and using the artificial intelligence model to determine whether work is OK or NG. This makes it possible to effectively utilize past data and automatically determine the safety and efficiency of work in real time.

“Information necessary for the work” refers to the data and knowledge required to perform the work, such as procedures, equipment images, and past accident examples.

“Smart glasses” refers to wearable devices that can be worn by workers to visually display operating screens and procedures to be performed.

The term “voice input means” refers to technology that allows operators to use voice to give operating instructions or input data.

The term “means to determine OK/NG” refers to technology used to evaluate the safety and efficiency of work and determine the results as OK or NG.

The term “database” refers to an information management system that systematically stores past work data and accident cases and allows retrieval and retrieval as needed.

The term “means of preprocessing” refers to technology that converts collected data into a format suitable for artificial intelligence models by completing missing values, normalization, feature extraction, and other processing.

The term “artificial intelligence model” refers to a model that uses machine learning algorithms to learn data and perform a specific task (in this case, the OK/NG decision for a task).

The term “means to train” refers to techniques for training artificial intelligence models using preprocessed data to improve their performance.

“New work data” refers to information about current or future work, on the basis of which the artificial intelligence model determines whether the work is OK or NG.

The term “means to provide feedback” refers to technology that notifies users of the results of judgments made by the artificial intelligence model and encourages them to improve their work or take safety measures.

This invention is a system to improve the safety and efficiency of operations and can be implemented as follows

First, users use a development environment such as Python or TensorFlow to generate a program for the system. The program includes code to build an artificial intelligence (AI) model and to learn from historical work data and accident cases.

The server obtains past work data and accident cases provided by users from a database (e.g., MySQL (registered trademark)). Next, the server preprocesses these data and converts them into a format suitable for AI models. Specifically, data cleaning, normalization, and feature extraction are performed.

The server then trains the AI model using a machine learning library such as TensorFlow. Once training is complete, the server receives new work data as input and uses the AI model to determine whether the work is OK or NG.

As a concrete example, consider the case of factory work data. A user inputs past work data (e.g., work hours, equipment used, years of experience of workers) and accident cases (e.g., types, causes, and effects of accidents) into the system. The server learns these data and determines whether the work is safe or not when new work data is input.

### Example of a Prompt Statement:

“Based on historical work data and case studies of accidents, determine if current work is safe.”

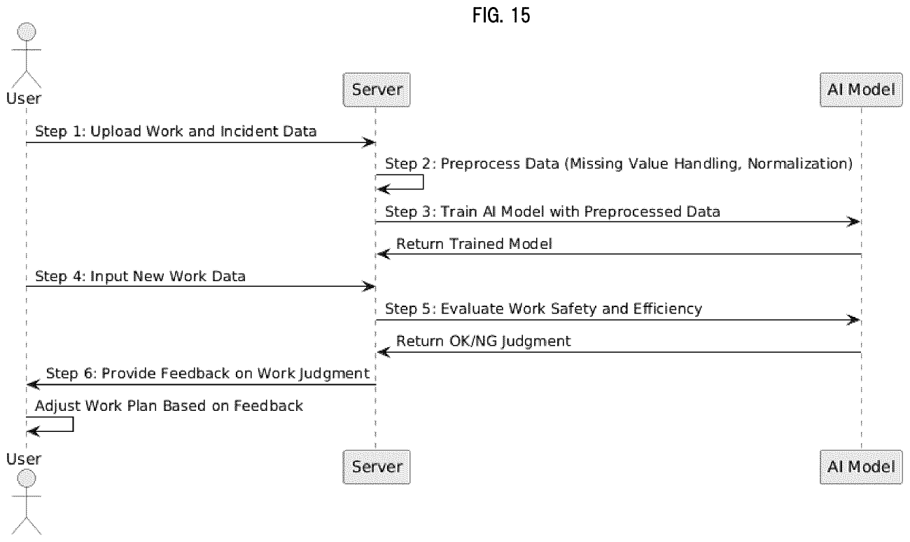

This system is expected to improve the efficiency and safety of workers. The flow of the identification process in Example 3 is described in FIG. 15.

### Step 1: Data Collection

Users upload past work data and accident cases to the system. Specifically, the data is extracted from a CSV file or database. Input is information such as work hours, equipment used, operator's years of experience, type of accident, cause, and impact. The output is that these data are stored on the server.

### Step 2: Data Preprocessing

The server preprocesses the collected data. Specifically, it completes missing values, normalizes data, and performs categorical data encoding. The input is the raw data collected in step 1. The output is the preprocessed data set. For example, missing values are complemented with averages, work hours are normalized, and instruments used are one-hot encoded.

### Step 3: AI Model Training

The server uses the preprocessed data to train AI models. Specifically, machine learning libraries such as TensorFlow are used. The input is the preprocessed data set from step 2. The output is the trained AI model. Training can take several hours.

### Step 4: Input Work Data

Users enter new work data into the system. Specifically, the data is entered in real-time or processed in batches. Inputs are information such as the start time of the new work, the equipment used, and the worker's years of experience. The output is that these data are stored on the server.

### Step 5: OK/NG Judgment of Work

The server passes the new work data entered to the AI model to determine if the work is OK/NG. Specifically, the AI model evaluates the safety and efficiency of the work. The input is the new work data entered in step 4. The output is the result of the OK/NG judgment of the work. For example, a judgment such as “NG because the work time is too long” is made.

### Step 6: Feedback on Results

The server will provide feedback to the user on the results of the decision. Specifically, the system notifies the user and displays a dashboard. Input is the judgment result obtained in step 5. The output is the feedback information to the user. The user reviews the work plan based on the result. For example, they take measures such as “shortening the work time” or “changing the equipment used.”

### Example of Application 3

Next, example 3 of application of example of implement 3 will be described. In the following description, data processing device 12 is referred to as the “server” and smart device 14 is referred to as the “terminal.”

Conventional work support systems require workers to learn procedures, equipment images, and past accident cases in advance, but they do not acquire work data in real time or make OK/NG decisions for work based on past data. As a result, work efficiency and safety were not sufficiently improved. Furthermore, it was necessary to improve the accuracy of judgment when workers input operation screens and procedures to be performed by voice through smart glasses.

The specific processing by the specific processing unit 290 of the data processing device 12 in example of application 3 is realized by the following means.

In this invention, the server includes means to learn in advance the information required for the work (procedures, equipment images, past accident cases, etc.), means to input the operation screen and the procedures to be performed through the smart glasses by voice when performing the work, and means to judge whether the work is OK or NG and display the answer on the smart glasses, means using artificial intelligence that acquires work data in real time and judges whether the work is OK or NG based on past data and accident cases. This makes it possible to improve work efficiency and safety.

“Information necessary for the work” refers to information such as procedures, equipment images, and past accidents that are necessary for the work to be performed.

A “means of learning in advance” is a means of learning in advance the information needed to perform a task.

“Smart glasses” are eyeglass-shaped devices that can be worn by the operator to display an operating screen and the procedures to be performed.

The “operation screen” is the screen that the operator can see through the smart glasses.

A “procedure to be performed” is a specific procedure to be followed when performing a task.

The “voice input means” is a means for the operator to use his/her voice to input the operation screens and procedures to be performed.

The “means to determine OK/NG” is a means to determine whether the result of the work is appropriate or not.

“Means to obtain work data in real time” means a means to obtain data in real time while work is being performed.

“Historical data” refers to data on work performed in the past.

An “accident case” is a specific example of an accident that has occurred in the past.

“Artificial intelligence means” is a means of using artificial intelligence technology to determine if a task is OK/NG.

The following is an exemplary embodiment of this invention.

First, the server has the means to learn in advance the information necessary for the work (procedures, equipment images, past accidents, etc.). This means is done using artificial intelligence techniques. Specifically, machine learning libraries such as TensorFlow are used to learn past work data and accident cases to model work patterns.

Next, the user wears smart glasses when performing the task. Smart glasses are devices used to display operation screens and procedures to be performed, and have a means of voice input using voice recognition technology. When the user inputs operation instructions by voice, the voice data is sent to the server, which converts it into text data using voice recognition technology.

The server has the means to acquire work data in real time. Specifically, the progress of the work is monitored in real time through cameras and sensors mounted on the smart glasses. This data is transmitted to the server, which has a means of using artificial intelligence to determine if the work is OK or NG based on past data and accident cases; the AI model is built using machine learning libraries such as TensorFlow to determine the suitability of the work based on data acquired in real time.

The decision results are displayed on the smart glasses. This allows users to check the progress of the work in real time and make corrections as necessary. This improves work efficiency and safety.

As a concrete example, consider a case where a robot is assembling parts in a factory.

In this case, cameras and sensors mounted on the robot acquire work data in real time and input the data to the AI model, which determines whether the work is OK or NG based on past data and accident cases, and displays the results on the smart glasses in real time.

Examples of prompt sentences to be input to the generative AI model could include the following:

A robot is assembling parts in a factory. “Please build an AI system to judge whether the work is OK or NG based on the work data acquired in real time, referring to past data and accident cases.”

The above is an exemplary embodiment of this invention.

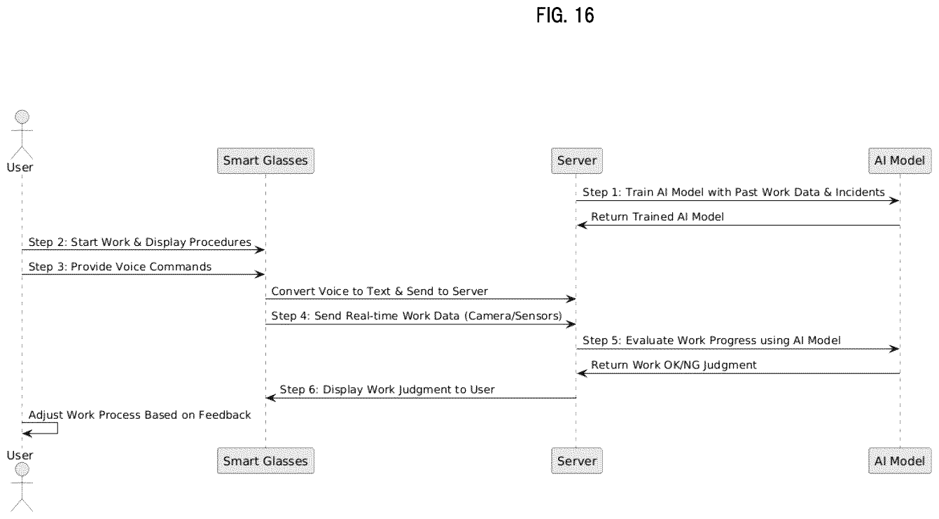

The flow of the identification process in example of application 3 is described in FIG. 16.

### Step 1:

The server learns information necessary for the work (procedures, equipment images, past accident cases, etc.) in advance. Specifically, it uses machine learning libraries such as TensorFlow to learn past work data and accident cases to model patterns of work. The input is past work data and accident cases, and the output is the learned AI model.

### Step 2:

The user puts on the smart glasses and begins to work. Smart glasses are devices used to display operation screens and procedures to be performed. The input is the user's voice instructions, and the output is the operation screen and procedures displayed on the smart glasses.

### Step 3:

The user inputs operation instructions by voice. The smart glasses use voice recognition technology to convert the voice into text data, which is then sent to the server. The input is the user's voice instructions and the output is the text data.

### Step 4:

The server acquires work data in real time. The progress of the work is monitored in real time through cameras and sensors mounted on the smart glasses. The input is the real-time data from the cameras and sensors, and the output is the work data sent to the server.

### Step 5:

The server inputs work data acquired in real time to the AI model and judges whether the work is OK or NG. The AI model judges the suitability of the work based on past data and accident cases. The input is work data acquired in real time, and the output is the result of OK/NG judgment of work.

### Step 6:

The server sends the decision results to the smart glasses and displays them to the user.

This allows the user to check the progress of the work in real time and make corrections as necessary. The input is the OK/NG judgment result of the work, and the output is the judgment result displayed on the smart glasses.

These are the specific processing steps for implementing this invention.

Furthermore, an emotion engine that estimates the user's emotion may be combined. In other words, the specific processing unit 290 may use the emotion identification model 59 to estimate the user's emotion and perform specific processing using the user's emotion.

### Example of Implement 1.″

One exemplary embodiment of this invention is a system that combines an emotion engine that recognizes the emotions of a worker. In this system, when a worker wears the smart glasses and performs a task, the emotion engine recognizes the emotion from the tone of the worker's voice and facial expression. For example, if the worker feels nervous, the system can adjust work instructions according to the worker's emotions, such as slowing the pace of the work.

### Example of Implement 2.″

The emotion engine can also take measures such as suspending work if the worker's emotions exceed a certain threshold. For example, if the system determines that the worker is overly stressed, it can pause the work and instruct the worker to take a break.

### (2) to be Able to Cut.

### Example of Implement 3.″

Furthermore, the emotion engine can record changes in the worker's emotions and analyze the data to find areas for improvement in the work. For example, if a worker tends to feel stress during a particular task, the system can suggest improvements such as reviewing the procedures for that task.

The process flow for each example of implement is described below.

### Example of Implement 1.″

Step 1: The worker wears the smart glasses.
Step 2: As the work begins, the emotion engine recognizes emotions from the tone of the worker's voice and facial expressions.
Step 3: The emotion engine adjusts the work instructions according to the worker's emotions. For example, if the worker feels nervous, the system adjusts the pace of the work by slowing it down. Example of implement 2.”
Step 1: The worker puts on the smart glasses and starts working.
Step 2: The emotion engine recognizes the worker's emotion and pauses the work if the emotion exceeds a certain threshold.
Step 3: After pausing the work, the system instructs the worker to take a break.

### Example of Implement 3.″

Step 1: The worker puts on the smart glasses and starts working.
Step 2: The emotion engine records changes in the worker's emotions.
Step 3: The system analyzes the recorded emotional data to find areas for improvement in the work. For example, if a worker tends to feel stressed by a particular task, the system will suggest improvements, such as revising the procedures for that task.

### Example 1

The following is an example of exemplary embodiment of implement. In the following description, data processing device 12 is referred to as the “server” and smart device 14 is referred to as the “terminal.”

Conventional work support systems allow workers to learn information such as work procedures, equipment images, and past accident cases in advance, but they could not respond to emotional changes during work. As a result, it was difficult to provide appropriate instructions when workers felt tension or stress, which could reduce work efficiency and safety.

The specific processing by the specific processing unit 290 of the data processing device 12 in Example 1 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK/NG and display the answer on the smart glasses, means to recognize the operator's The system also includes means to recognize the emotion of the worker and adjust work instructions according to that emotion. This makes it possible to respond to changes in the worker's emotions and provide appropriate instructions.

“Information necessary for the work” is a generic term for data and materials necessary to perform the work, such as work procedures, equipment images, and past accident examples.

“Smart glasses” are a type of wearable device with a built-in display, camera, and microphone that is worn by the worker.

The “operation screen” is an interface on the smart glasses' display that contains information such as work procedures and instructions.

The term “voice input means” refers to technology that allows workers to input instructions and information through voice, and generally involves the use of voice recognition technology.

The “means to determine OK/NG” is an algorithm or program that analyzes the worker's voice input and work content and determines whether the results are correct or not.

The “means of recognizing emotions” refers to technology that analyzes a worker's tone of voice and facial expressions to identify emotions such as tension and stress.

A “means of adjusting work instructions” is an algorithm or program for modifying the pace of work or the content of instructions in response to recognized worker emotions.

### Exemplary Embodiment of the Invention

This invention is a system in which workers wear smart glasses and learn information such as work procedures, equipment images, and past accident cases in advance. The worker can check the operation screen through the smart glasses and input instructions by voice.

Combined with an emotion engine, the system also has the ability to recognize the operator's emotions and adjust work instructions.

### Hardware and Software Used

Server: A relational database such as MySQL is used to store information such as work procedures, equipment images, and past accidents.

Terminal (smart glasses): Wearable devices such as Google Glass and Microsoft (registered trademark) HoloLens (registered trademark).

Speech recognition software: converts speech into text using a given API.

Emotion Recognition Software: Use a system that combines the Emotion API of Microsoft Azure (registered trademark) and OpenCV (registered trademark) with a deep learning model.

### Specific System Operation

1. the server stores information such as work procedures, equipment images, and past accident cases in a database. For example, the database will store text data of work procedures and equipment image files.

When the terminal (smart glasses) is worn by the worker, it connects to the server via Wi-Fi and requests necessary information. The server sends work procedures and equipment images to the terminal in response to the request. The terminal displays the received information on its display.

3. the user (worker) checks the information displayed through the smart glasses and inputs voice instructions such as “tell me the next step”. Smart Glass captures the voice using its built-in microphone and converts the voice into text using a predefined API.

4. the server receives the text data of voice instructions sent from the terminal and analyzes it using a script written in Python. For example, it determines if the instruction “Tell me the next step” is correct and generates an OK/NG result.

5. the terminal displays the result of the decision received from the server on its display. For example, it displays a message such as “The following procedure is OK.”

6. the emotion engine analyzes the user's tone of voice and facial expressions. It uses the camera and microphone built into the smart glasses to capture the user's facial expressions and tone of voice, and uses Microsoft Azure's Emotion API to recognize emotions.

7. the server adjusts work instructions based on the emotional data received from the emotion engine. For example, if the server recognizes that the user is nervous, it sends additional instructions to the terminal, such as “Proceed slowly.” The terminal displays this instruction on its display.

### Concrete Example

For example, consider a case where a user wears smart glasses to perform an equipment inspection. The user inputs a voice instruction, “Tell me the next step.” The server analyzes this voice instruction and displays the next steps on the smart glasses display. At the same time, if the emotion engine senses tension in the user's tone of voice, the server will display additional instructions such as “Please proceed slowly.”

### Example of Prompt Text

Examples of prompt sentences to be input into the generative AI model could include the following:

A worker is wearing smart glasses and inspecting equipment. The worker enters voice instructions for the next step. The server analyzes this voice instruction and displays the next step on the Smart Glasses display. At the same time, if the emotion engine detects tension in the worker's tone of voice, the server displays additional instructions to slow down the pace of the work.”

By inputting this prompt statement into a generative AI model, the system's behavior can be simulated.

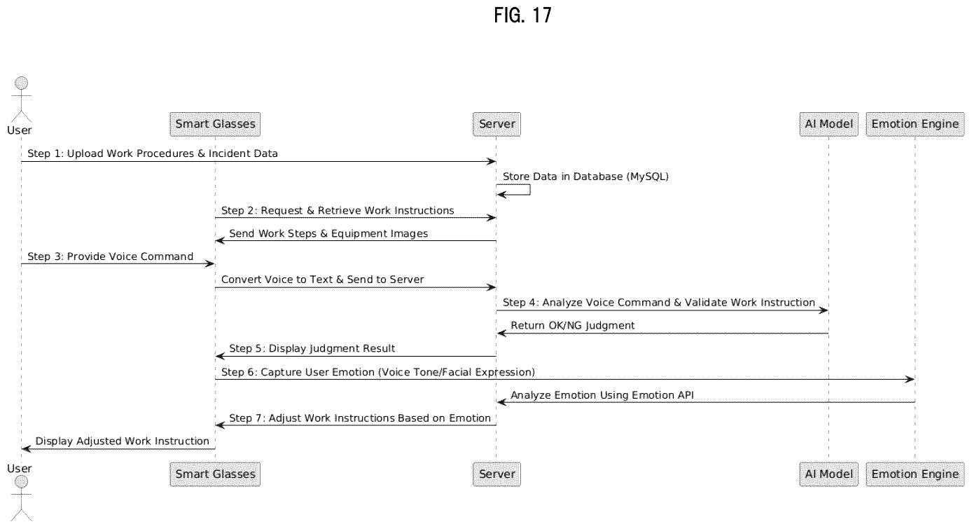

The flow of the identification process in Example 1 is described in FIG. 17.

### Step 1:

The server stores the information in a database.

Input: information on work procedures, equipment images, past accidents, etc.

Processing: The server stores this information in a relational database such as MySQL.

Specifically, the database stores text data of work procedures and image files of equipment.

Output: Information stored in the database.

### Step 2:

The terminal retrieves information from the server and displays it on the display.

Input: Information such as work procedures and equipment images stored on the server.

Processing: When worn by the user, the terminal (smart glasses) connects to the server via Wi-Fi and requests necessary information. The server sends work procedures and equipment images to the terminal in response to the request.

Output: Work procedures and equipment images displayed on the terminal's display.

### Step 3:

The user enters voice instructions.

Input: User voice instructions (e.g., “Tell me the next step”).

Processing: Smart Glasses captures audio using the built-in microphone and converts the audio to text using a predefined API at.

Output: Voice instructions converted to text.

### Step 4:

The server analyzes the voice instructions and determines whether the work is OK or NG.

Input: Voice instructions converted to text.

Processing: The server receives text data of voice instructions sent from the terminal and analyzes it using a script written in Python. For example, it determines if the instruction “Tell me the next step” is correct and generates an OK/NG result.

Output: OK/NG decision result.

### Step 5:

The terminal displays the results of the decision on its display.

Input: OK/NG judgment results received from the server.

Processing: The terminal displays the result of the decision received from the server on its display. For example, the terminal displays a message such as “The next step is OK.”

Output: The result of the decision shown on the terminal's display.

### Step 6:

The emotion engine recognizes the user's emotions.

Input: Tone of voice and facial expression of the user.

Processing: Capture the user's facial expressions and tone of voice using the smart glasses' built-in camera and microphone, and recognize emotions using Microsoft Azure's Emotion API.

Output: Recognized emotion data.

### Step 7:

The server adjusts work orders according to emotion.

Input: Emotion data received from the emotion engine.

Processing: The server adjusts work instructions based on the emotional data received from the emotion engine. For example, if a user is perceived as nervous, the server will send additional instructions to the terminal, such as “proceed slowly.”

Output: Adjusted work instructions shown on the terminal display.

### Example of Application 1

Next, example of application 1 of example of implement 1 will be described. In the following description, data processing device 12 is referred to as the “server” and smart device 14 is referred to as the “terminal.”

Conventional work support systems allow workers to learn information such as work procedures, equipment images, and past accident cases in advance, but lack support that takes into account their emotional state during work. As a result, the system may not be able to respond appropriately when the worker feels tension or stress, which may reduce work efficiency and safety. In addition, OK/NG judgment of operations by voice input also does not take emotional states into account, which may increase the psychological burden on the worker.

The specific processing by the specific processing unit 290 of the data processing device 12 in example of application 1 is realized by the following means. In this invention, the server includes means for learning information necessary for the work (procedures, equipment images, past accident cases, etc.) in advance, means for inputting the operation screen and procedures to be performed by voice through the smart glasses when performing the work, means for judging whether the work is OK or NG and displaying the answer on the smart glasses, means for recognizing the emotion of the worker, means for adjusting the pace and instructions according to the emotion of the worker The system also includes means to recognize the emotions of the worker, and means to adjust the pace of the work and instructions according to the worker's emotions. This enables appropriate support that takes into account the emotional state of the worker, and is expected to improve work efficiency and safety.

Information necessary for work” refers to information necessary for smooth and safe operations, such as work procedures, equipment images, and past accidents.

The “means to learn in advance” is a means for workers to learn in advance the information necessary for their work, and this includes learning systems using artificial intelligence.

“Smart glasses” are wearable devices worn by the operator that provide a visual display of the operating screen and procedures to be performed.

The “means for voice input of operation screens and procedures to be performed” is a means for operators to input operation screens and procedures to be performed using voice, and voice recognition technology can be used.

The “means for judging OK/NG and displaying the answer on the smart glasses” is a means for judging whether the work is OK or NG based on the worker's voice input and displaying the result on the smart glasses' display.

The “emotion recognition means” is a means to recognize emotions from the tone of voice and facial expressions of the worker, and an emotion recognition engine can be used.

The “means for adjusting the pace of work and instructions” is a means for adjusting the pace of work and instructions according to the emotions of the worker.

An exemplary embodiment of this invention is an application that is installed on a factory robot. The following is an exemplary embodiment of this application.

### Hardware and Software Used

Hardware: smart glasses (e.g., wearable devices), factory robots (e.g., robot arms)

Software: Emotion Recognition Engine (e.g., Emotion Recognition Software), Speech Recognition Engine (e.g., Speech Recognition Software), Display Software (e.g., Display Software)

### Data Processing and Data Arithmetic

### Voice Input Processing: 1.

The user inputs voice instructions into the smart glasses.

Convert speech into text using a speech recognition engine.

Analyze the converted text and determine if the operation is OK/NG.

### 2. Emotion Recognition Processing

Capture the user's facial expressions and tone of voice using the smart glasses' camera and microphone.

Use an emotion recognition engine to recognize the user's emotions.

Adjust the pace and direction of work based on perceived emotions.

### 3. Processing of the Display:

The OK/NG results of the operation and the adjusted instructions are displayed on the smart glasses display.

Use display software to present the information in a visually pleasing manner.

### Concrete Example

For example, when a user performs maintenance on a robot arm, the user wears the smart glasses and performs the following operations:

1. the user voice inputs “tell me the next step”.

2. speech recognition engine converts speech into text and displays next steps

3. if the user is nervous, the emotion recognition engine detects this and adjusts the instructions to slow down the pace of the work.

4. the Smart Glass display will show “Please proceed slowly to the next step.”

### Example of Prompt Text

Examples of prompt sentences to be entered into the generative AI model are as follows:

Design a smart glasses application to learn maintenance procedures for a “factory robot.

Include the ability for the user to enter spoken instructions and use an emotion recognition engine to recognize the user's emotions and adjust the pace of work and instructions. The hardware used is a wearable device and a robot arm; the software is voice recognition software, emotion recognition software, and display software.”

In this way, smart glass applications can be implemented for efficient and safe operation and maintenance of factory robots.

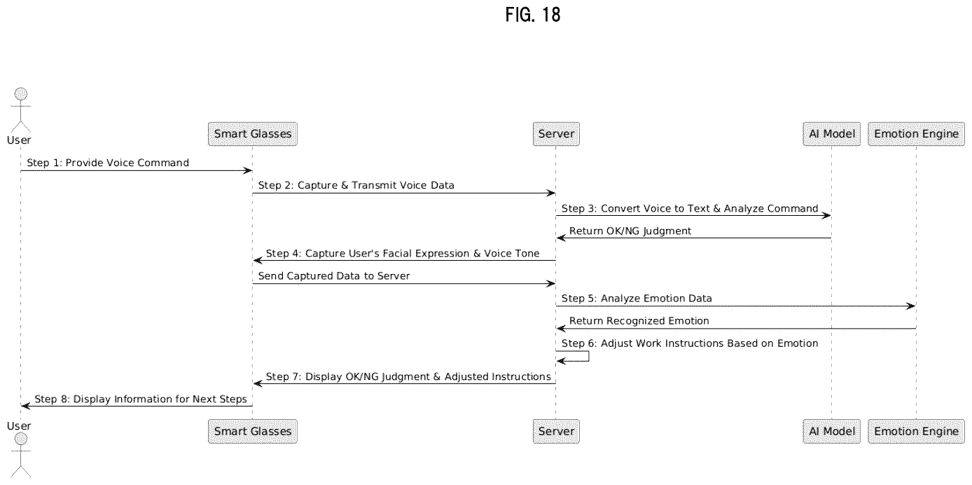

The flow of the identification process in Example of Application 1 is described in FIG. 18.

### Step 1:

The user inputs voice instructions into the smart glasses. The voice input is captured through the Smart Glasses' microphone.

### Step 2:

The server uses a speech recognition engine to convert the captured speech into text.

The input is the speech data and the output is the text data.

### Step 3:

The server analyzes the converted text and judges whether the operation is OK or NG.

The input is the text data and the output is the OK/NG judgment result.

### Step 4:

The server uses the camera and microphone on the smart glasses to capture the user's facial expressions and tone of voice. Input is camera video and voice data.

### Step 5:

The server uses an emotion recognition engine to recognize the user's emotions from captured facial expressions and tone of voice. The input is the camera video and voice data, and the output is the emotion data.

### Step 6:

The server adjusts the pace of work and instructions based on the recognized emotions.

The input is the emotion data and the output is the adjusted instructions.

### Step 7:

The server displays the OK/NG results of the operation and the adjusted instructions on the smart glasses display. The input is the OK/NG results and adjusted instructions, and the output is the display.

### Step 8:

The user reviews the information displayed on the smart glasses display and proceeds to the next step. The input is the display indication and the output is the user's next action.

### Example 2

Next, example 2 of exemplary embodiment of implement will be described. In the following description, data processing device 12 is referred to as the “server” and smart device 14 is referred to as the “terminal.”

In conventional maintenance work, workers are required to accurately understand and properly execute procedures, but errors in procedures and worker stress sometimes resulted in reduced work efficiency. In addition, worker health and safety were not adequately ensured because there was no system that monitored workers' emotional states in real time and instructed them to take a break at the appropriate time.

The specific processing unit 290 of the data processing device 12 in Example 2 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK or not and display the answer on the smart glasses, and means to monitor the user The system also includes means for monitoring the emotional state of the user and, if the emotional state exceeds a certain threshold, suspending the work and instructing the user to take a break. This allows the worker to proceed with the work while checking the accuracy of the procedure, and also allows the user to take an appropriate break if he/she feels excessively stressed.

Information necessary for the work” refers to the data and knowledge required to perform maintenance work accurately and efficiently, including procedures, equipment images, and past accident examples.

“Smart glasses” refers to wearable devices with displays and voice input capabilities that allow workers to view and input information hands-free.

The term “voice input means” refers to techniques and devices that allow operators to use their voice to input information on operating screens and procedures to be performed, and includes voice recognition technology.

The term “means to determine OK/NG” refers to a technique or device that evaluates whether an input procedure or operation is correct and outputs the results.

The term “means of monitoring emotional states” refers to techniques and devices used to measure and evaluate workers' stress levels and fatigue in real time.

“Means for suspending work and instructing workers to take a break when a certain threshold is exceeded” refers to techniques or devices for suspending work and instructing workers to take a break when the evaluation results of the emotional state exceed a set criterion.

The term “artificial intelligence” refers to technologies and systems that use machine learning and data analysis to automatically learn the information needed to perform a task and make decisions.

The term “speech recognition technology” refers to technologies and systems for converting speech into text data, enabling voice input.

This invention is a system that uses smart glasses to allow workers to voice input procedures when performing maintenance tasks, determine the accuracy of those procedures, and also monitor the emotional state of the worker. The system is implemented using the following hardware and software:

### Hardware and Software Used

### Hardware: Smart Glasses

Software: Speech recognition system, emotion engine, generative AI model

### Specific System Operation

1. the user puts on the smart glasses. The smart glasses are activated and connected to the system.

2. the user inputs the maintenance procedure by voice. For example, the user speaks “change engine oil”.

The terminal (smart glasses) activates the speech recognition system and converts the input speech into text data. Specifically, speech recognition software (e.g., a given API) is used.

4. the server receives the text data and determines if the input procedure is correct using the generated AI model. For example, a generative AI model (e.g., GPT-4) evaluates whether the procedure “change engine oil” is correct.

The server sends the judgment result to the smart glasses display. The terminal (smart glasses) displays the judgment result on its display. For example, the result “correct” is displayed.

6. the terminal (smart glasses) monitors the user's emotional state using built-in sensors. The emotional engine evaluates the user's stress level and fatigue.

7. the server receives the evaluation results of the emotion engine and pauses the work if the user's emotion exceeds a certain threshold. The terminal (smart glasses) shows the message “Please take a break” on the display. For example, if the system determines that the user is excessively stressed, the system displays “Please take a break.”

### Concrete Example

### Example 1: Entering Maintenance Work Procedures

The user voice inputs “change engine oil”.

The voice recognition system in the smart glasses converts the text data into “change engine oil.

The server determines if this procedure is “correct” using a generative AI model.

The server displays the “correct” result on the smart glasses display.

The user checks the display and continues working.

### Example 2: Work Stoppage by the Emotion Engine

The emotional engine determines that the user is overly stressed while working.

The emotional engine pauses the work and displays the message “Please take a break” on the smart glasses' display.

The user follows the instructions and takes a break.

### Example of Prompt Text

Enter the procedure for changing the engine oil audibly. The system determines the accuracy of the procedure and shows the result on the display. Also, if you experience undue stress during the procedure, the system will pause the operation and ask you to take a break.”

In this way, users can proceed with their work with peace of mind, checking to see if their own work is correct. In addition, if the user feels excessive stress, the system will prompt him or her to take an appropriate break, thereby improving the safety and efficiency of the work.

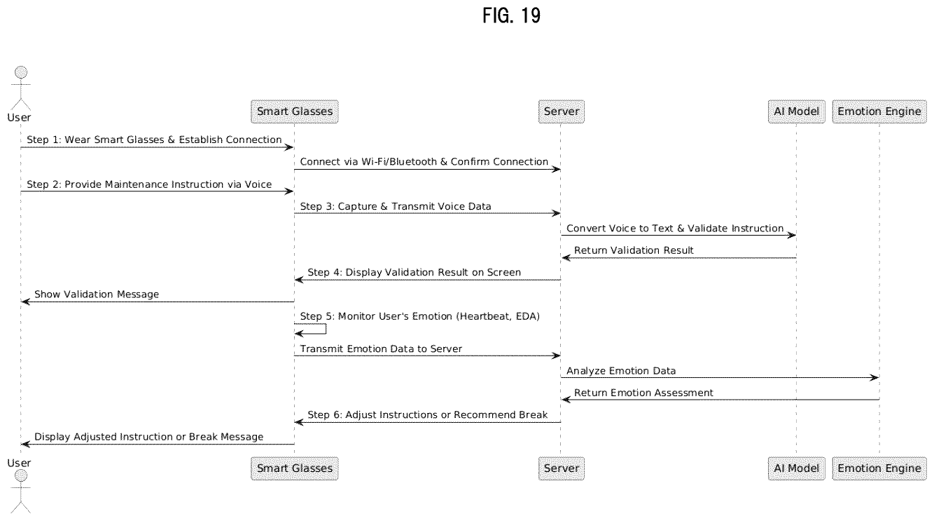

The flow of the identification process in Example 2 is described in FIG. 19.

### Step 1:

The user puts on the smart glasses. The smart glasses are activated and connected to the system.

Input: Wearing Smart Glasses

Output: System connection completion message

Specific operation: Smart Glasses is activated and connected to the server via Wi-Fi or Bluetooth. The message “System connection complete” appears on the display.

### Step 2:

The user voice inputs the procedure for a maintenance task. For example, he/she speaks, “Change the engine oil.”

Input: Voice input (e.g., “change engine oil”)

Output: Audio data

Specific operation: The smart glasses' microphone captures voice and stores it as voice data.

### Step 3:

The terminal (smart glasses) activates the voice recognition system and converts the input voice into text data.

Input: Audio data

Output: Text data (e.g., “change engine oil”)

Specific behavior: Speech recognition software (e.g., a given API) analyzes speech data and generates corresponding text data.

### Step 4:

The server receives the text data and determines if the input procedure is correct using the data generation model.

Input: text data (e.g., “change engine oil”)

Output: Judgment result (e.g., “correct”)

Specific behavior: The server uses a data generation model (e.g., GPT-4) to analyze the contents of the text data and evaluate the accuracy of the procedure.

### Step 5:

The server sends the judgment result to the smart glasses display. The terminal (smart glasses) displays the judgment result on its display.

Input: Judgment result (e.g., “correct”)

Output: Displayed (e.g., “correct”)

Specific operation: The server sends the judgment results to the smart glasses, and the smart glasses display the results on the display.

### Step 6:

The terminal (smart glasses) monitors the user's emotional state using built-in sensors.

Input: Biological data (e.g., heart rate, skin electrical response)

Output: Results of emotional state assessment (e.g., stress level)

Specific operation: Sensors in the smart glasses collect the user's biometric data, and the emotion engine analyzes the data to evaluate the emotional state.

### Step 7:

The server receives the evaluation results of the emotion engine and pauses the work if the user's emotion exceeds a certain threshold. The terminal (smart glasses) displays the message “Please take a break” on the display.

Input: Result of emotional state assessment (e.g., high stress)

Output: Break instruction message (e.g., “Please take a break”)

Specific operation: When the server receives the evaluation results from the emotion engine and determines that the stress level is high, it sends a break instruction message to the smart glasses and displays it on the display.

### Example of Application 2

Next, example of application 2 of example of implement 2 will be described. In the following description, data processing device 12 will be referred to as the “server” and smart device 14 will be referred to as the “terminal.”

In conventional maintenance work, workers are required to accurately understand and properly execute procedures, but accidents and mistakes can occur due to errors in procedures and worker stress. In addition, there is a problem of reduced work efficiency and safety due to the lack of a system that monitors the emotional state of workers in real time and prompts them to take a break at the appropriate time. To solve these problems, a system that checks the accuracy of work procedures and monitors the emotional state of workers is needed.

The specific processing by the specific processing unit 290 of the data processing device 12 in example of application 2 is realized by the following means.

In this invention, the server includes means to learn in advance the information necessary for the work (procedures, equipment images, past accident cases, etc.), means to input the operation screen and procedures to be performed by voice through the smart glasses when performing the work, means to judge whether the work is OK or not and display the answer on the smart glasses, means to monitor the worker's The system also includes means to monitor the emotional state of the worker and pause the work if the worker feels excessive stress, and means to instruct the worker to take a break. This makes it possible to proceed with the work while checking the accuracy of the work procedures, and to monitor the emotional state of the worker in real time and prompt the worker to take a break at the appropriate time.

Information necessary for the work” refers to information necessary to perform maintenance work, such as procedures, equipment images, and past accidents.

The “means of learning” is a means of learning in advance the information necessary for a task, which is done using artificial intelligence.

The “voice input means” is a means for the operator to voice input the operation screen and procedures to be performed through the smart glasses.

The “means for judging OK/NG” is a means for judging whether the entered work procedure is correct and displaying the result on the smart glasses.

The “means to monitor the emotional state” is a means to monitor the worker's emotional state in real time and pause the work if he/she feels excessively stressed.

A “means of instructing a worker to take a break” is a means of instructing a worker to pause work and take a break when he/she feels undue stress.

The system for implementing this invention consists of the following components.

First, the worker wears smart glasses to perform maintenance work. The smart glasses are equipped with a microphone and a camera, which can provide audio and video input.

### Hardware and Software Used

Hardware: smart glasses (e.g., Google Glass), microphone, camera

### Software: Prescribed API, Microsoft Azure Emotion API

### Data Processing and Data Arithmetic

### Voice Input and Recognition

1. voice input: the operator inputs the maintenance procedure by voice through the microphone of the smart glasses.

Speech Recognition: The server converts speech into text using a predefined API. This text is used to verify the accuracy of the work procedure.

### Procedure Evaluation

Procedure determination: The server determines if the converted text is a correct procedure. This determination is made by checking against a pre-trained database of work procedures.

### Emotional State Monitoring

4. emotion analysis: Acquire facial images of the worker through the Smart Glasses camera and analyze the emotional state using the Microsoft Azure Emotion API. Particular attention will be paid to stress levels that exceed a certain threshold.

### Result Display and Break Instructions

5. result display: The result of the decision and the emotional state are displayed on the smart glasses display. If the work procedure is correct, “Correct procedure” is displayed; if there is an error, “Incorrect procedure” is displayed.

6. break instruction: If the worker feels undue stress, the system pauses the work and instructs the worker to take a break.

### Concrete Example

Voice input: “Next, remove the screws.”

Procedure result: “Correct procedure.

Emotional analysis result: “The worker is under undue stress. Ask them to pause work and take a break.”

### Example of Prompt Text

Voice input: “Next, remove the screws.”

Procedure result: “Correct procedure.”

Emotional analysis result: “The worker is under undue stress. Tell them to pause work and take a break.”

In this way, work can proceed while confirming the accuracy of work procedures, and the emotional state of the worker can be monitored in real time to prompt a break at the appropriate time. This improves work efficiency and safety.

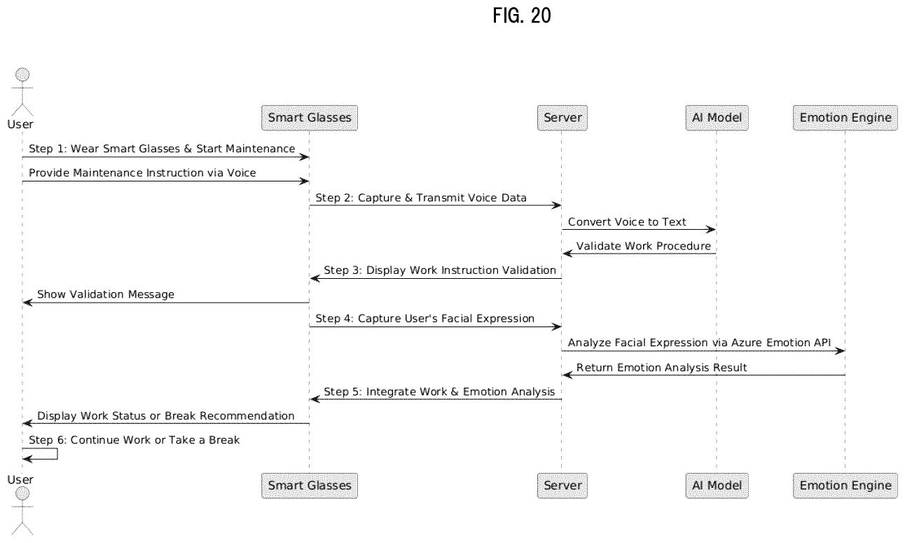

The flow of the identification process in example of application 2 is described in FIG. 20.

### Step 1:

The user puts on the smart glasses and begins a maintenance task. The user voice inputs the work procedure through the microphone of the smart glasses. The input voice data is captured by the microphone of the Smart Glasses.

### Step 2:

The server receives voice data sent from the smart glasses. The received voice data is sent to a predefined API, which converts the voice to text data. The input is voice data and the output is text data.

### Step 3:

The server matches the converted text data against a pre-trained database of work procedures. As a result of the cross-checking, the server determines whether the input procedure is correct or not. The input is the text data and the output is the judgment result regarding the correctness of the procedure.

### Step 4:

The server receives the user's facial image acquired through the smart glasses camera. The received face image is sent to the Microsoft Azure Emotion API to analyze the user's emotional state. The input is the face image data and the output is the result of the emotional state analysis.

### Step 5:

The server integrates the results of the determination of the procedure and the analysis of the emotional state and displays them on the smart glasses' display. If the procedure is correct, it displays “The procedure is correct,” and if there is an error, it displays “There is an error in the procedure. If the user is under undue stress, the display will indicate “Please ask the user to pause the work and take a break. The input is the judgment and analysis results, and the output is the message shown on the display.

### Step 6:

The user chooses whether to continue working or take a break according to the message displayed on the smart glasses display. If the user takes a break, the system pauses the work and prompts the user to take a break. The input is the message displayed on the display and the output is the user's action.

### Example 3

Next, example 3 of exemplary embodiment of implement will be described. In the following description, data processing device 12 is referred to as the “server” and smart device 14 is referred to as the “terminal.”

Conventional work support systems have the ability to determine the accuracy of a worker's movements and procedures, but could not provide feedback that took into account the worker's emotions and stress level. As a result, the worker's emotional burden increased, which could reduce work efficiency and safety. In addition, it was difficult to quickly find areas for improvement in work because the system did not sufficiently collect and analyze the real-time OK/NG judgment of work and emotional data.

The specific processing by the specific processing unit 290 of the data processing device 12 in Example 3 is realized by the following means.

In this invention, the server includes means for learning in advance the information required for the work (procedures, equipment images, past accident cases, etc.), means for inputting the operation screen and the procedures to be performed by voice through a visual device when performing the work, means for judging whether the work is OK/NG and displaying the answer on the visual device, means for The system includes means for collecting and analyzing emotional data, and means for suggesting improvements to the work based on the collected emotional data. This makes it possible to improve work efficiency and safety by providing feedback that takes into account the worker's emotions and stress level.

Information necessary for the work” refers to data necessary to perform the work accurately and safely, such as procedures, equipment images, and past accidents.

A “visual device” is a device that a worker wears to visually confirm the operation screen and procedures to be performed, and includes smart glasses.

The term “voice input means” refers to technology that allows operators to input operation screens and procedures to be performed using voice, and includes voice recognition technology.

The “OK/NG judgment method” is a technique for evaluating the accuracy and appropriateness of work and feeding the results back to the operator.

Emotional data collection means technology for detecting and collecting data on workers' emotions and stress levels.

The “emotional data analysis means” is technology for analyzing collected emotional data and evaluating changes in workers' emotions and stress levels.

The “means of suggesting improvements in work” is a technique for suggesting measures to improve work procedures and the environment based on the results of emotional data analysis.

This invention is a system to improve the efficiency and safety of workers, and is implemented by clarifying the roles of the server, terminal, and user.

### Server Role

The server provides a means to learn in advance the information required for the work (e.g., procedures, equipment images, past accident cases, etc.). Specifically, the server uses a database management system such as MySQL to collect and store past work data and accident cases. It then trains AI models based on the collected data, using machine learning frameworks such as TensorFlow for the AI models.

The server will perform the following processes:

1. retrieve historical work data and accident cases from the database

2. preprocess the acquired data and convert it into a format suitable for AI models.

3. train AI models using preprocessed data.

4. save the trained AI model and use it for OK/NG decision of the work.

### Role of the Terminal

The terminal collects data on the work performed by the worker in real time and transmits it to the server. The terminal is equipped with hardware such as cameras and sensors, which are used to collect work data. The collected data is temporarily stored in the terminal and periodically uploaded to the server.

The terminal performs the following processes:

1. collect work data using cameras and sensors.

2. temporarily store the collected data.

3. periodically transmit the stored data to the server.

### Role of the User

Users receive feedback provided by the system to help them improve their work. For example, if the system gives a NG decision for a particular task, the user can check the reason and review the work procedure. Also, if the affective engine detects stress in the worker, the user can use that information to improve the work environment.

The user shall do the following:

1. review feedback from the system.

2. review work procedures and environment based on feedback.

3. implement the improvements and again receive feedback on the system.

### Concrete Example

For example, a factory worker is assembling parts. The server trains an AI model based on past assembly data and accident cases, and the terminal collects data by capturing the worker's movements with a camera; the AI model judges whether the work is OK or NG in real time, and notifies the user of the reason if the work is NG. The emotion engine analyzes the worker's facial expression and provides information to the user if the worker is feeling stress.

### Example of Prompt Text

Please design a system that trains AI models based on past work data and accident cases, and determines whether work is OK or NG in real time. Also add a function to analyze the worker's emotions and provide information if they are feeling stressed.”

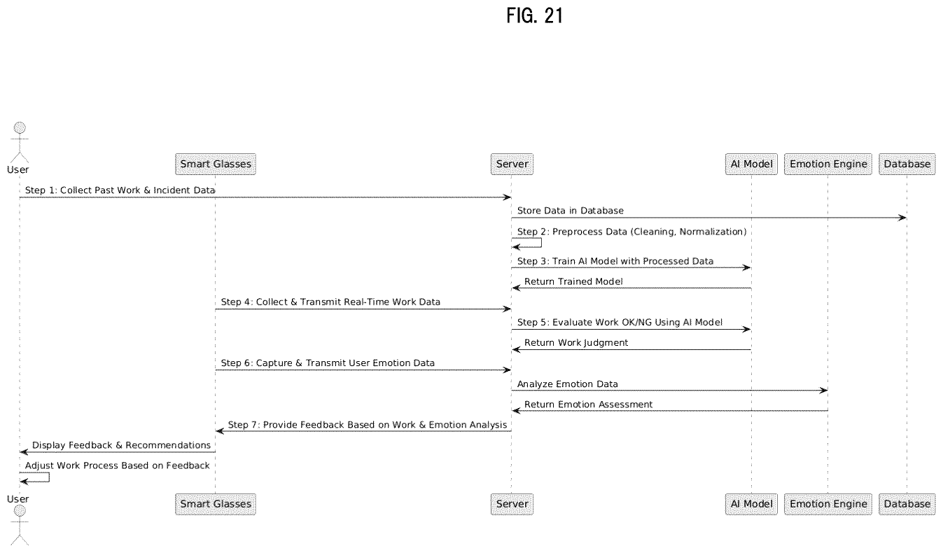

In this way, the roles of the server, terminal, and user are clarified, and the flow of data processing using specific hardware and software is explained to facilitate understanding of the overall system. The flow of specific processing in Example 3 is explained using FIG. 21.

### Step 1:

### Data Collection

The server collects historical work data and accident cases. Input includes data from each work station in the plant. This includes worker movement logs, sensor data from the work environment, and past accident reports. The server stores these data in a database such as MySQL. As a specific action, the server connects to the database and stores the collected data.

### Step 2:

### Data Preprocessing

The server preprocesses the collected data. As input, there is the raw data collected in step 1. Specific data processing includes completion of missing values, removal of anomalous values, and normalization of data. As output, a dataset in a format suitable for AI models is obtained. As a specific action, the server uses a Python library to clean the data and store the preprocessed data in a new table.

### Step 3:

### AI Model Training

The server trains the AI model using the preprocessed data. As input, there is the preprocessed data set from step 2. As specific data operations, a machine learning framework such as TensorFlow is used to build and train the model. As output, a trained AI model is obtained. As a specific operation, the server inputs training data to TensorFlow, trains the model, and saves the model when training is complete.

### Step 4:

### Real-Time Data Collection and Transmission

The terminal collects data on the work performed by the worker in real time and transmits it to the server. Inputs include data on the worker's movements and the work environment. As specific data collection, data is collected using cameras and sensors and stored temporarily. As output, the collected data is transmitted to the server. As specific operations, the terminal takes pictures of the worker's movements with a camera, collects data on the work environment with a sensor, and periodically transmits the data to the server.

### Step 5:

### OK/NG Judgment of Work

The server inputs the real-time data received into the AI model to determine if the work is OK/NG. As input, there is the real-time data collected in step 4. As specific data operation, data is input to the AI model to obtain the judgment result. As output, OK/NG judgment results are obtained. As specific operations, the server inputs the received data into the AI model, analyzes the output results of the model, judges OK/NG, and sends the judgment results to the terminal.

### Step 6:

### Emotional Data Collection and Analysis

The terminal collects the worker's emotional data and sends it to the server. Inputs include the worker's facial expressions and voice data. As specific data collection, data is collected using cameras and microphones and analyzed by the emotion engine. As output, the analyzed emotion data is sent to the server. As specific operations, the terminal captures the worker's facial expressions with a camera, records the worker's voice with a microphone, analyzes the data with the emotion engine, detects changes in emotion, and sends the data to the server.

### Step 7:

### Providing Feedback

Users receive feedback provided by the system to help them improve their work. Input includes the results of the OK/NG decision in Step 5 and the emotional data in Step 6. As specific feedback, the user is provided with suggestions for revising work procedures and improving the environment. As output, the improvement measures are implemented and the system again receives feedback. As a specific action, the user checks the feedback on the terminal screen, reviews the work procedures and environment based on the feedback, executes the improvement measures, and receives the system feedback again.

### Example of Application 3

Next, example 3 of application of example of implement 3 will be described. In the following description, data processing device 12 is referred to as the “server” and smart device 14 is referred to as the “terminal.”

Conventional work support systems did not provide sufficiently accurate judgments to improve work efficiency and safety, and did not take into account workers' emotions and stress in proposing improvements. This caused a problem of accumulated stress for workers, resulting in a decrease in work efficiency.

The specific processing by the specific processing unit 290 of the data processing device 12 in example of application 3 is realized by the following means. In this invention, the server has the means to learn in advance the information necessary for the work (procedures, equipment images, past accident cases, etc.), the means to input the operation screen and the procedures to be performed by voice through the smart glasses when performing the work, the means to judge whether the work is OK or NG and display the answer on the smart glasses, the means to collect the emotion data of the worker and to record and analyze the changes in the emotion, the means to propose the improvement of the work procedures based on the emotion data and the work data, and the means to improve the work procedures based on the emotion data. The system includes means to collect emotional data of the worker, record and analyze changes in emotions, and suggest improvements to the work procedure based on the emotional and work data. This enables not only to improve the efficiency and safety of the work, but also to reduce the stress of the workers and to improve the work procedures.

Information necessary for the work” refers to the data and knowledge required to perform the work, such as work procedures, equipment images, and past accident examples.

The term “means of learning” refers to methods and devices that use artificial intelligence to learn in advance the information necessary for a task.

Smart glasses” refers to a glasses-type device worn by the worker that provides a visual display of the operating screen and procedures to be performed.

The term “voice input means” refers to methods and devices that allow operators to use their voice to input information on operating screens and procedures to be performed.

The term “means for determining OK/NG” refers to methods and devices for determining the appropriateness of work and displaying the results on smart glasses.

“Emotional data” refers to data indicating the emotional state of the worker, such as the worker's heart rate and skin electrical response.

“Means for recording and analyzing changes in emotions” refers to methods and devices for collecting workers' emotional data, recording and analyzing those changes.

The term “means for suggesting improvements in work procedures” refers to methods and devices for finding and suggesting improvements in work procedures based on emotional and operational data.

The system for implementing this invention has the following structure. First, the server uses artificial intelligence (AI) to learn in advance the information necessary for the work (procedures, equipment images, past accident cases, etc.). Specifically, it learns patterns based on past work data and accident cases, and builds a model to determine whether work is OK or NG.

Next, smart glasses are used as the terminal. The smart glasses are worn by the worker and provide a visual display of the operation screen and procedures to be performed. The worker can use voice recognition technology to input the operation screen and procedures to be performed by voice. This allows the operator to perform operations without using his or her hands, thereby improving work efficiency.

In addition, the server collects emotional data from the worker, recording and analyzing changes in emotions. Emotional data includes heart rate and skin electrical response. These data are collected in real time using an emotion engine. The emotion engine analyzes the worker's emotional state and alerts the worker if stress is elevated.

Finally, the server suggests improvements in work procedures based on the emotional and work data. This will reduce the stress of workers and improve the efficiency of work procedures.

As a concrete example, consider the case of assembling parts in a factory. The server learns from past assembly operation data and accident cases, and builds a model to judge whether the operation is OK or NG. The worker wears smart glasses and inputs operation procedures by voice. The smart glasses visually display the operation screen and procedures so that the worker can perform the operation without using his/her hands. The emotion engine collects the worker's heart rate and skin electrical response in real time and alerts the worker when stress is elevated. The server suggests improvements to work procedures based on the emotional and operational data.

Examples of prompt statements may include the following:

Please create a program that uses current work data and emotion data as inputs to determine if a task is OK/NG and alerts the user if necessary. The work data will include position and speed data, and the emotion data will include heart rate and skin electrical response; the AI model will use a Random Forest classifier, and the emotion engine will use the EmotionEngine class.”

In this way, the exemplary embodiment of the invention can be shown in detail.

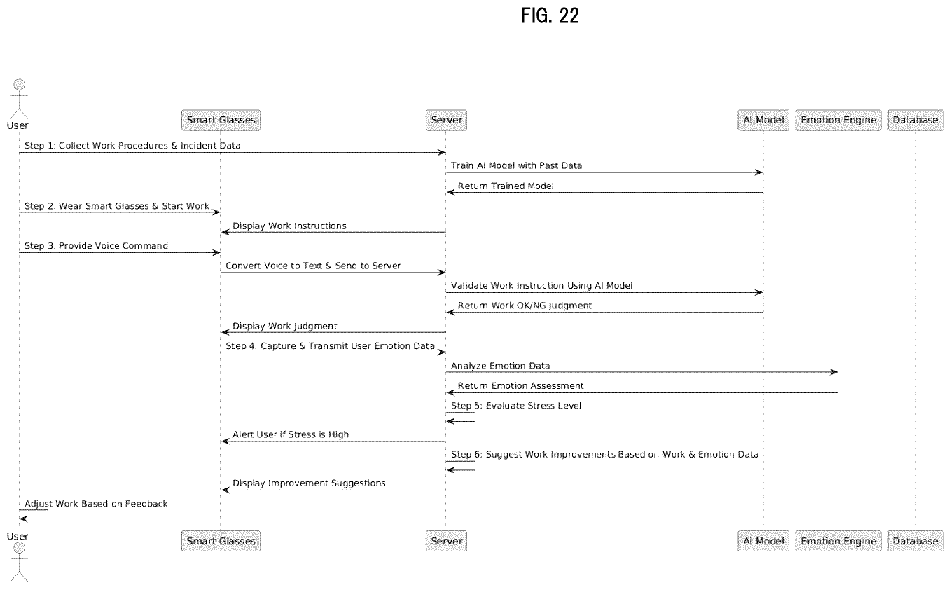

The flow of the identification process in example of application 3 is described in FIG. 22.

### Step 1:

The server collects information necessary for the work (procedures, equipment images, past accident cases, etc.) and learns using artificial intelligence (AI). Specifically, using past work data and accident cases as input, the system learns patterns and builds a model to determine whether work is OK or NG. As output, a learned AI model is obtained.

### Step 2:

The user puts on the smart glasses and begins to work. The smart glasses visually display the operation screen and the procedure to be performed. As input, it receives the work procedure data provided by the server, and as output, it provides visual instructions to the user.

### Step 3:

The user uses voice recognition technology to input the operating procedures by voice.

Smart Glass converts the voice input into text data and sends it to the server. Receive the user's voice data as input and generate text data as output.

### Step 4:

The server receives text data sent from the smart glasses and judges whether the work is OK or NG using a learned AI model. It uses the text data and the trained AI model as input and data generation model as output to determine if the task is OK or NG.

### Step 5:

The server sends the OK/NG decision results of the work to the smart glasses and displays them visually to the user. Receive the OK/NG decision results as input and provide visual feedback to the user as output.

### Step 6:

The server uses an emotion engine to collect real-time emotional data (e.g., heart rate, skin electrical response, etc.) from the worker. It receives data from emotion sensors as input and generates emotion data as output.

### Step 7:

The server analyzes the collected emotional data and evaluates the stress level of the worker. It uses the emotional data as input and generates the results of the stress level assessment as output.

### Step 8:

The server issues an alert and notifies the smart glasses if the stress level is high. It receives the results of the stress level assessment as input and generates an alert notification as output.

### Step 9:

The server proposes improvements to work procedures based on emotion and work data. It uses emotion and work data as input and generates improvement suggestions as output.

### Step 10:

The server sends suggestions for improving work procedures to the smart glasses and provides a visual display to the user. Receive suggestions for improvement as input and provide visual feedback to the user as output.

The specific processing unit 290 sends the results of the specific processing to the smart device 14. In smart device 14, control unit 46A causes output device 40 to output the results of the specific processing. Microphone 38B acquires audio indicating user input to the results of the specific processing. The control unit 46A transmits the voice data indicating the user input acquired by the microphone 38B to the data processing device 12. In data processing device 12, specific processing unit 290 acquires the voice data.

The data generation model 58 is the so-called Generative AI (Artificial Intelligence). De

An example of a data generation model 58 is a generated AI such as ChatGPT (registered trademark) (Internet search <URL: https://openai.com/blog/chatgpt>). The data generation model 58 is

The data is obtained by having a neural network perform deep learning on a neural network. Prompts containing instructions are input to the data generation model 58, and data for inference, such as voice data indicating voice, text data indicating text, and image data indicating images, are input to the model 58. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (registered trademark) (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the smart device 14.

### Second Exemplary Embodiment

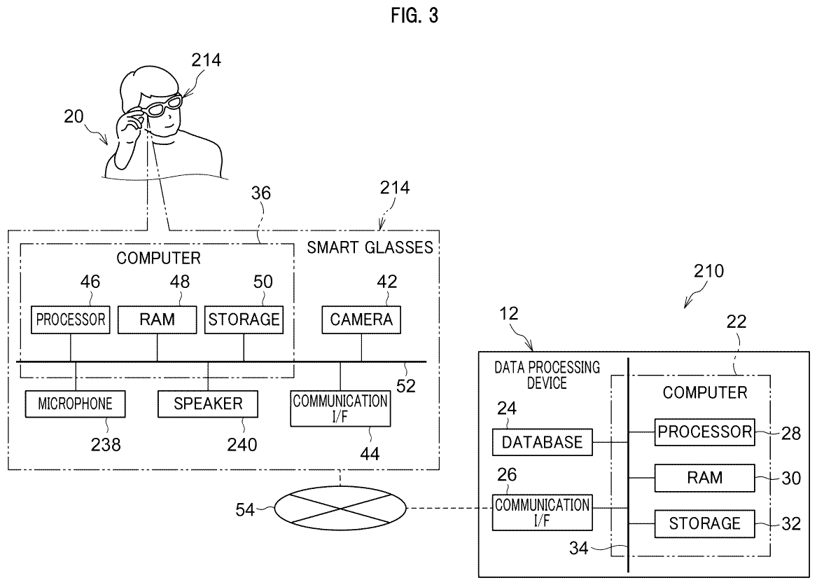

FIG. 3 shows an example of implement of a data processing system 210 for the second exemplary embodiment

The following is a list of the most common problems with the

As shown in FIG. 3, data processing system 210 includes data processing device 12 and smart glasses 214. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Smart glasses 214 have a computer 36, microphone 238, speaker 240, camera 42, and communication I/F 44. The computer 36 has a processor 46, RAM 48, and storage 50. Processor 46, RAM 48, and storage 50 are connected to bus 52. The microphone 238, speaker 240, and camera 42 are also connected to the bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and images the surroundings of the user 20 (for example, the imaging range defined by an angle of view equivalent to the field of view of an average healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner.

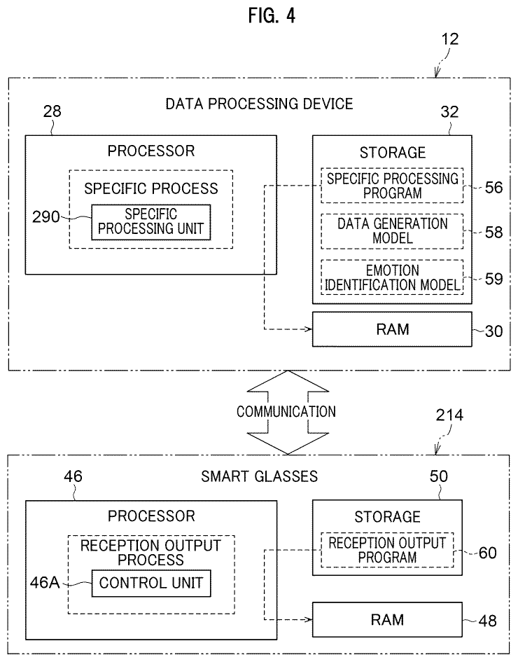

FIG. 4 shows an example of the key functions of data processing device 12 and smart glasses 214. As shown in FIG. 4, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

In smart glasses 214, the processor 46 performs the reception output process. Stray.

The reception output program 60 is stored in the storage 50. Processor 46 reads reception output program 60 from storage 50 and executes the read reception output program 60 on RAM 48. The reception output process is realized by the processor 46 operating as control unit 46A according to the reception output program 60 executed by the processor 46 on RAM 48.

Next, the specific processing by the specific processing unit 290 of the data processing device 12 is described.

### Example of Implement 1.″

One exemplary embodiment of this invention is a system in which workers wear smart glasses and learn in advance information such as work procedures, equipment images, and past accidents. The worker can view the operation screen through the smart glasses and can input voice instructions. The system determines whether work is OK or NG based on the worker's voice input and displays the results on the smart glasses' display.

### Example of Implement 2.″

As a concrete example, consider the case where a worker performs maintenance work on equipment. The worker wears the smart glasses and inputs the maintenance work procedure by voice. The system determines whether the input procedure is correct and displays the result on the Smart Glasses' display. In this way, the worker can proceed with the work while checking whether his/her work is correct or not.

### Example of Implement 3.″

The system can also use artificial intelligence to learn work information. The artificial intelligence learns patterns from past work data and accident cases, and judges whether work is OK/NG based on these patterns. This allows the system's judgment accuracy to improve over time, further enhancing worker work efficiency and safety.

The following is a description of the process flow for each example of implement.

### Example of Implement 1.″

Step 1: The worker wears the smart glasses.
Step 2: Smart glasses learn the information necessary for the work (procedures, equipment images, past accidents, etc.) in advance.
Step 3: The operator can view the operation screen through smart glasses and input instructions by voice.
Step 4: The system determines if the work is OK/NG based on the worker's voice input and displays the results on the smart glasses' display.

### Example of Implement 2.″

Step 1: When a worker performs maintenance work on equipment, he or she first puts on the smart glasses.
Step 2: The operator voice-enters the maintenance procedure.
Step 3: The system determines if the entered procedure is correct and displays the result on the smart glasses display.
Step 4: Workers proceed based on system feedback.

### Example of Implement 3.″

Step 1: The system learns work information using artificial intelligence.
Step 2: Artificial intelligence learns patterns from past work data and accident cases.
Step 3: Based on the learned patterns, the system determines if the work is OK/NG.
Step 4: The results of the decision are displayed on the smart glasses display, and the worker proceeds based on the feedback.

### Example 1

The following is an example of exemplary embodiment of implement. In the following description, data processing device 12 will be referred to as the “server” and smart glasses 214 will be referred to as the “terminal.”

In conventional work support systems, it was difficult for workers to efficiently learn information such as procedures, equipment images, and past accident cases, and to receive appropriate instructions during work. There were also issues with the accuracy of voice input instructions and the speed of OK/NG decisions for work. This could reduce work efficiency and safety.

The specific processing by the specific processing unit 290 of the data processing device 12 in Example 1 is realized by the following means. In this invention, the server has the following means: a means to learn information necessary for the work (procedures, equipment images, past accident cases, etc.) in advance; a means to input the operation screen and procedures to be performed by voice through the smart glasses when performing the work; a means to judge whether the work is OK or NG and display the answer on the smart glasses; a means to analyze voice data is analyzed and converted into text, and a prompt sentence is generated using a generation AI model to determine the OK/NG of the task. This enables the operator to efficiently learn information, improve the accuracy of voice input instructions, and quickly determine the OK/NG of the work.

“Information necessary for the work” refers to knowledge and data necessary to perform the work, such as procedures, equipment images, and past accident examples.

A “means of learning” is a method or device by which a worker learns in advance the information necessary to perform a task.

“Smart glasses” are wearable devices that are worn by workers to display operational screens and information.

The “operation screen” is a screen displayed on the smart glasses that shows information such as work procedures and instructions.

A “means of voice input” is a method or device that allows a worker to input instructions or information using voice.

“Means to determine OK/NG” is a method or device used to evaluate the progress or results of work and determine if it is appropriate or not.

“Means for analyzing speech data and converting it to text” refers to methods and devices for converting speech data to text using speech recognition technology.

The “Generative AI Model” is a model that uses artificial intelligence to generate prompt sentences and determine if the work is OK/NG.

A “prompt sentence” is an instruction sentence to be input into the generated AI model, and is used as the basis for the OK/NG judgment of the work.

### Exemplary Embodiment of the Invention

This invention is a system in which workers wear smart glasses and learn information such as work procedures, equipment images, and past accident cases in advance. The worker can view the operation screen through the smart glasses and can input voice instructions. The system determines whether work is OK or NG based on the worker's voice input and displays the results on the smart glasses' display.

### 1. Program Generation

The server generates a program for workers to wear smart glasses to learn information such as work procedures, equipment images, and past accident cases in advance. This program includes a function that allows the worker to view the operation screen through the smart glasses and input instructions by voice.

### Explanation of Program Processing

The server installs the generated program in the smart glasses. When worn by a worker, the smart glasses display information such as work procedures, equipment images, and past accident examples. The worker can view this information through the Smart Glasses' display.

When a worker inputs voice instructions, the smart glasses transmit the voice data to the server. The server converts the voice data into text using voice recognition software (e.g., speech recognition technology). It then uses a generative AI model (e.g., artificial intelligence model) to generate prompt sentences to determine whether the input instructions are OK/NG for the task.

The server inputs the generated prompt sentences to the AI model and obtains the results to determine if the work is OK/NG. The acquired results are sent to the smart glasses and displayed on the smart glasses' display.

### 3. Examples of Specific Examples and Prompt Sentences

As a concrete example, consider the case where a worker enters voice instructions, “Please tell me the next work procedure.” In this case, the server generates the following prompt sentence:

### Example of a Prompt Statement:

The worker wants to know what the next step is. “Please tell me what the next step is.”

The server inputs this prompt sentence to the generative AI model to retrieve the next work procedure. The retrieved work procedure is displayed on the smart glasses display.

In this way, workers can check information such as work procedures, equipment images, and past accident cases through smart glasses, and judge whether work is OK or NG by inputting voice instructions.

The flow of the identification process in Example 1 is described in FIG. 11.

### Step 1:

### Smart Glass Activation and Connection

The user puts on the smart glasses and turns them on.

The terminal (smart glasses) connects to the server through Wi-Fi.

Input: Smart Glass power on, Wi-Fi connection information

Output: Connection established with server

### Step 2:

### Display of Work Procedures and Information

The server recognizes the worker's ID and sends information such as related work procedures, equipment images, and past accidents to the smart glasses.

The terminal displays the received information on its display. For example, a list of work procedures and images of equipment are displayed.

Input: Worker's ID, relevant information

Output: Work procedures and equipment images displayed on smart glasses

### Step 3:

### Input of Voice Instructions

The user enters voice instructions into the smart glasses. For example, he/she says, “Please tell me the next step in the workflow.”

Input: User's voice instructions

Output: Audio data

### Step 4:

### Transmission and Analysis of Voice Data

The terminal sends the user's voice data to the server.

The server uses speech recognition software (e.g., speech recognition technology) to convert voice data into text.

Input: Voice data

Output: Text data

### Step 5:

### OK/NG Judgment of Work

The server generates prompt statements based on the converted text. For example, “The worker wants to know the next work procedure. Please tell me what the next step is.” The server generates the prompt sentence “The worker wants to know the next step.

The server inputs this prompt statement to the generating AI model (e.g., artificial intelligence model) to obtain the next work procedure and the OK/NG decision for the work.

Input: text data, prompt statements

Output: Work procedures and OK/NG decisions

### Step 6:

### Display of Judgment Results

The server sends the retrieved results to the smart glasses.

The terminal displays the results received on its display. For example, “The next work step is to install part A.” or “The work is OK.” will be displayed.

Input: work procedures and OK/NG decisions

Output: Results displayed on smart glasses

### Example of Application 1

Next, example of application 1 of example of implement 1 will be described. In the following description, the data processing device 12 will be referred to as the “server” and the smart glasses 214 will be referred to as the “terminal.”

In conventional factory operations, workers spent a lot of time and effort to check procedures and equipment conditions. In addition, it was difficult to refer to past accident cases, and work safety was not sufficiently ensured. Furthermore, the lack of a means to report and properly evaluate the progress of work in real time reduced work efficiency. To solve these problems, there is a need for a system that allows operators to work efficiently and safely using smart glasses.

The specific processing by the specific processing unit 290 of the data processing device 12 in example of application 1 is realized by the following means.

In this invention, the server has means to learn in advance the information necessary for the work (procedures, equipment images, past accident cases, etc.), means to input the operation screen and the procedures to be performed by voice through the smart glasses when performing the work, means to judge whether the work is OK or NG and display the answer on the smart glasses, means to display the real-time status of the equipment The system includes means to display the real-time status of the equipment, means to display past accident cases and alert the operator, means to report the progress of the work based on voice input, means to judge whether the work is OK or NG based on the progress of the work, and means to display the results on the smart glasses display. This enables the worker to obtain the necessary information in real time and perform the work efficiently and safely.

“Information necessary for the work” refers to information necessary to perform the work, such as work procedures, equipment images, and past accidents.

A “means of learning in advance” is a means of acquiring and understanding the information needed to perform a task in advance.

“Smart glasses” are eyeglass-shaped devices worn by workers to display information.

The “operation screen” is the interface that the operator can see through the smart glasses.

A “voice input means” is a means by which a worker inputs instructions or information using voice.

The “means to determine OK/NG” is a means to evaluate the progress and results of the work and to determine if they are appropriate or not.

The “means of displaying the answer on the smart glasses” is a means of displaying the judgment result on the smart glasses' display.

“Means for displaying the real-time status of equipment” means a means for displaying the current status of equipment in real time.

The “means of displaying past accident cases and alerting the operator” is a means of displaying past accident cases and alerting the operator.

A “means for reporting work progress based on voice input” means a means for reporting work progress based on a worker's voice input.

The “means to determine whether work is OK/NG based on the progress of the work” is a means to evaluate the progress of the work and to determine whether the work is being performed properly.

The “means for displaying on the smart glasses display” is a means for displaying the judgment results and other information on the smart glasses display.

The system for implementing this invention allows workers to wear smart glasses and check information such as work procedures, equipment conditions, and past accidents in real time. An exemplary embodiment of this system is described below.

### Hardware and Software Used

Smart glasses: A glasses-type device worn by the worker and used to display information.

Microphone: Device used to capture the operator's voice input.

Server: A computer system that manages the information needed to do a job and processes voice input.

speech_recognition library: Software for converting spoken input into text.

smart_glasses_display module: custom software for displaying information on smart glasses displays.

factory_system module: Custom software to obtain work procedures, equipment status, and past accident cases from the factory system and determine if work is OK/NG.

### System Operation

1. display of work procedures: The server displays the necessary procedures for a task on the Smart Glasses' display. This allows the operator to see, in real time, what needs to be done next.

Confirmation of equipment status: The server obtains the real-time status of the equipment and displays it on the smart glasses. This allows workers to proceed with their work while keeping track of the current status of the equipment.

3. display of past accidents: The server displays past accidents on the smart glasses to alert the operator. This allows workers to refer to past mistakes and work safely.

4. capturing voice input: A worker enters spoken instructions through a microphone. The server converts the voice into text using the speech_recognition library.

5. work progress reporting: Based on the worker's voice input, the server reports the progress of the work. This allows the worker to report progress without using his/her hands.

6. work OK/NG judgment: The server judges work OK/NG based on voice input using the factory_system module.

Display of results: The results of the evaluation are displayed on the Smart Glasses display. This allows the operator to check the evaluation of the work in real time.

### Concrete Example

When a worker wears the smart glasses and performs maintenance work on equipment, the following procedure is used to use the application.

1. voice input to the smart glasses, “Display the next work procedure”.

2. voice input to the smart glasses, “Check the condition of the equipment.

3. voice input to Smart Glasses, “Show past accident cases.

4. when the work is completed, voice input “work completed”.

The server determines whether the work is OK or NG and displays the results on the smart glasses.

### Example of Prompt Text

Show next steps.

“Check the condition of the equipment.”

“View past accidents.”

“Work completed.”

Thus, the use of smart glasses can significantly improve work efficiency and safety in the factory.

The flow of the identification process in Example of Application 1 is described in FIG. 12.

### Step 1:

The server learns in advance the information required for the work (e.g., procedures, equipment images, past accidents, etc.). This includes acquiring data from the factory system and using artificial intelligence to organize and analyze the information. The input is data from the factory system, and the output is the organized and analyzed work procedures, equipment images, and past accident cases.

### Step 2:

The user puts on the smart glasses and starts working. The server displays the work procedure on the smart glasses display. The input is the work procedure data from the server and the output is the work procedure displayed on the smart glasses display.

### Step 3:

The user inputs spoken instructions through a microphone. The server converts the voice into text using the speech_recognition library. The input is the user's voice instructions and the output is the instructions in text format.

### Step 4:

The server obtains the real-time status of the equipment based on the text form instructions and displays it on the smart glasses. The input is the instruction in text format and the output is the real-time status of the facility displayed on the smart glasses' display ray.

### Step 5:

The server retrieves past accident cases and displays them on the smart glasses. The input is the user's voice instructions, and the output is the past accident cases displayed on the smart glasses display.

### Step 6:

A user reports the progress of his/her work by voice. The server converts the voice into text using the speech_recognition library and records the work progress. The input is the user's voice report and the output is the progress report in text format.

### Step 7:

The server judges the work OK/NG based on the progress report in text format. The input is the progress report in text format, and the output is the OK/NG judgment result of the work.

### Step 8:

The server displays the decision results on the smart glasses display. The input is the OK/NG judgment result of the work, and the output is the judgment result displayed on the smart glasses display.

### Example 2

Next, example 2 of exemplary embodiment of implement will be described. In the following description, data processing device 12 will be referred to as the “server” and smart glasses 214 will be referred to as the “terminal.”

In conventional maintenance work, workers are required to accurately grasp and execute procedures, but it is sometimes difficult to check procedures and determine their accuracy. In addition, workers need to use their hands to check procedures during work, which is problematic and reduces work efficiency. Furthermore, even when voice input is used, accurate analysis of voice data and determination of procedures is difficult, and real-time feedback may not be obtained. To solve these problems, there is a need for a system that uses voice input to confirm procedures and provide real-time feedback

The specific processing by the specific processing unit 290 of the data processing device 12 in Example 2 is realized by the following means.

In this invention, the server has means to learn in advance the information necessary for the work (procedures, equipment images, past accident cases, etc.), means to input the operation screen and the procedure to be performed through the smart glasses by voice when performing the work, means to judge whether the work is OK or NG and display the answer on the smart glasses, means to convert voice means to convert the data into text data, means to analyze the text data to determine the accuracy of the procedure, means to transmit the results of the determination to the smart glasses, and means to display the results of the determination on the smart glasses' display. This allows the operator to check the procedure using voice input and receive real-time feedback while accurately performing the maintenance task.

“Information necessary for the work” refers to information necessary to perform maintenance work, such as procedures, equipment images, and past accidents.

The “means of learning” are the methods and techniques used to obtain and understand the information needed for a task in advance.

“Smart glasses” are wearable devices with built-in displays and microphones that enable voice input and information display.

The “operation screen” is a screen on the smart glasses' display that allows the user to review work procedures and other information.

The term “voice input means” refers to methods and techniques that allow operators to use their voice to input information about the operating screens and procedures to be performed.

“Means to determine OK/NG” is a method or technique to determine if an input procedure is correct or not.

The “means of displaying the answers” is the method or technique used to display the judgment results on the smart glasses' display.

“Means for converting voice data to text data” refers to methods and techniques for converting voice input to text format.

“Means for analyzing text data to determine the accuracy of a procedure” refers to methods and techniques for analyzing text data and determining whether the entered procedure is correct.

“Means for transmitting judgment results to smart glasses” refers to methods and techniques for transmitting judgment results of procedure accuracy to smart glasses.

The “means for displaying the judgment result on the smart glasses display” is a method or technique for displaying the judgment result on the smart glasses display.

### Exemplary Embodiment of the Invention

This invention is a system that allows workers to voice input procedures using smart glasses when performing maintenance work on equipment, and to determine the accuracy of those procedures in real time. An exemplary embodiment of this system is described below.

### Hardware and Software Used

Smart Glasses: Wearable devices with built-in displays and microphones that allow voice input and information display.

Server: A computer system that analyzes audio data, determines procedures, and transmits the results.

Speech recognition technology for converting voice data to text data.

Generative AI model (e.g., OpenAI's GPT-4): an artificial intelligence model for analyzing textual data and determining the accuracy of procedures.

### System Operation

### 1. Voice Input: 1.

The user wears the smart glasses and voice inputs maintenance procedures. For example, the user voice inputs a procedure such as “remove the filter.”

### 2. Transmission of Voice Data: (1)

The terminal (smart glasses) captures audio data through a built-in microphone and sends the data to the server. Wi-Fi and Bluetooth are used for communication.

### 3. Audio Data Conversion

The server converts the received voice data into text data using a predefined API. This API provides highly accurate speech recognition.

### 4. Procedure Determination:

The server uses a generation AI model (e.g., OpenAI's GPT-4) to determine if the maintenance procedures retrieved as text data are correct. This determination includes a process of checking against a predefined database of correct procedures.

### Transmission of Judgment Results: 5.

The server determines the accuracy of the procedure and sends the results to the smart glasses. Wi-Fi and Bluetooth are again used for communication.

### 6. Display of Results:

The terminal (smart glasses) displays the received decision on its display. For example, “The procedure is correct. Please proceed to the next step.” and so on.

### Concrete Example

As a concrete example, consider the case where a worker changes the filter of an air conditioner.

1. the user puts on the smart glasses and voice-types “remove filter”.

The terminal (smart glasses) sends this voice data to the server.

The server converts the voice data into text data “remove filter” using a predefined API. 3.

4. the server uses the data generation AI model to determine if this text data is the correct procedure. For example, it will check to see if the procedure “remove filter” exists in the database.

5. the server sends the judgment result “the procedure is correct” to the smart glasses.

6. the terminal (smart glasses) displays the result of this determination on its display and tells the user, “Step is correct. Please proceed to the next step.” and informs the user, “Please proceed to the next step.”

### Example of Prompt Text

User: “Remove the filter.”

Server: “The procedure is correct. Please proceed to the next step.”

User: “Install new filter”

Server: “The procedure is correct. Maintenance work has been completed.”

In this way, users can accurately proceed with maintenance tasks while receiving real-time feedback.

The flow of the identification process in Example 2 is described in FIG. 13.

### Program Processing Flow

### Step 1: Voice Input

The user wears the smart glasses and voice inputs maintenance procedures. For example, the user voice inputs a procedure such as “remove the filter.”

Input: User's voice instructions

Output: Audio data captured by the Smart Glass microphone

### Step 2: Transmission of Voice Data

The terminal (smart glasses) sends the captured voice data to the server through the built-in microphone. Wi-Fi and Bluetooth are used for communication.

Input: Audio data captured by the Smart Glass microphone

Output: Audio data sent to server

### Step 3: Convert Audio Data

The server converts the received voice data into text data using a predefined API. This API provides highly accurate speech recognition.

Input: Audio data sent to the server

Output: text data (e.g., “remove filter”)

### Step 4: Determination of Procedure

The server uses a generation AI model (e.g., OpenAI's GPT-4) to determine if the maintenance procedures retrieved as text data are correct. This determination involves a process of checking against a predefined database of correct procedures.

Input: text data (e.g., “remove filter”)

Output: Judgment result (e.g., “The procedure is correct.”)

### Step 5: Transmission of Judgment Results

The server determines the accuracy of the procedure and sends the results to the smart glasses. Wi-Fi and Bluetooth are again used for communication.

Input: Judgment result (e.g., “The procedure is correct.”)

Output: Judgment results sent to Smart Glass

### Step 6: Display Results

The terminal (smart glasses) displays the received decision on its display. For example, “The procedure is correct. Please proceed to the next step.” and so on.

Input: Judgment results sent to Smart Glass

Output: A message on the Smart Glass display (e.g., “The procedure is correct. Please proceed to the next step.”)

### Examples of Specific Actions

User: Speech: “Remove filter”.

Terminal (smart glasses): Transmits voice data to the server.

Server: Converts voice data to text data using a specified API.

4. server: analyze text data using the data generation model to determine the accuracy of the procedure.

Server: Transmits judgment results to smart glasses.

6. terminal (smart glasses): the result of the decision is shown on the display and the message “The procedure is correct. Please proceed to the next step. and informs the user.

In this way, users can accurately proceed with maintenance tasks while receiving real-time feedback.

### Example of Application 2

Next, example of application 2 of example of implement 2 will be described. In the following description, the data processing device 12 will be referred to as the “server” and the smart glasses 214 will be referred to as the “terminal.”

In conventional maintenance work, workers are required to accurately understand and implement procedures, but because there is a lack of a means to confirm procedures and the accuracy of work in real time, work errors and loss of efficiency can occur. In addition, there is a need for a system that allows workers to voice input procedures and immediately check their accuracy. The challenge is to improve work efficiency and accuracy through this

The specific processing by the specific processing unit 290 of the data processing device 12 in example of application 2 is realized by the following means.

In this invention, the server includes means to learn in advance the information required for the work (procedures, equipment images, past accident cases, etc.), means to input the operation screen and the procedures to be performed through the smart glasses by voice when performing the work, means to judge whether the work is OK/NG and display the answer on the smart glasses, and means to display the voice means to judge the inputted procedure in real time and display the result on the smart glasses display. This allows the operator to efficiently proceed with maintenance work while confirming the accuracy of the work in real time.

“Information necessary for the work” refers to information required to perform maintenance work, such as procedures, equipment images, and past accident examples.

The “means of learning” is a means of learning in advance the information necessary for a task, which is done using artificial intelligence.

“Smart glasses” are eyeglass-shaped devices worn by the operator that display an operation screen and the procedures to be performed, and can accept voice input.

The “operation screen” is a screen displayed on the smart glasses that the operator refers to when performing maintenance tasks.

A “voice input means” is a means for a worker to input maintenance procedures using voice, and is performed using voice recognition technology.

The “means to determine OK/NG” is a means to determine whether the entered maintenance procedure is correct or not.

The “means of displaying the answers” is a means for displaying the judgment results on the smart glasses' display.

The “real-time judging means” is a means for immediately judging the voice-input procedure and displaying the results in real time.

The “display” is a display device mounted on the smart glasses that shows the judgment results and operation screens.

The system for implementing this invention is such that when a worker wears the smart glasses and performs a maintenance task, the system inputs the procedure by voice, determines in real time whether the procedure is correct, and displays the result on the smart glasses' display.

### System Configuration

The system consists of the following major components

1. smart glasses: These are eyeglass-shaped devices worn by the worker and equipped with a display that shows the operation screen and judgment results. They are also equipped with a microphone that accepts voice input.

2. server: processes the input procedure using speech recognition technology and artificial intelligence to determine the input procedure.

3. speech recognition software: Software for converting voice input into text, e.g., using Google's speech recognition API.

4. artificial intelligence model: This model is used to learn the information required for a task in advance and to determine whether the input procedure is correct or not.

### Program Processing

The server operates as follows:

1. acquisition of voice input: the operator's voice is acquired through the microphone of the smart glasses.

2. speech recognition: Acquired speech is converted into text using speech recognition software.

3. procedure determination: The converted text is input into the artificial intelligence model to determine if the procedure is correct.

4. display of the result: The result of the judgment is displayed on the display of the smart glasses.

### Hardware and Software Used

Hardware: Smart glasses, microphone
Software: Python, SpeechRecognition library, Smart Glass SDK, artificial intelligence models (e.g., TensorFlow)

### Concrete Example

For example, when a technician performs maintenance work on a robot, he or she can voice-activate the robot, remove the cover, and inspect the internal components. This voice is captured through the microphone of the smart glasses and converted into text by the voice recognition software. The converted text is sent to the server, where an artificial intelligence model determines the accuracy of the procedure. The result of the judgment is shown on the smart glasses' display as “The procedure is correct.”

### Example of Prompt Text

Turn off the robot, remove the cover, and inspect the internal components.

In this way, workers can efficiently proceed with maintenance work while checking the accuracy of the work in real time.

The flow of the identification process in example of application 2 is described in FIG. 14.

### Step 1:

The user puts on the smart glasses and begins the maintenance procedure. The user voice inputs the maintenance procedure into the microphone of the smart glasses. The voice input is a specific procedure, for example, “Turn off the robot, remove the cover, and inspect the internal parts.” Input: User's voice. Output: voice data.

### Step 2:

The smart glasses send the acquired voice data to the server. The server uses speech recognition software (e.g., Google's speech recognition API) to convert the voice data into text data. Input: voice data. Output: text data.

### Step 3:

The server inputs the converted text data to the artificial intelligence model. The artificial intelligence model checks the data against a database of maintenance procedures learned in advance to determine if the input procedure is correct. Input: text data. Output: Judgment result (correct/wrong).

### Step 4:

The server sends the judgment results to the smart glasses. The smart glass displays the judgment result on its display. For example, messages such as “The procedure is correct” or “The procedure is incorrect. Please reconfirm.” Messages such as “The procedure is correct” or “The procedure is incorrect, please reconfirm.” Input: Judgment result. Output: Message shown on the display.

### Step 5:

The user checks the results of the decision on the smart glasses display and corrects the procedure if necessary. If the correct procedure is displayed, the user continues with the work. Input: A message shown on the display. Output: User action (modify the procedure or continue working).

In this way, users can check the accuracy of maintenance procedures in real time.

### Example 3

Next, example 3 of exemplary embodiment of implement will be described. In the following description, the data processing device 12 will be referred to as the “server” and the smart glasses 214 will be referred to as the “terminal”.

Conventional work support systems required operators to manually determine the safety and efficiency of work, which entailed a high risk of work errors and accidents. In addition, there was a lack of means to effectively utilize past accident cases and work data, and work improvements and safety measures were not sufficiently implemented. Furthermore, it was difficult to provide real-time work support, which placed a heavy burden on workers.

The specific processing unit 290 of the data processing device 12 in Example 3 is realized by the following means.

In this invention, the server includes means for acquiring past work data and accident cases from a database and pre-processing them, means for training an artificial intelligence model using the pre-processed data, and means for inputting new work data and using the artificial intelligence model to determine whether work is OK or NG. This makes it possible to effectively utilize past data and automatically determine the safety and efficiency of work in real time.

“Information necessary for the work” refers to the data and knowledge required to perform the work, such as procedures, equipment images, and past accident examples.

“Smart glasses” refers to wearable devices that can be worn by workers to visually display operating screens and procedures to be performed.

The term “voice input means” refers to technology that allows operators to use voice to give operating instructions or input data.

The term “means to determine OK/NG” refers to technology used to evaluate the safety and efficiency of work and determine the results as OK or NG.

The term “database” refers to an information management system that systematically stores past work data and accident cases and allows retrieval and retrieval as needed.

The term “means of preprocessing” refers to technology that converts collected data into a format suitable for artificial intelligence models by completing missing values, normalization, feature extraction, and other processing.

The term “artificial intelligence model” refers to a model that uses machine learning algorithms to learn data and perform a specific task (in this case, the OK/NG decision for a task).

The term “means to train” refers to techniques for training artificial intelligence models using preprocessed data to improve their performance.

“New work data” refers to information about current or future work, on the basis of which the artificial intelligence model determines whether the work is OK or NG.

The term “means to provide feedback” refers to technology that notifies users of the results of judgments made by the artificial intelligence model and encourages them to improve their work or take safety measures.

This invention is a system to improve the safety and efficiency of operations and can be implemented as follows

First, users use a development environment such as Python or TensorFlow to generate a program for the system. The program includes code to build an artificial intelligence (AI) model and to learn from historical work data and accident cases.

The server retrieves past work data and accident cases provided by users from a database (e.g., MySQL). Next, the server preprocesses these data and converts them into a format suitable for AI models. Specifically, data cleaning, normalization, and feature extraction are performed.

The server then trains the AI model using a machine learning library such as TensorFlow. Once training is complete, the server receives new work data as input and uses the AI model to determine if the work is OK/NG.

As a concrete example, consider the case of factory work data. A user inputs past work data (e.g., work hours, equipment used, years of experience of workers) and accident cases (e.g., types, causes, and effects of accidents) into the system. The server learns these data and determines whether the work is safe or not when new work data is input.

### Example of a Prompt Statement:

Based on historical work data and case studies of accidents, determine if current work is safe.”

This system is expected to improve the efficiency and safety of workers. The flow of the identification process in Example 3 is described in FIG. 15.

### Step 1: Data Collection

Users upload past work data and accident cases to the system. Specifically, the data is extracted from a CSV file or database. Input is information such as work hours, equipment used, operator's years of experience, type of accident, cause, and impact. The output is that these data are stored on the server.

### Step 2: Data Preprocessing

The server preprocesses the collected data. Specifically, it completes missing values, normalizes data, and performs categorical data encoding. The input is the raw data collected in step 1. The output is the preprocessed data set. For example, missing values are complemented with averages, work hours are normalized, and instruments used are one-hot encoded.

### Step 3: AI Model Training

The server uses the preprocessed data to train AI models. Specifically, machine learning libraries such as TensorFlow are used. The input is the preprocessed data set from step 2. The output is the trained AI model. Training can take several hours.

### Step 4: Input Work Data

Users enter new work data into the system. Specifically, the data is entered in real-time or processed in batches. Inputs are information such as the start time of the new work, the equipment used, and the worker's years of experience. The output is that these data are stored on the server.

### Step 5: OK/NG Judgment of Work

The server passes the new work data entered to the AI model to determine if the work is OK/NG. Specifically, the AI model evaluates the safety and efficiency of the work. The input is the new work data entered in step 4. The output is the result of the OK/NG judgment of the work. For example, a judgment such as “NG because the work time is too long” is made.

### Step 6: Feedback on Results

The server will provide feedback to the user on the results of the decision. Specifically, the system notifies the user and displays a dashboard. Input is the judgment result obtained in step 5. The output is the feedback information to the user. The user reviews the work plan based on the result. For example, they take measures such as “shortening the work time” or “changing the equipment used.

### Example of Application 3

Next, example 3 of application of example of implement 3 will be described. In the following description, the data processing device 12 will be referred to as the “server” and the smart glasses 214 will be referred to as the “terminal”.

Conventional work support systems require workers to learn procedures, equipment images, and past accident cases in advance, but they do not acquire work data in real time or make OK/NG decisions for work based on past data. As a result, work efficiency and safety were not sufficiently improved. Furthermore, it was necessary to improve the accuracy of judgment when workers input operation screens and procedures to be performed by voice through smart glasses.

The specific processing by the specific processing unit 290 of the data processing device 12 in example of application 3 is realized by the following means.

In this invention, the server includes means to learn in advance the information required for the work (procedures, equipment images, past accident cases, etc.), means to input the operation screen and the procedures to be performed through the smart glasses by voice when performing the work, and means to judge whether the work is OK or NG and display the answer on the smart glasses, means using artificial intelligence that acquires work data in real time and judges whether the work is OK or NG based on past data and accident cases. This makes it possible to improve work efficiency and safety.

“Information necessary for the work” refers to information such as procedures, equipment images, and past accidents that are necessary for the work to be performed.

A “means of learning in advance” is a means of learning in advance the information needed to perform a task.

“Smart glasses” are eyeglass-shaped devices that can be worn by the operator to display an operating screen and the procedures to be performed.

The “operation screen” is the screen that the operator can see through the smart glasses.

A “procedure to be performed” is a specific procedure to be followed when performing a task.

The “voice input means” is a means for the operator to use his/her voice to input the operation screens and procedures to be performed.

The “means to determine OK/NG” is a means to determine whether the result of the work is appropriate or not.

“Means to obtain work data in real time” means means means to obtain data in real time while work is being performed.

“Historical data” refers to data on work performed in the past.

An “accident case” is a specific example of an accident that has occurred in the past.

“Artificial intelligence means” is a means of using artificial intelligence technology to determine if a task is OK/NG.

The following is an exemplary embodiment of this invention.

First, the server has the means to learn in advance the information necessary for the work (procedures, equipment images, past accidents, etc.). This means is done using artificial intelligence techniques. Specifically, machine learning libraries such as TensorFlow are used to learn past work data and accident cases to model work patterns.

Next, the user wears smart glasses when performing the task. Smart glasses are devices used to display operation screens and procedures to be performed, and have a means of voice input using voice recognition technology. When the user inputs operation instructions by voice, the voice data is sent to the server, which converts it into text data using voice recognition technology.

The server has the means to acquire work data in real time. Specifically, the progress of the work is monitored in real time through cameras and sensors mounted on the smart glasses. This data is transmitted to the server, which has a means of using artificial intelligence to determine if the work is OK or NG based on past data and accident cases; the AI model is built using machine learning libraries such as TensorFlow to determine the suitability of the work based on data acquired in real time.

The decision results are displayed on the smart glasses. This allows users to check the progress of the work in real time and make corrections as necessary. This improves work efficiency and safety.

As a concrete example, consider a case in which a robot is assembling parts in a factory.

In this case, cameras and sensors mounted on the robot acquire work data in real time and input the data to the AI model, which determines whether the work is OK or not based on past data and accident cases, and displays the results on the smart glasses in real time.

Examples of prompt sentences to be input to the generative AI model could include the following

A robot is assembling parts in a factory. Please build an AI system to judge whether the work is OK or NG based on the work data acquired in real time, referring to past data and accident cases.”

The above is an exemplary embodiment of this invention.

The flow of the identification process in example of application 3 is described in FIG. 16.

### Step 1:

The server learns information necessary for the work (procedures, equipment images, past accident cases, etc.) in advance. Specifically, it uses machine learning libraries such as TensorFlow to learn past work data and accident cases to model patterns of work. The input is past work data and accident cases, and the output is the learned AI model.

### Step 2:

The user puts on the smart glasses and begins to work. Smart glasses are devices used to display operation screens and procedures to be performed. The input is the user's voice instructions, and the output is the operation screen and procedures displayed on the smart glasses.

### Step 3:

The user inputs operation instructions by voice. The smart glasses use voice recognition technology to convert the voice into text data, which is then sent to the server. The input is the user's voice instructions and the output is the text data.

### Step 4:

The server acquires work data in real time. The progress of the work is monitored in real time through cameras and sensors mounted on the smart glasses. The input is the real-time data from the cameras and sensors, and the output is the work data sent to the server.

### Step 5:

The server inputs work data acquired in real time to the AI model and judges whether the work is OK or NG. The AI model judges the suitability of the work based on past data and accident cases. The input is work data acquired in real time, and the output is the result of OK/NG judgment of work.

### Step 6:

The server sends the decision results to the smart glasses and displays them to the user.

This allows the user to check the progress of the work in real time and make corrections as necessary. The input is the OK/NG judgment result of the work, and the output is the judgment result displayed on the smart glasses.

These are the specific processing steps for implementing this invention.

In addition, an emotion engine that estimates the user's emotions may be combined. Namely,

The specific processing unit 290 may use the emotion identification model 59 to estimate the user's emotion and perform specific processing using the user's emotion.

### Example of Implement 1.″

One exemplary embodiment of this invention is a system that combines an emotion engine that recognizes the emotions of a worker. In this system, when a worker wears the smart glasses and performs a task, the emotion engine recognizes the emotion from the tone of the worker's voice and facial expression. For example, if the worker feels nervous, the system can adjust work instructions according to the worker's emotions, such as slowing the pace of the work.

### Example of Implement 2.″

The emotion engine can also take actions such as suspending work if the worker's emotions exceed a certain threshold. For example, if the system determines that the worker is overly stressed, it can pause the work and instruct the worker to take a break.

### Example of Implement 3.″

Furthermore, the emotion engine can record changes in the worker's emotions and analyze the data to find areas for improvement in the work. For example, if a worker tends to feel stress during a particular task, the system can suggest improvements, such as revising the procedures for that task.

The following is a description of the process flow for each example of implement.

### Example of Implement 1.″

Step 1: The worker wears the smart glasses.
Step 2: As the work begins, the emotion engine recognizes emotions from the tone of the worker's voice and facial expressions.
Step 3: The emotion engine adjusts the work instructions according to the worker's emotions. For example, if the worker feels nervous, the system adjusts the pace of the work by slowing it down. Example of implement 2.”
Step 1: The worker puts on the smart glasses and starts working.
Step 2: The emotion engine recognizes the worker's emotion and pauses the work if the emotion exceeds a certain threshold.
Step 3: After pausing the work, the system instructs the worker to take a break.

### Example of Implement 3.″

Step 1: The worker puts on the smart glasses and starts working.
Step 2: The emotion engine records changes in the worker's emotions.
Step 3: The system analyzes the recorded emotional data to find areas for improvement in the work. For example, if a worker tends to feel stressed by a particular task, the system will suggest improvements, such as revising the procedures for that task.

### Example 1

The following is an example of exemplary embodiment of implement. In the following description, the data processing device 12 will be referred to as the “server” and the smart glasses 214 will be referred to as the “terminal”.

Conventional work support systems allow workers to learn information such as work procedures, equipment images, and past accident cases in advance, but they could not respond to emotional changes during work. As a result, it was difficult to provide appropriate instructions when workers felt tension or stress, which could reduce work efficiency and safety.

The specific processing by the specific processing unit 290 of the data processing device 12 in Example 1 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK/NG and display the answer on the smart glasses, means to recognize the operator's The system also includes means to recognize the emotion of the worker and adjust work instructions according to that emotion. This makes it possible to respond to changes in the worker's emotions and provide appropriate instructions.

“Information necessary for the work” is a generic term for data and materials necessary to perform the work, such as work procedures, equipment images, and past accident examples.

“Smart glasses” are a type of wearable device with a built-in display, camera, and microphone that is worn by the worker.

The “operation screen” is an interface on the smart glasses' display that contains information such as work procedures and instructions.

The term “voice input means” refers to technology that allows workers to input instructions and information through voice, and generally involves the use of voice recognition technology.

The “means to determine OK/NG” is an algorithm or program that analyzes the worker's voice input and work content and determines whether the results are correct or not.

The “means of recognizing emotions” refers to technology that analyzes a worker's tone of voice and facial expressions to identify emotions such as tension and stress.

A “means of adjusting work instructions” is an algorithm or program for modifying the pace of work or the content of instructions in response to recognized worker emotions.

### Exemplary Embodiment of the Invention

This invention is a system in which workers wear smart glasses and learn information such as work procedures, equipment images, and past accident cases in advance. The worker can check the operation screen through the smart glasses and input instructions by voice.

Combined with an emotion engine, the system also has the ability to recognize the operator's emotions and adjust work instructions.

### Hardware and Software Used

Server: A relational database such as MySQL is used to store information such as work procedures, equipment images, and past accidents.

Terminal (smart glasses): wearable devices such as Google Glass or Microsoft HoloLens.

Speech recognition software: converts speech into text using a given API.

Emotion recognition software: Use Microsoft Azure's Emotion API or a system that combines OpenCV and deep learning models.

Specific System Operation

1. the server stores information such as work procedures, equipment images, and past accident cases in a database. For example, the database will store text data of work procedures and equipment image files.

When the terminal (smart glasses) is worn by the worker, it connects to the server via Wi-Fi and requests necessary information. The server sends work procedures and equipment images to the terminal in response to the request. The terminal displays the received information on its display.

3. the user (worker) checks the information displayed through the smart glasses and inputs voice instructions such as “tell me the next step”. Smart Glass captures the voice using its built-in microphone and converts the voice into text using a predefined API.

4. the server receives the text data of voice instructions sent from the terminal and analyzes it using a script written in Python. For example, it determines if the instruction “Tell me the next step” is correct and generates an OK/NG result.

5. the terminal displays the result of the decision received from the server on its display. For example, it displays a message such as “The following procedure is OK.

6. the emotion engine analyzes the user's tone of voice and facial expressions. It uses the camera and microphone built into the smart glasses to capture the user's facial expressions and tone of voice, and uses Microsoft Azure's Emotion API to recognize emotions.

7. the server adjusts work instructions based on the emotional data received from the emotion engine. For example, if the server recognizes that the user is nervous, it sends additional instructions to the terminal, such as “Proceed slowly.” The terminal displays this instruction on its display.

### Concrete Example

For example, consider a case where a user wears smart glasses to perform an inspection of equipment. The user inputs a voice instruction, “Tell me the next step. The server analyzes this voice instruction and displays the next step on the smart glasses display. At the same time, if the emotion engine senses tension in the user's tone of voice, the server will display additional instructions such as “Please proceed slowly.”

### Example of Prompt Text

Examples of prompt sentences to be input into the generative AI model could include the following:

A worker is wearing smart glasses and inspecting equipment. The worker enters voice instructions for the next step. The server analyzes this voice instruction and displays the next step on the Smart Glasses display. At the same time, if the emotion engine detects tension in the worker's tone of voice, the server displays additional instructions to slow down the pace of the work.”

By inputting this prompt statement into a generative AI model, the system's behavior can be simulated.

The flow of the identification process in Example 1 is described in FIG. 17.

### Step 1:

The server stores the information in a database.

Input: information on work procedures, equipment images, past accidents, etc.

Processing: The server stores this information in a relational database such as MySQL.

Specifically, the database stores text data of work procedures and image files of equipment.

Output: Information stored in the database.

### Step 2:

The terminal retrieves information from the server and displays it on the display.

Input: Information such as work procedures and equipment images stored on the server.

Processing: When the terminal (smart glasses) is worn by the user, it connects to the server via Wi-Fi and requests necessary information. The server sends work procedures and equipment images to the terminal in response to the request.

Output: Work procedures and equipment images displayed on the terminal's display.

### Step 3:

The user enters voice instructions.

Input: User voice instructions (e.g., “Tell me the next step”).

Processing: Smart Glasses captures voice using the built-in microphone and converts voice to text using a predefined API.

Output: Voice instructions converted to text.

### Step 4:

The server analyzes the voice instructions and determines whether the work is OK or NG.

Input: Voice instructions converted to text.

Processing: The server receives text data of voice instructions sent from the terminal and analyzes it using a script written in Python. For example, it determines if the instruction “Tell me the next step” is correct and generates an OK/NG result.

Output: OK/NG decision result.

### Step 5:

The terminal displays the results of the decision on its display.

Input: OK/NG judgment results received from the server.

Processing: The terminal displays the result of the decision received from the server on its display. For example, the terminal displays a message such as “The next step is OK.

Output: The result of the decision shown on the terminal's display.

### Step 6:

The emotion engine recognizes the user's emotions.

Input: Tone of voice and facial expression of the user.

Processing: Capture the user's facial expressions and tone of voice using the smart glasses' built-in camera and microphone, and recognize emotions using Microsoft Azure's Emotion API.

Output: Recognized emotion data.

### Step 7:

The server adjusts work orders according to emotion.

Input: Emotion data received from the emotion engine.

Processing: The server adjusts work instructions based on the emotional data received from the emotion engine. For example, if a user is perceived as nervous, the server will send additional instructions to the terminal, such as “proceed slowly.”

Output: Adjusted work instructions shown on the terminal display.

### Example of Application 1

Next, example of application 1 of example of implement 1 will be described. In the following description, the data processing device 12 will be referred to as the “server” and the smart glasses 214 will be referred to as the “terminal.”

Conventional work support systems allow workers to learn information such as work procedures, equipment images, and past accident cases in advance, but lack support that takes into account their emotional state during work. As a result, the system may not be able to respond appropriately when the worker feels tension or stress, which may reduce work efficiency and safety. In addition, OK/NG judgment of operations by voice input also does not take emotional states into account, which may increase the psychological burden on the worker.

The specific processing by the specific processing unit 290 of the data processing device 12 in example of application 1 is realized by the following means. In this invention, the server includes means for learning information necessary for the work (procedures, equipment images, past accident cases, etc.) in advance, means for inputting the operation screen and procedures to be performed by voice through the smart glasses when performing the work, means for judging whether the work is OK or NG and displaying the answer on the smart glasses, means for recognizing the emotion of the worker, means for adjusting the pace and instructions according to the emotion of the worker The system also includes means to recognize the emotions of the worker, and means to adjust the pace of the work and instructions according to the worker's emotions. This enables appropriate support that takes into account the emotional state of the worker, and is expected to improve work efficiency and safety.

“Information necessary for work” refers to information necessary for smooth and safe operations, such as work procedures, equipment images, and past accidents.

The “means to learn in advance” is a means for workers to learn in advance the information necessary for their work, and this includes learning systems using artificial intelligence.

“Smart glasses” are wearable devices worn by the operator that provide a visual display of the operating screen and procedures to be performed.

The “means for voice input of operation screens and procedures to be performed” is a means for operators to input operation screens and procedures to be performed using voice, and voice recognition technology can be used.

The “means for judging OK/NG and displaying the answer on the smart glasses” is a means for judging whether the work is OK or NG based on the worker's voice input and displaying the result on the smart glasses' display.

The “emotion recognition means” is a means to recognize emotions from the tone of voice and facial expressions of the worker, and an emotion recognition engine can be used.

The “means for adjusting the pace of work and instructions” is a means for adjusting the pace of work and instructions according to the emotions of the worker.

An exemplary embodiment of this invention is an application that is installed on a factory robot. The following is an exemplary embodiment of this application.

### Hardware and Software Used

Hardware: smart glasses (e.g., wearable devices), factory robots (e.g., robot arms)

Software: Emotion recognition engine (e.g., emotion recognition software), speech recognition engine (e.g., speech recognition software), display software (e.g., display software)

### Data Processing and Data Arithmetic

### Voice Input Processing: 1.

The user inputs voice instructions into the smart glasses.

Convert speech into text using a speech recognition engine.

Analyze the converted text and determine if the operation is OK/NG.

### 2. Emotion Recognition Processing

Capture the user's facial expressions and tone of voice using the smart glasses' camera and microphone.

Use an emotion recognition engine to recognize the user's emotions.

Adjust the pace of work and instructions based on perceived emotions.

### 3. Processing of the Display:

The OK/NG results of the operation and the adjusted instructions are displayed on the smart glasses display.

Use display software to present the information in a visually pleasing manner.

### Concrete Example

For example, when a user performs maintenance on a robot arm, the user wears the smart glasses and performs the following operations:

1. the user voice inputs “tell me the next step”.

2. speech recognition engine converts speech into text and displays next steps

3. if the user is nervous, the emotion recognition engine detects this and adjusts the instructions to slow down the pace of the work.

4. the Smart Glass display will show “Please proceed slowly to the next step.

### Example of Prompt Text

Examples of prompt sentences to be entered into the generative AI model are as follows:

Design a smart glasses application to learn maintenance procedures for a “factory robot. Include the ability for the user to enter spoken instructions and use an emotion recognition engine to recognize the user's emotions and adjust the pace of work and instructions. Hardware to be used is a wearable device and robot arm; software is voice recognition software, emotion recognition software, and display software.”

In this way, smart glass applications can be implemented for efficient and safe operation and maintenance of factory robots.

The flow of the identification process in Example of Application 1 is described in FIG. 18.

### Step 1:

The user inputs voice instructions into the smart glasses. The voice input is captured through the Smart Glasses' microphone.

### Step 2:

The server uses a speech recognition engine to convert the captured speech into text.

The input is the speech data and the output is the text data.

### Step 3:

The server analyzes the converted text and judges whether the operation is OK or NG. The input is the text data and the output is the OK/NG judgment result.

### Step 4:

The server uses the camera and microphone on the smart glasses to capture the user's facial expressions and tone of voice. Input is camera video and voice data.

### Step 5:

The server uses an emotion recognition engine to recognize the user's emotions from captured facial expressions and tone of voice. The input is the camera video and voice data, and the output is the emotion data.

### Step 6:

The server adjusts the pace of work and instructions based on the recognized emotions. The input is the emotion data and the output is the adjusted instructions.

### Step 7:

The server displays the OK/NG results of the operation and the adjusted instructions on the smart glasses display. The input is the OK/NG results and adjusted instructions, and the output is the display.

### Step 8:

The user reviews the information displayed on the smart glasses display and proceeds to the next step. The input is the display indication and the output is the user's next action.

### Example 2

Next, example 2 of exemplary embodiment of implement will be described. In the following description, data processing device 12 will be referred to as the “server” and smart glasses 214 will be referred to as the “terminal.”

In conventional maintenance work, workers are required to accurately understand and properly execute procedures, but errors in procedures and worker stress sometimes resulted in reduced work efficiency. In addition, worker health and safety were not adequately ensured because there was no system that monitored workers' emotional states in real time and instructed them to take a break at the appropriate time.

The specific processing unit 290 of the data processing device 12 in Example 2 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK or not and display the answer on the smart glasses, and means to monitor the user The system also includes means for monitoring the emotional state of the user and, if the emotional state exceeds a certain threshold, suspending the work and instructing the user to take a break. This allows the worker to proceed with the work while checking the accuracy of the procedure, and also allows the user to take an appropriate break if he/she feels excessively stressed.

Information necessary for the work” refers to the data and knowledge required to perform maintenance work accurately and efficiently, including procedures, equipment images, and past accident examples.

Smart glasses” refers to wearable devices with displays and voice input capabilities that allow workers to view and input information hands-free.

The term “voice input means” refers to techniques and devices that allow operators to use their voice to input information on operating screens and procedures to be performed, and includes voice recognition technology.

The term “means to determine OK/NG” refers to a technique or device that evaluates whether an input procedure or operation is correct and outputs the results.

The term “means of monitoring emotional states” refers to techniques and devices used to measure and evaluate workers' stress levels and fatigue in real time.

Means for suspending work and instructing workers to take a break when a certain threshold is exceeded” refers to techniques or devices for suspending work and instructing workers to take a break when the evaluation results of the emotional state exceed a set criterion.

The term “artificial intelligence” refers to technologies and systems that use machine learning and data analysis to automatically learn the information needed to perform a task and make decisions.

The term “speech recognition technology” refers to technologies and systems for converting speech into text data, enabling voice input.

This invention is a system that uses smart glasses to allow workers to voice input procedures when performing maintenance tasks, determine the accuracy of those procedures, and also monitor the emotional state of the worker. The system is implemented using the following hardware and software:

### Hardware and Software Used

### Hardware: Smart Glasses

Software: Speech recognition system, emotion engine, generative AI model

Specific System Operation

1. the user puts on the smart glasses. The smart glasses are activated and connected to the system.

2. the user inputs the maintenance procedure by voice. For example, the user speaks “change engine oil”.

The terminal (smart glasses) activates the speech recognition system and converts the input speech into text data. Specifically, speech recognition software (e.g., a given API) is used.

4. the server receives the text data and determines if the input procedure is correct using the generated AI model. For example, a generative AI model (e.g., GPT-4) evaluates whether the procedure “change engine oil” is correct.

The server sends the judgment result to the smart glasses display. The terminal (smart glasses) displays the judgment result on its display. For example, the result “correct” is displayed.

6. the terminal (smart glasses) monitors the user's emotional state using built-in sensors. The emotional engine evaluates the user's stress level and fatigue.

7. the server receives the evaluation results of the emotion engine and pauses the work if the user's emotion exceeds a certain threshold. The terminal (smart glasses) shows the message “Please take a break” on the display. For example, if the system determines that the user is excessively stressed, the system displays “Please take a break.”

### Concrete Example

### Example 1: Entering Maintenance Work Procedures

The user voice inputs “change engine oil”.

The voice recognition system in the smart glasses converts the text data into “change engine oil.”

The server determines if this procedure is “correct” using a generative AI model.

The server displays the “correct” result on the smart glasses display.

The user checks the display and continues working.

### Example 2: Work Stoppage by the Emotion Engine

The emotional engine determines that the user is overly stressed while working.

The emotional engine pauses the work and displays the message “Please take a break” on the smart glasses' display.

The user follows the instructions and takes a break.

### Example of Prompt Text

Enter the procedure for changing the engine oil audibly. The system determines the accuracy of the procedure and shows the result on the display. Also, if you experience undue stress during the procedure, the system will pause the operation and ask you to take a break.”

In this way, users can proceed with their work with peace of mind, checking to see if their own work is correct. In addition, if the user feels excessive stress, the system will prompt him or her to take an appropriate break, thereby improving the safety and efficiency of the work.

The flow of the identification process in Example 2 is described in FIG. 19.

### Step 1:

The user puts on the smart glasses. The smart glasses are activated and connected to the system.

Input: Wearing Smart Glasses

Output: System connection completion message

Specific operation: Smart Glasses is activated and connected to the server via Wi-Fi or Bluetooth. The message “System connection complete” appears on the display.

### Step 2:

The user voice inputs the procedure for a maintenance task. For example, he/she speaks, “Change the engine oil.”

Input: Voice input (e.g., “change engine oil”)

Output: Audio data

Specific operation: The smart glasses' microphone captures voice and stores it as voice data.

### Step 3:

The terminal (smart glasses) activates the voice recognition system and converts the input voice into text data.

Input: Audio data

Output: Text data (e.g., “change engine oil”)

Specific behavior: Speech recognition software (e.g., a given API) analyzes speech data and generates corresponding text data.

### Step 4:

The server receives the text data and determines if the input procedure is correct using the data generation model.

Input: Text data (e.g., “change engine oil”)

Output: Judgment result (e.g., “correct”)

Specific behavior: The server uses a data generation model (e.g., GPT-4) to analyze the contents of the text data and evaluate the accuracy of the procedure.

### Step 5:

The server sends the judgment result to the smart glasses display. The terminal (smart glasses) displays the judgment result on its display.

Input: Judgment result (e.g., “correct”)

Output: Displayed (e.g., “correct”)

Specific operation: The server sends the judgment results to the smart glasses, and the smart glasses display the results on the display.

### Step 6:

The terminal (smart glasses) monitors the user's emotional state using built-in sensors.

Input: Biological data (e.g., heart rate, skin electrical response)

Output: Results of emotional state assessment (e.g., stress level)

Specific operation: Sensors in the smart glasses collect the user's biometric data, and the emotion engine analyzes the data to evaluate the emotional state.

### Step 7:

The server receives the evaluation results of the emotion engine and pauses the work if the user's emotion exceeds a certain threshold. The terminal (smart glasses) displays the message “Please take a break” on the display.

Input: Result of emotional state assessment (e.g., high stress)

Output: Break instruction message (e.g., “Please take a break”)

Specific operation: When the server receives the evaluation results from the emotion engine and determines that the stress level is high, it sends a break instruction message to the smart glasses and displays it on the display.

### Example of Application 2

Next, example of application 2 of example of implement 2 will be described. In the following description, data processing device 12 will be referred to as the “server” and smart glasses 214 will be referred to as the “terminal.”

In conventional maintenance work, workers are required to accurately understand and properly execute procedures, but accidents and mistakes can occur due to errors in procedures and worker stress. In addition, there is a lack of a system that monitors the emotional state of workers in real time and prompts them to take a break at the appropriate time, which is a problem that reduces work efficiency and safety. To solve these problems, a system is needed to check the accuracy of work procedures and monitor the emotional state of workers

The specific processing by the specific processing unit 290 of the data processing device 12 in example of application 2 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK or not and display the answer on the smart glasses, means to monitor the worker's The system also includes means to monitor the emotional state of the worker and pause the work if the worker feels excessive stress, and means to instruct the worker to take a break. This makes it possible to proceed with the work while checking the accuracy of the work procedures, and to monitor the emotional state of the worker in real time and prompt the worker to take a break at the appropriate time.

“Information necessary for the work” refers to information such as procedures, equipment images, and past accidents that are required to perform maintenance work.

The “means of learning” is a means of learning in advance the information necessary for a task, which is done using artificial intelligence.

The “voice input means” is a means for the operator to voice input the operation screen and procedures to be performed through the smart glasses.

The “means for judging OK/NG” is a means for judging whether the entered work procedure is correct and displaying the result on the smart glasses.

The “means to monitor the emotional state” is a means to monitor the worker's emotional state in real time and pause the work if he/she feels excessively stressed.

A “means of instructing a worker to take a break” is a means of instructing a worker to pause work and take a break when he/she feels undue stress.

The system for implementing this invention consists of the following components.

First, the worker wears smart glasses to perform maintenance work. The smart glasses are equipped with a microphone and a camera, which can provide audio and video input.

### Hardware and Software Used

Hardware: smart glasses (e.g., Google Glass), microphone, camera

### Software: Prescribed API, Microsoft Azure Emotion API

### Data Processing and Data Arithmetic

### Voice Input and Recognition

1. voice input: the operator inputs the maintenance procedure by voice through the microphone of the smart glasses.

Speech Recognition: The server converts speech into text using a predefined API. This text is used to verify the accuracy of the work procedure.

### Procedure Evaluation

Procedure determination: The server determines if the converted text is a correct procedure. This determination is made by checking against a pre-trained database of work procedures.

### Emotional State Monitoring

4. emotion analysis: Acquire facial images of the worker through the Smart Glasses camera and analyze the emotional state using the Microsoft Azure Emotion API. Particular attention will be paid to stress levels that exceed a certain threshold.

### Result Display and Break Instructions

5. result display: The result of the decision and the emotional state are displayed on the smart glasses display. If the work procedure is correct, “Correct procedure” is displayed; if there is an error, “Incorrect procedure” is displayed.

6. break instruction: If the worker feels undue stress, the system pauses the work and instructs the worker to take a break.

### Concrete Example

Voice input: “Next, remove the screws.”

Procedure result: “Correct procedure.”

Emotional analysis result: “The worker is under undue stress. Tell them to pause work and take a break.”

### Example of Prompt Text

Voice input: “Next, remove the screws.”

Procedure result: “Correct procedure.”

Emotional analysis result: “The worker is under undue stress. Tell them to pause work and take a break.”

In this way, work can proceed while confirming the accuracy of work procedures, and the emotional state of the worker can be monitored in real time to prompt a break at the appropriate time. This improves work efficiency and safety.

The flow of the identification process in example of application 2 is described in FIG. 20.

### Step 1:

The user puts on the smart glasses and begins a maintenance task. The user voice inputs the work procedure through the microphone of the smart glasses. The input voice data is captured by the microphone of the Smart Glasses.

### Step 2:

The server receives the voice data sent from the smart glasses. The received voice data is sent to prescribed API to convert voice to text data. The input is the voice data and the output is the text data.

### Step 3:

The server matches the converted text data against a pre-trained database of work procedures. As a result of the cross-checking, the server determines whether the input procedure is correct or not. The input is the text data and the output is the judgment result regarding the correctness of the procedure.

### Step 4:

The server receives the user's facial image acquired through the smart glasses camera. The received face image is sent to the Microsoft Azure Emotion API to analyze the user's emotional state. The input is the face image data and the output is the result of the emotional state analysis.

### Step 5:

The server integrates the results of the determination of the procedure and the analysis of the emotional state and displays them on the smart glasses' display. If the procedure is correct, it displays “The procedure is correct,” and if there is an error, it displays “There is an error in the procedure. If the user is under undue stress, the display will indicate “Please ask the user to pause the work and take a break. The input is the judgment and analysis results, and the output is the message shown on the display.

### Step 6:

The user chooses whether to continue working or take a break according to the message displayed on the smart glasses display. If the user takes a break, the system pauses the work and prompts the user to take a break. The input is the message displayed on the display and the output is the user's action.

### Example 3

Next, example 3 of exemplary embodiment of implement will be described. In the following description, the data processing device 12 will be referred to as the “server” and the smart glasses 214 will be referred to as the “terminal”.

Conventional work support systems have the ability to determine the accuracy of a worker's movements and procedures, but could not provide feedback that took into account the worker's emotions and stress level. As a result, the worker's emotional burden increased, which could reduce work efficiency and safety. In addition, it was difficult to quickly find areas for improvement in work because the system did not sufficiently collect and analyze the real-time OK/NG judgment of work and emotional data.

The specific processing unit 290 of the data processing device 12 in Example 3 is realized by the following means.

In this invention, the server includes means for learning in advance the information required for the work (procedures, equipment images, past accident cases, etc.), means for inputting the operation screen and the procedures to be performed by voice through a visual device when performing the work, means for judging whether the work is OK/NG and displaying the answer on the visual device, means for The system includes means for collecting and analyzing emotional data, and means for suggesting improvements to the work based on the collected emotional data. This makes it possible to improve work efficiency and safety by providing feedback that takes into account the worker's emotions and stress level.

“Information necessary for the work” refers to data necessary to perform the work accurately and safely, such as procedures, equipment images, and past accidents.

A “visual device” is a device that a worker wears to visually confirm the operation screen and procedures to be performed, and includes smart glasses.

The term “voice input means” refers to technology that allows operators to use their voice to input information about operation screens and procedures to be performed, including voice recognition technology.

The “OK/NG judgment method” is a technique for evaluating the accuracy and appropriateness of work and feeding the results back to the operator.

Emotional data collection means technology for detecting and collecting data on workers' emotions and stress levels.

The “emotional data analysis means” is technology for analyzing collected emotional data and evaluating changes in workers' emotions and stress levels.

The “means of suggesting improvements in work” is a technique for suggesting measures to improve work procedures and the environment based on the results of emotional data analysis.

This invention is a system to improve the efficiency and safety of workers, and is implemented by clarifying the roles of the server, terminal, and user.

### Server Role

The server provides a means to learn in advance the information required for the work (procedures, equipment images, past accident cases, etc.). Specifically, the server uses a database management system such as MySQL to collect and store past work data and accident cases. Next, AI models are trained based on the collected data; machine learning frameworks such as TensorFlow are used for the AI models.

The server will perform the following processes:

1. retrieve historical work data and accident cases from the database

2. preprocess the acquired data and convert it into a format suitable for AI models.

3. train AI models using preprocessed data.

4. save the trained AI model and use it for OK/NG decision of the work.

### Role of the Terminal

The terminal collects data on the work performed by the worker in real time and transmits it to the server. The terminal is equipped with hardware such as cameras and sensors, which are used to collect work data. The collected data is temporarily stored in the terminal and periodically uploaded to the server.

The terminal performs the following processes:

1. collect work data using cameras and sensors.

2. temporarily store the collected data.

3. periodically transmit the stored data to the server.

### Role of the User

Users receive feedback provided by the system to help them improve their work. For example, if the system gives a NG decision for a particular task, the user can check the reason and review the work procedure. Also, if the affective engine detects stress in a worker, the user can use that information to improve the work environment.

The user shall do the following:

1. review feedback from the system.

2. review work procedures and environment based on feedback.

3. implement the improvements and again receive feedback on the system.

### Concrete Example

For example, suppose a factory worker is assembling parts. The server trains an AI model based on past assembly operation data and accident cases, and the terminal collects data by capturing the worker's movements with a camera; the AI model judges whether the operation is OK or NG in real time, and notifies the user of the reason if it is NG. The emotion engine analyzes the worker's facial expression and provides information to the user if the worker is feeling stress.

### Example of Prompt Text

Please design a system that trains AI models based on past work data and accident cases, and determines whether work is OK or NG in real time. Also add a function to analyze the worker's emotions and provide information if they are feeling stressed.”

In this way, the roles of the server, terminal, and user are clarified, and the flow of data processing using specific hardware and software is explained to facilitate understanding of the overall system. The flow of specific processing in Example 3 is explained using FIG. 21.

### Step 1:

### Data Collection

The server collects historical work data and accident cases. Input includes data from each work station in the plant. This includes worker movement logs, sensor data from the work environment, and past accident reports. The server stores these data in a database such as MySQL. As a specific action, the server connects to the database and stores the collected data.

### Step 2:

### Data Preprocessing

The server preprocesses the collected data. As input, there is the raw data collected in step 1. Specific data processing includes completion of missing values, removal of anomalous values, and normalization of data. As output, a dataset in a format suitable for AI models is obtained. As a specific action, the server uses a Python library to clean the data and store the preprocessed data in a new table.

### Step 3:

### AI Model Training

The server trains the AI model using the preprocessed data. As input, there is the preprocessed data set from step 2. As specific data operations, a machine learning framework such as TensorFlow is used to build and train the model. As output, a trained AI model is obtained. As a specific operation, the server inputs training data to TensorFlow, trains the model, and saves the model when training is complete.

### Step 4:

### Real-Time Data Collection and Transmission

The terminal collects data on the work performed by the worker in real time and transmits it to the server. Inputs include data on the worker's movements and the work environment. As specific data collection, data is collected using cameras and sensors and stored temporarily. As output, the collected data is transmitted to the server. As specific operations, the terminal takes pictures of the worker's movements with a camera, collects data on the work environment with a sensor, and periodically transmits the data to the server.

### Step 5:

### OK/NG Judgment of Work

The server inputs the real-time data received into the AI model to determine if the work is OK/NG. As input, there is the real-time data collected in step 4. As specific data operation, data is input to the AI model to obtain the judgment result. As output, OK/NG judgment results are obtained. As specific operations, the server inputs the received data into the AI model, analyzes the output results of the model, judges OK/NG, and sends the judgment results to the terminal.

### Step 6:

### Emotional Data Collection and Analysis

The terminal collects the worker's emotional data and sends it to the server. Inputs include the worker's facial expressions and voice data. As specific data collection, data is collected using cameras and microphones and analyzed by the emotion engine. As output, the analyzed emotion data is sent to the server. Specifically, the terminal uses a camera to capture the worker's facial expressions, a microphone to record the worker's voice, and an emotion engine to analyze the data, detect changes in emotion, and send the data to the server.

### Step 7:

### Providing Feedback

Users receive feedback provided by the system to help them improve their work. Input includes the results of the OK/NG decision in Step 5 and the emotional data in Step 6. As specific feedback, the user is provided with suggestions for revising work procedures and improving the environment. As output, the improvement measures are implemented and the system again receives feedback. As a specific action, the user checks the feedback on the terminal screen, reviews the work procedures and environment based on the feedback, executes the improvement measures, and receives the system feedback again.

### Example of Application 3

Next, example 3 of application of example of implement 3 will be described. In the following description, the data processing device 12 will be referred to as the “server” and the smart glasses 214 will be referred to as the “terminal”.

Conventional work support systems did not provide sufficiently accurate judgments to improve work efficiency and safety, and did not take into account workers' emotions and stress in proposing improvements. This caused a problem of accumulated stress for workers, resulting in a decrease in work efficiency.

The specific processing by the specific processing unit 290 of the data processing device 12 in example of application 3 is realized by the following means. In this invention, the server has the means to learn in advance the information necessary for the work (procedures, equipment images, past accident cases, etc.), the means to input the operation screen and the procedures to be performed by voice through the smart glasses when performing the work, the means to judge whether the work is OK or NG and display the answer on the smart glasses, the means to collect the emotion data of the worker and to record and analyze the changes in the emotion, the means to propose the improvement of the work procedures based on the emotion data and the work data, and the means to improve the work procedures based on the emotion data. The system includes means to collect emotional data of the worker, record and analyze changes in emotions, and suggest improvements to the work procedure based on the emotional and work data. This enables not only to improve the efficiency and safety of the work, but also to reduce the stress of the workers and to improve the work procedures.

“Information necessary for the work” refers to the data and knowledge required to perform the work, such as work procedures, equipment images, and past accident examples.

The term “means of learning” refers to methods and devices that use artificial intelligence to learn in advance the information necessary for a task.

“Smart glasses” refers to a glasses-type device worn by the worker that provides a visual display of the operating screen and procedures to be performed.

The term “voice input means” refers to methods and devices that allow operators to use their voice to input information on operating screens and procedures to be performed.

The term “means for determining OK/NG” refers to methods and devices for determining the appropriateness of work and displaying the results on smart glasses.

“Emotional data” refers to data indicating the emotional state of the worker, such as the worker's heart rate and skin electrical response.

The term “means of recording and analyzing changes in emotions” refers to methods and devices for collecting workers' emotional data and recording and analyzing those changes.

The term “means for suggesting improvements in work procedures” refers to methods and devices for finding and suggesting improvements in work procedures based on emotional and operational data.

The system for implementing this invention consists of the following components. First, the server uses artificial intelligence (AI) to learn in advance the information necessary for the work (procedures, equipment images, past accident cases, etc.). Specifically, it learns patterns based on past work data and accident cases, and builds a model to determine whether work is OK or NG.

Next, smart glasses are used as the terminal. The smart glasses are worn by the worker and provide a visual display of the operation screen and procedures to be performed. The worker can use voice recognition technology to input the operation screen and procedures to be performed by voice. This allows the operator to perform operations without using his or her hands, thereby improving work efficiency.

In addition, the server collects emotional data from the worker, recording and analyzing changes in emotions. Emotional data includes heart rate and skin electrical response. These data are collected in real time using an emotion engine. The emotion engine analyzes the worker's emotional state and alerts the worker if stress is elevated.

Finally, the server suggests improvements in work procedures based on the emotional and work data. This will reduce the stress of workers and improve the efficiency of work procedures.

As a concrete example, consider the case of assembling parts in a factory. The server learns from past assembly operation data and accident cases, and builds a model to judge whether the operation is OK or NG. The worker wears smart glasses and inputs operation procedures by voice. The smart glasses visually display the operation screen and procedures so that the worker can perform the operation without using his/her hands. The emotion engine collects the worker's heart rate and skin electrical response in real time and alerts the worker when stress is elevated. The server suggests improvements to work procedures based on the emotional and operational data.

Examples of prompt statements may include the following:

Please create a program that uses current work data and emotion data as inputs to determine if a task is OK/NG and alerts the user if necessary. The work data will include position and speed data, and the emotion data will include heart rate and skin electrical response; the AI model will use a Random Forest classifier, and the emotion engine will use the EmotionEngine class.”

In this way, the exemplary embodiment of the invention can be shown in detail.

The flow of the identification process in example of application 3 is described in FIG. 22.

### Step 1:

The server collects information necessary for the work (procedures, equipment images, past accident cases, etc.) and learns using artificial intelligence (AI). Specifically, using past work data and accident cases as input, the system learns patterns and builds a model to determine whether work is OK or NG. As output, a learned AI model is obtained.

### Step 2:

The user puts on the smart glasses and begins to work. The smart glasses visually display the operation screen and the procedure to be performed. As input, it receives the work procedure data provided by the server, and as output, it provides visual instructions to the user.

### Step 3:

The user uses voice recognition technology to input the operating procedures by voice. Smart Glass converts the voice input into text data and sends it to the server. Receive the user's voice data as input and generate text data as output.

### Step 4:

The server receives text data sent from the smart glasses and judges whether the work is OK or NG using a learned AI model. It uses the text data and the trained AI model as input and data generation model as output to determine if the task is OK or NG.

### Step 5:

The server sends the OK/NG decision results of the work to the smart glasses and displays them visually to the user. Receive the OK/NG decision results as input and provide visual feedback to the user as output.

### Step 6:

The server uses an emotion engine to collect real-time emotional data (e.g., heart rate, skin electrical response, etc.) from the worker. It receives data from emotion sensors as input and generates emotion data as output.

### Step 7:

The server analyzes the collected emotional data and evaluates the stress level of the worker. It uses the emotional data as input and generates the results of the stress level assessment as output.

### Step 8:

The server issues an alert and notifies the smart glasses if the stress level is high. It receives the results of the stress level assessment as input and generates an alert notification as output.

### Step 9:

The server proposes improvements to work procedures based on emotion and work data. It uses emotion and work data as input and generates improvement suggestions as output.

### Step 10:

The server sends suggestions for improving work procedures to the smart glasses and provides a visual display to the user. Receive suggestions for improvement as input and provide visual feedback to the user as output.

The specific processing unit 290 sends the results of the specific processing to the smart glasses 214. In smart glasses 214, control unit 46A causes speaker 240 to output the results of the specific processing. Microphone 238 acquires audio indicating user input to the results of the specific processing. The control unit 46A transmits the voice data indicating the user input acquired by the microphone 238 to the data processing device 12. In the data processing device 12, the specific processing unit 290 acquires the voice data.

The data generation model 58 is the so-called Generative AI (Artificial Intelligence). De

An example of a data generation model 58 is a generated AI such as ChatGPT (Internet search <URL: https://openai.com/blog/chatgpt>). The data generation model 58 is

and is obtained by having a neural network perform deep learning on a neural network.

### Data Raw

The data generation model 58 receives prompts containing instructions and inference data such as voice data indicating speech, text data indicating text, and image data indicating images. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the smart glasses 214.

### Third Exemplary Embodiment

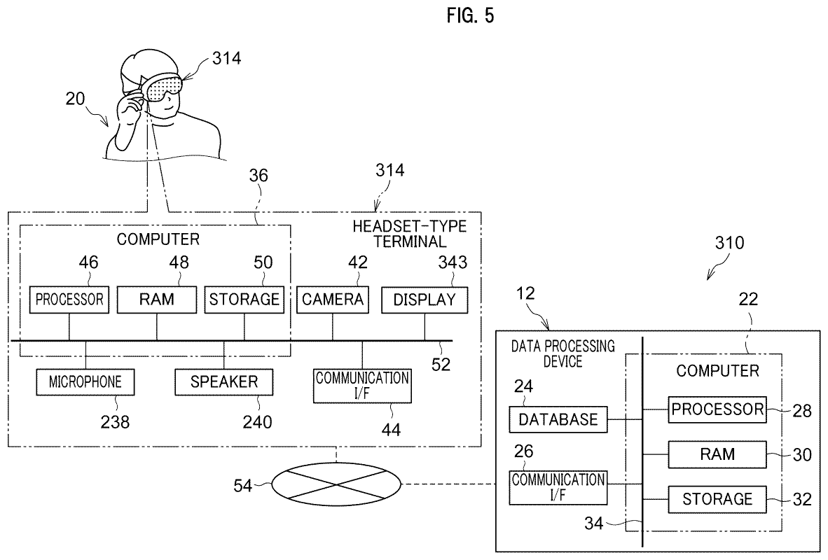

FIG. 5 shows an example of implement of a data processing system 310 for the third exemplary embodiment.

As shown in FIG. 5, data processing system 310 has data processing device 12 and headset-type terminal 314. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

The headset-type terminal 314 has a computer 36, microphone 238, speaker 240, camera 42, communication I/F 44, and display 343. The computer 36 has a processor 46, RAM 48, and storage 50. Processor 46, RAM 48, and storage 50 are connected to bus 52. The microphone phone 238, speaker 240, camera 42, and display 343 are also connected to bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 outputs audio in accordance with instructions from processor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and images the surroundings of the user 20 (for example, the imaging range defined by an angle of view equivalent to the field of view of an average healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner.

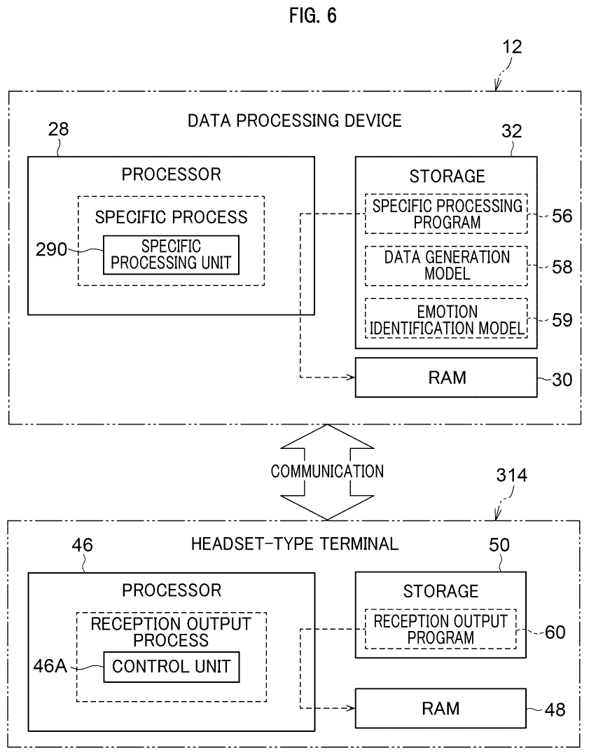

FIG. 6 shows an example of the key functions of data processing device 12 and headset-type terminal 314. As shown in FIG. 6, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

At the headset-type terminal 314, the reception output process is performed by processor 46. The reception output program 60 is stored in the storage 50. Processor 46 reads reception output program 60 from storage 50 and executes the read reception output program 60 on RAM 48. The reception output process is realized by the processor 46 operating as the control unit 46A according to the reception output program 60 executed by the processor 46 on RAM 48.

Next, the specific processing by the specific processing unit 290 of the data processing device 12 is described.

### Example of Implement 1.″

One exemplary embodiment of this invention is a system in which workers wear smart glasses and learn in advance information such as work procedures, equipment images, and past accidents. The worker can view the operation screen through the smart glasses and can input voice instructions. The system determines whether work is OK or NG based on the worker's voice input and displays the results on the smart glasses' display.

### Example of Implement 2.″

As a concrete example, consider the case where a worker performs maintenance work on equipment. The worker wears the smart glasses and inputs the maintenance work procedure by voice. The system determines whether the input procedure is correct and displays the result on the Smart Glasses' display. In this way, the worker can proceed with the work while checking whether his/her work is correct or not.

### Example of Implement 3.″

The system can also use artificial intelligence to learn work information. The artificial intelligence learns patterns from past work data and accident cases, and judges whether work is OK/NG based on these patterns. This allows the system's judgment accuracy to improve over time, further enhancing worker work efficiency and safety.

The following is a description of the process flow for each example of implement.

### Example of Implement 1.″

Step 1: The worker wears the smart glasses.
Step 2: Smart glasses learn the information necessary for the work (procedures, equipment images, past accidents, etc.) in advance.
Step 3: The operator can view the operation screen through smart glasses and input instructions by voice.
Step 4: The system determines if the work is OK/NG based on the worker's voice input and

The results are displayed on the smart glasses display.

### Example of Implement 2.″

Step 1: When a worker performs maintenance work on equipment, he or she first puts on the smart glasses.
Step 2: The operator voice-enters the maintenance procedure.
Step 3: The system determines if the entered procedure is correct and displays the result on the smart glasses display.
Step 4: Workers proceed based on system feedback.

### Example of Implement 3.″

Step 1: The system learns work information using artificial intelligence.
Step 2: Artificial intelligence learns patterns from past work data and accident cases.
Step 3: Based on the learned patterns, the system determines if the work is OK/NG.
Step 4: The results of the decision are displayed on the smart glasses display, and the worker proceeds based on the feedback.

### Example 1

Next, example 1 of exemplary embodiment of implement will be described. In the following description, data processing device 12 is referred to as the “server” and headset-type terminal 314 is referred to as the “terminal.”

In conventional work support systems, it was difficult for workers to efficiently learn information such as procedures, equipment images, and past accident cases, and to receive appropriate instructions during work. There were also issues with the accuracy of voice input instructions and the speed of OK/NG decisions for work. This could reduce work efficiency and safety.

The specific processing by the specific processing unit 290 of the data processing device 12 in Example 1 is realized by the following means. In this invention, the server has the following means: a means to learn information necessary for the work (procedures, equipment images, past accident cases, etc.) in advance; a means to input the operation screen and procedures to be performed by voice through the smart glasses when performing the work; a means to judge whether the work is OK or NG and display the answer on the smart glasses; a means to analyze voice data is analyzed and converted into text, and a prompt sentence is generated using a generation AI model to determine the OK/NG of the task. This enables the operator to efficiently learn information, improve the accuracy of voice input instructions, and quickly determine the OK/NG of the work.

“Information necessary for the work” refers to knowledge and data necessary to perform the work, such as procedures, equipment images, and past accident examples.

A “means of learning” is a method or device by which a worker learns in advance the information necessary to perform a task.

“Smart glasses” are wearable devices that are worn by workers to display operational screens and information.

The “operation screen” is a screen displayed on the smart glasses that shows information such as work procedures and instructions.

A “means of voice input” is a method or device that allows a worker to input instructions or information using voice.

“Means to determine OK/NG” is a method or device used to evaluate the progress or results of work and determine if it is appropriate or not.

“Means for analyzing speech data and converting it to text” refers to methods and devices for converting speech data to text using speech recognition technology.

The “Generative AI Model” is a model that uses artificial intelligence to generate prompt sentences and determine if the work is OK/NG.

A “prompt sentence” is an instruction sentence to be input into the generated AI model, and is used as the basis for the OK/NG judgment of the work.

### Exemplary Embodiment of the Invention

This invention is a system in which workers wear smart glasses and learn information such as work procedures, equipment images, and past accident cases in advance. The worker can view the operation screen through the smart glasses and can input voice instructions. The system determines whether work is OK or NG based on the worker's voice input and displays the results on the smart glasses' display.

### 1. Program Generation

The server generates a program for workers to wear smart glasses to learn information such as work procedures, equipment images, and past accident cases in advance. This program includes a function that allows the worker to view the operation screen through the smart glasses and input instructions by voice.

### Explanation of Program Processing

The server installs the generated program in the smart glasses. When worn by a worker, the smart glasses display information such as work procedures, equipment images, and past accident examples. The worker can view this information through the Smart Glasses' display.

When a worker inputs voice instructions, the smart glasses transmit the voice data to the server. The server converts the voice data into text using voice recognition software (e.g., speech recognition technology). It then uses a generative AI model (e.g., artificial intelligence model) to generate prompt sentences to determine whether the input instructions are OK/NG for the task.

The server inputs the generated prompt sentences to the AI model and obtains the results to determine if the work is OK/NG. The acquired results are sent to the smart glasses and displayed on the smart glasses' display.

### 3. Examples of Specific Examples and Prompt Sentences

As a concrete example, consider the case where a worker enters voice instructions, “Please tell me the next work procedure.” In this case, the server generates the following prompt sentence:

### Example of a Prompt Statement

The worker wants to know what the next step is. “Please tell me what the next step is.”

The server inputs this prompt sentence to the generative AI model to obtain the next work procedure. The retrieved work procedure is displayed on the smart glasses display.

In this way, workers can check information such as work procedures, equipment images, and past accident cases through smart glasses, and judge whether work is OK or NG by inputting voice instructions.

The flow of the identification process in Example 1 is described in FIG. 11.

### Step 1:

### Smart Glass Activation and Connection

The user puts on the smart glasses and turns them on.

The terminal (smart glasses) connects to the server through Wi-Fi.

Input: Smart Glass power on, Wi-Fi connection information

Output: Connection established with server

### Step 2:

### Display of Work Procedures and Information

The server recognizes the worker's ID and sends information such as related work procedures, equipment images, and past accidents to the smart glasses.

The terminal displays the received information on its display. For example, a list of work procedures and images of equipment are displayed.

Input: Worker's ID, relevant information

Output: Work procedures and equipment images displayed on smart glasses

### Step 3:

### Input of Voice Instructions

The user enters voice instructions into the smart glasses. For example, he/she says, “Please tell me the next step in the workflow.”

Input: User's voice instructions

Output: Audio data

### Step 4:

### Transmission and Analysis of Voice Data

The terminal sends the user's voice data to the server.

The server uses speech recognition software (e.g., speech recognition technology) to convert voice data into text.

Input: Voice data

Output: Text data

### Step 5:

### OK/NG Judgment of Work

The server generates prompt statements based on the converted text. For example, “The worker wants to know the next work procedure. Please tell me what the next step is.” The server generates the prompt sentence “The worker wants to know the next step.”

The server inputs this prompt statement to the generating AI model (e.g., artificial intelligence model) to obtain the next work procedure and the OK/NG decision for the work.

Input: text data, prompt statements

Output: Work procedures and OK/NG decisions

### Step 6:

### Display of Judgment Results

The server sends the retrieved results to the smart glasses.

The terminal displays the results received on its display. For example, “The next work step is to install part A.” or “The work is OK.” will be displayed.

Input: work procedures and OK/NG decisions

Output: Results displayed on smart glasses

### Example of Application 1

Next, example of application 1 of example of implement 1 will be described. In the following description, data processing device 12 is referred to as the “server” and headset-type terminal 314 is referred to as the “terminal.”

In conventional factory operations, workers spent a lot of time and effort to check procedures and equipment conditions. In addition, it was difficult to refer to past accident cases, and work safety was not sufficiently ensured. Furthermore, the lack of a means to report and properly evaluate the progress of work in real time reduced work efficiency. To solve these problems, there is a need for a system that enables workers to work efficiently and safely using smart glasses.

The specific processing by the specific processing unit 290 of the data processing device 12 in example of application 1 is realized by the following means.

In this invention, the server has means to learn in advance the information necessary for the work (procedures, equipment images, past accident cases, etc.), means to input the operation screen and the procedures to be performed by voice through the smart glasses when performing the work, means to judge whether the work is OK or NG and display the answer on the smart glasses, means to display the real-time status of the equipment The system includes means to display the real-time status of the equipment, means to display past accident cases and alert the operator, means to report the progress of the work based on voice input, means to judge whether the work is OK or NG based on the progress of the work, and means to display the results on the smart glasses display. This enables the worker to obtain the necessary information in real time and perform the work efficiently and safely.

“Information necessary for the work” refers to information necessary to perform the work, such as work procedures, equipment images, past accidents, etc.

A “means of learning in advance” is a means of acquiring and understanding the information needed to perform a task in advance.

“Smart glasses” are eyeglass-shaped devices worn by workers to display information.

The “operation screen” is the interface that the operator can see through the smart glasses.

A “voice input means” is a means by which a worker inputs instructions or information using voice.

The “means to determine OK/NG” is a means to evaluate the progress and results of the work and to determine if they are appropriate or not.

The “means of displaying the answer on the smart glasses” is a means of displaying the judgment result on the smart glasses' display.

“Means for displaying the real-time status of equipment” means a means for displaying the current status of equipment in real time.

The “means of displaying past accident cases and alerting the operator” is a means of displaying past accident cases and alerting the operator.

A “means for reporting work progress based on voice input” means a means for reporting work progress based on a worker's voice input.

The “means to determine whether work is OK/NG based on the progress of the work” is a means to evaluate the progress of the work and to determine whether the work is being performed properly.

The “means for displaying on the smart glasses display” is a means for displaying the judgment results and other information on the smart glasses display.

The system for implementing this invention allows workers to wear smart glasses and check information such as work procedures, equipment conditions, and past accidents in real time. An exemplary embodiment of this system is described below.

### Hardware and Software Used

Smart glasses: A glasses-type device worn by the worker and used to display information.

Microphone: Device used to capture the operator's voice input.

Server: A computer system that manages the information needed to do a job and processes voice input.

speech_recognition library: Software for converting spoken input into text.

smart_glasses_display module: custom software to display information on the Smart Glasses display.

factory_system module: Custom software to obtain work procedures, equipment status, and past accident cases from the factory system to determine if work is OK/NG.

### System Operation

1. display of work procedures: The server displays the necessary procedures for a task on the smart glasses display. This allows the operator to see, in real time, what needs to be done next.

2. equipment status check: The server obtains the real-time status of the equipment and displays it on the smart glasses. This allows workers to proceed with their work while keeping track of the current status of the equipment.

3. display of past accidents: The server displays past accidents on the smart glasses to alert the operator. This allows workers to refer to past mistakes and work safely.

4. capturing voice input: A worker enters spoken instructions through a microphone. The server converts the voice into text using the speech_recognition library.

5. work progress reporting: Based on the worker's voice input, the server reports the progress of the work. This allows the worker to report progress without using his/her hands.

6. work OK/NG judgment: The server judges work OK/NG based on voice input using the factory_system module.

Display of results: The results of the evaluation are displayed on the Smart Glasses' display. This allows the operator to check the evaluation of the work in real time.

### Concrete Example

When a worker wears the smart glasses and performs maintenance work on equipment, the following steps are used in the application:

1. voice input to the smart glasses, “Display the next work procedure”.

2. voice input to the smart glasses, “Check the condition of the equipment.

3. voice input to Smart Glasses, “Show past accident cases.

4. when the work is completed, voice input “work completed”.

The server determines whether the work is OK or NG and displays the results on the smart glasses.

### Example of Prompt Text

Show next steps.

“Check the condition of the equipment.”

“View past accidents.”

“Work completed.”

Thus, the use of smart glasses can significantly improve work efficiency and safety in the factory.

The flow of the identification process in Example of Application 1 is described in FIG. 12.

### Step 1:

The server learns in advance the information required for the work (e.g., procedures, equipment images, past accidents, etc.). This includes acquiring data from the factory system and using artificial intelligence to organize and analyze the information. The input is data from the factory system, and the output is the organized and analyzed work procedures, equipment images, and past accident cases.

### Step 2:

The user puts on the smart glasses and starts working. The server displays the work procedure on the smart glasses display. The input is the work procedure data from the server and the output is the work procedure displayed on the smart glasses display.

### Step 3:

The user inputs spoken instructions through a microphone. The server converts the voice into text using the speech_recognition library. The input is the user's voice instructions and the output is the instructions in text format.

### Step 4:

The server obtains the real-time status of the equipment based on the text form instructions and displays it on the smart glasses. The input is the text-format instruction, and the output is the real-time status of the facility displayed on the smart glasses.

### Step 5:

The server retrieves past accident cases and displays them on the smart glasses. The input is the user's voice instructions, and the output is the past accident cases displayed on the smart glasses display.

### Step 6:

A user reports the progress of his/her work by voice. The server converts the voice into text using the speech_recognition library and records the work progress. The input is the user's voice report and the output is the progress report in text format.

### Step 7:

The server judges whether the work is OK or NG based on the progress report in text format. The input is a progress report in text format and the output is the OK/NG judgment result of the work.

### Step 8:

The server displays the decision results on the smart glasses display. The input is the OK/NG judgment result of the work, and the output is the judgment result displayed on the smart glasses display.

### Example 2

Next, example 2 of exemplary embodiment of implement will be described. In the following description, data processing device 12 is referred to as the “server” and headset-type terminal 314 is referred to as the “terminal.”

In conventional maintenance work, workers are required to accurately grasp and execute procedures, but it is sometimes difficult to check procedures and determine their accuracy. In addition, workers need to use their hands to check procedures during work, which is problematic and reduces work efficiency. Furthermore, even when voice input is used, accurate analysis of voice data and determination of procedures is difficult, and real-time feedback may not be obtained. To solve these problems, there is a need for a system that uses voice input to confirm procedures and provide real-time feedback.

The specific processing unit 290 of the data processing device 12 in Example 2 is realized by the following means.

In this invention, the server has means to learn in advance the information necessary for the work (procedures, equipment images, past accident cases, etc.), means to input the operation screen and the procedures to be performed through the smart glasses by voice when performing the work, means to judge whether the work is OK or NG and display the answer on the smart glasses, means to convert voice means to convert the data into text data, means to analyze the text data to determine the accuracy of the procedure, means to transmit the results of the determination to the smart glasses, and means to display the results of the determination on the smart glasses' display. This allows the operator to check the procedure using voice input and receive real-time feedback while accurately performing the maintenance task.

“Information necessary for the work” refers to information necessary to perform maintenance work, such as procedures, equipment images, and past accidents.

The “means of learning” are the methods and techniques used to obtain and understand the information needed for a task in advance.

“Smart glasses” are wearable devices with built-in displays and microphones that enable voice input and information display.

The “operation screen” is a screen on the smart glasses' display that allows the user to review work procedures and other information.

The term “voice input means” refers to methods and techniques that allow operators to use their voice to input information about the operating screens and procedures to be performed.

“Means to determine OK/NG” is a method or technique to determine if an input procedure is correct or not.

The “means of displaying the answer” is the method or technique used by to display the results of the decision on the smart glasses display.

“Means for converting voice data to text data” refers to methods and techniques for converting voice input to text format.

“Means for analyzing text data to determine the accuracy of a procedure” refers to methods and techniques for analyzing text data and determining whether the entered procedure is correct.

“Means for transmitting judgment results to smart glasses” refers to methods and techniques for transmitting judgment results of procedure accuracy to smart glasses.

The “means for displaying the judgment result on the smart glasses display” is a method or technique for displaying the judgment result on the smart glasses display.

### Exemplary Embodiment of the Invention

This invention is a system that allows workers to voice input procedures using smart glasses when performing maintenance work on equipment, and to determine the accuracy of those procedures in real time. An exemplary embodiment of this system is described below.

### Hardware and Software Used

Smart Glasses: Wearable devices with built-in displays and microphones that allow voice input and information display.

Server: A computer system that analyzes audio data, determines procedures, and transmits the results.

Speech recognition technology for converting voice data to text data.

Generative AI model (e.g., OpenAI's GPT-4): an artificial intelligence model for analyzing textual data and determining the accuracy of procedures.

### System Operation

### Voice Input: 1.

The user wears the smart glasses and voice inputs maintenance procedures. For example, the user voice inputs a procedure such as “remove the filter.”

### 2. Transmission of Voice Data: (1)

The terminal (smart glasses) captures audio data through a built-in microphone and sends the data to the server. Wi-Fi and Bluetooth are used for communication.

### 3. Audio Data Conversion

The server converts the received voice data into text data using a predefined API. This API provides highly accurate speech recognition.

### 4. Procedure Determination:

The server uses a generation AI model (e.g., OpenAI's GPT-4) to determine if the maintenance procedures retrieved as text data are correct. This determination includes a process of checking against a predefined database of correct procedures.

### Transmission of Judgment Results: 5.

The server determines the accuracy of the procedure and sends the results to the smart glasses. Wi-Fi and Bluetooth are again used for communication.

### 6. Display of Results:

The terminal (smart glasses) displays the received decision on its display. For example, “The procedure is correct. Please proceed to the next step.” and so on.

### Concrete Example

As a concrete example, consider the case where a worker changes the filter of an air conditioner.

1. the user puts on the smart glasses and voice-types “remove filter”.

The terminal (smart glasses) sends this voice data to the server.

The server converts the voice data into text data “remove filter” using a predefined API. 3.

4. the server uses the data generation AI model to determine if this text data is the correct procedure. For example, it will check to see if the procedure “remove filter” exists in the database.

5. the server sends the judgment result “the procedure is correct” to the smart glasses.

6. the terminal (smart glasses) displays the result of this decision on its display and tells the user, “The procedure is correct. Please proceed to the next step.” and informs the user, “Please proceed to the next step.”

### Example of Prompt Text

User: “Remove the filter.”

Server: “The procedure is correct. Please proceed to the next step.”

User: “Install new filter”

Server: “The procedure is correct. Maintenance work has been completed.”

In this way, users can accurately proceed with maintenance tasks while receiving real-time feedback.

The flow of the identification process in Example 2 is described in FIG. 13.

### Program Processing Flow

### Step 1: Voice Input

The user wears the smart glasses and voice inputs maintenance procedures. For example, the user voice inputs a procedure such as “remove the filter.”

Input: User's voice instructions

Output: Audio data captured by the Smart Glass microphone

### Step 2: Transmission of Voice Data

The terminal (smart glasses) sends the captured voice data to the server through the built-in microphone. Wi-Fi and Bluetooth are used for communication.

Input: Audio data captured by the Smart Glass microphone

Output: Audio data sent to server

### Step 3: Convert Audio Data

The server converts the received voice data into text data using a predefined API. This API provides highly accurate speech recognition.

Input: Audio data sent to the server

Output: text data (e.g., “remove filter”)

### Step 4: Determination of Procedure

The server uses a generation AI model (e.g., OpenAI's GPT-4) to determine if the maintenance procedures retrieved as text data are correct. This determination includes a process of checking against a predefined database of correct procedures.

Input: text data (e.g., “remove filter”)

Output: Judgment result (e.g., “The procedure is correct.”)

### Step 5: Transmission of Judgment Results

The server determines the accuracy of the procedure and sends the results to the smart glasses. Wi-Fi and Bluetooth are again used for communication.

Input: Judgment result (e.g., “The procedure is correct.”)

Output: Judgment results sent to Smart Glass

### Step 6: Display Results

The terminal (smart glasses) displays the received decision on its display. For example, “The procedure is correct. Please proceed to the next step.” and so on.

Input: Judgment results sent to Smart Glass

Output: A message on the Smart Glass display (e.g., “The procedure is correct. Please proceed to the next step.”)

### Examples of Specific Actions

User: Speech: “Remove filter”.

Terminal (smart glasses): Transmits voice data to the server.

Server: Converts voice data to text data using a specified API.

4. server: analyze text data using the data generation model to determine the accuracy of the procedure.

Server: Transmits judgment results to smart glasses.

6. terminal (smart glasses): the result of the decision is shown on the display and the message “The procedure is correct. Please proceed to the next step.” and informs the user.

In this way, users can accurately proceed with maintenance tasks while receiving real-time feedback.

### Example of Application 2

Next, example of application 2 of example of implement 2 will be described. In the following description, data processing device 12 is referred to as the “server” and headset-type terminal 314 is referred to as the “terminal.”

In conventional maintenance work, workers are required to accurately understand and implement procedures. However, because there is a lack of a means to confirm procedures and the accuracy of work in real time, work errors and loss of efficiency can occur. In addition, there is a need for a system that allows workers to voice input procedures and immediately check their accuracy. The challenge is to improve work efficiency and accuracy by this

The specific processing by the specific processing unit 290 of the data processing device 12 in example of application 2 is realized by the following means.

In this invention, the server includes means to learn in advance the information required for the work (procedures, equipment images, past accident cases, etc.), means to input the operation screen and the procedures to be performed through the smart glasses by voice when performing the work, means to judge whether the work is OK/NG and display the answer on the smart glasses, and means to display the voice means for judging the inputted procedure in real time and displaying the result on the smart glasses display. This allows the operator to efficiently proceed with maintenance work while confirming the accuracy of the work in real time.

“Information necessary for the work” refers to information required to perform maintenance work, such as procedures, equipment images, and past accident examples.

The “means of learning” is a means of learning in advance the information necessary for a task, which is done using artificial intelligence.

“Smart glasses” are eyeglass-shaped devices worn by the operator that display an operation screen and the procedures to be performed, and can accept voice input.

The “operation screen” is a screen displayed on the smart glasses that the operator refers to when performing maintenance tasks.

A “voice input means” is a means for a worker to input maintenance procedures using voice, and is performed using voice recognition technology.

The “means to determine OK/NG” is a means to determine whether the entered maintenance procedure is correct or not.

The “means of displaying the answers” is a means for displaying the judgment results on the smart glasses' display.

The “real-time judging means” is a means for immediately judging the voice-input procedure and displaying the results in real time.

The “display” is a display device mounted on the smart glasses that shows the judgment results and operation screens.

The system for implementing this invention is such that when a worker wears the smart glasses and performs a maintenance task, the system inputs the procedure by voice, determines in real time whether the procedure is correct, and displays the result on the smart glasses' display.

### System Configuration

The system consists of the following major components

Smart glasses: These are eyeglass-shaped devices worn by the operator and equipped with a display that shows the operation screen and judgment results. They are also equipped with a microphone that accepts voice input.

2. server: processes the input procedure using speech recognition technology and artificial intelligence to determine the input procedure.

3. speech recognition software: Software for converting voice input into text, e.g., using Google's speech recognition API.

4. artificial intelligence model: This model is used to learn the information required for a task in advance and to determine whether the input procedure is correct or not.

### Program Processing

The server operates as follows:

1. acquisition of voice input: the worker's voice is acquired through the microphone of the smart glasses.

2. speech recognition: Acquired speech is converted into text using speech recognition software.

3. procedure determination: The converted text is input into the artificial intelligence model to determine if the procedure is correct.

4. display of the result: The result of the judgment is displayed on the smart glasses display.

### Hardware and Software Used

Hardware: Smart glasses, microphone
Software: Python, SpeechRecognition library, Smart Glass SDK, artificial intelligence models (e.g., TensorFlow)

### Concrete Example

For example, when a technician performs maintenance work on a robot, he or she can voice-activate the robot, remove the cover, and inspect the internal components. This voice is captured through the microphone of the smart glasses and converted into text by the voice recognition software. The converted text is sent to the server, where an artificial intelligence model determines the accuracy of the procedure. The result of the judgment is shown on the smart glasses' display as “The procedure is correct.”

### Example of Prompt Text

Turn off the robot, remove the cover, and inspect the internal components.

In this way, workers can efficiently proceed with maintenance work while checking the accuracy of the work in real time.

The flow of the identification process in example of application 2 is described in FIG. 14.

### Step 1:

The user puts on the smart glasses and begins the maintenance procedure. The user voice inputs the maintenance procedure into the microphone of the smart glasses. The voice input is a specific procedure, for example, “Turn off the robot, remove the cover, and inspect the internal parts. Input: User's voice. Output: voice data.

### Step 2:

The smart glasses send the acquired voice data to the server. The server uses speech recognition software (e.g., Google's speech recognition API) to convert the voice data into text data. Input: voice data. Output: text data.

### Step 3:

The server inputs the converted text data to the artificial intelligence model. The artificial intelligence model checks the data against a database of maintenance procedures learned in advance to determine if the input procedure is correct. Input: text data. Output: Judgment result (correct/wrong).

### Step 4:

The server sends the judgment results to the smart glasses. The smart glass displays the judgment result on its display. For example, messages such as “The procedure is correct” or “The procedure is incorrect. Please reconfirm.” Messages such as “The procedure is correct” or “The procedure is incorrect, please reconfirm.” Input: Judgment result. Output: Message shown on the display.

### Step 5:

The user checks the results of the decision on the smart glasses display and corrects the procedure if necessary. If the correct procedure is displayed, the user continues with the work.

Input: A message shown on the display. Output: User action (modify the procedure or continue working).

In this way, users can check the accuracy of maintenance procedures in real time.

### Example 3

Next, example 3 of exemplary embodiment of implement will be described. In the following description, data processing device 12 is referred to as the “server” and headset-type terminal 314 is referred to as the “terminal.”

Conventional work support systems required operators to manually determine the safety and efficiency of work, which entailed a high risk of work errors and accidents. In addition, there was a lack of means to effectively utilize past accident cases and work data, and work improvements and safety measures were not sufficiently implemented. Furthermore, it was difficult to provide real-time work support, which placed a heavy burden on workers.

The specific processing by the specific processing unit 290 of the data processing device 12 in Example 3 is realized by the following means.

In this invention, the server includes means for acquiring past work data and accident cases from a database and pre-processing them, means for training an artificial intelligence model using the pre-processed data, and means for inputting new work data and using the artificial intelligence model to determine whether work is OK or NG. This makes it possible to effectively utilize past data and automatically determine the safety and efficiency of work in real time.

“Information necessary for the work” refers to the data and knowledge required to perform the work, such as procedures, equipment images, and past accident examples.

“Smart glasses” refers to wearable devices that can be worn by workers to visually display operating screens and procedures to be performed.

The term “voice input means” refers to technology that allows operators to use voice to give operating instructions or input data.

The term “means to determine OK/NG” refers to technology used to evaluate the safety and efficiency of work and determine the results as OK or NG.

The term “database” refers to an information management system that systematically stores past work data and accident cases and allows retrieval and retrieval as needed.

The term “means of preprocessing” refers to technology that converts collected data into a format suitable for artificial intelligence models by completing missing values, normalization, feature extraction, and other processing.

The term “artificial intelligence model” refers to a model that uses machine learning algorithms to learn data and perform a specific task (in this case, the OK/NG decision for a task).

The term “means to train” refers to techniques for training artificial intelligence models using preprocessed data to improve their performance.

“New work data” refers to information about current or future work, on the basis of which the artificial intelligence model determines whether the work is OK or NG.

The term “means to provide feedback” refers to technology that notifies users of the results of judgments made by the artificial intelligence model and encourages them to improve their work or take safety measures.

This invention is a system to improve the safety and efficiency of operations and can be implemented as follows:

First, users use a development environment such as Python or TensorFlow to generate a program for the system. The program includes code to build an artificial intelligence (AI) model and to learn from historical work data and accident cases.

The server retrieves past work data and accident cases provided by users from a database (e.g., MySQL). Next, the server preprocesses these data and converts them into a format suitable for AI models. Specifically, data cleaning, normalization, and feature extraction are performed.

The server then trains the AI model using a machine learning library such as TensorFlow. Once training is complete, the server receives new work data as input and uses the AI model to determine whether the work is OK or NG.

As a concrete example, consider the case of factory work data. A user inputs past work data (e.g., work hours, equipment used, years of experience of workers) and accident cases (e.g., types, causes, and effects of accidents) into the system. The server learns these data and determines whether the work is safe or not when new work data is input.

### Example of a Prompt Statement:

Based on historical work data and case studies of accidents, determine if current work is safe.”

This system is expected to improve the efficiency and safety of workers. The flow of the identification process in Example 3 is described in FIG. 15.

### Step 1: Data Collection

Users upload past work data and accident cases to the system. Specifically, the data is extracted from a CSV file or database. Input is information such as work hours, equipment used, operator's years of experience, type of accident, cause, and impact. The output is that these data are stored on the server.

### Step 2: Data Preprocessing

The server preprocesses the collected data. Specifically, it completes missing values, normalizes data, and performs categorical data encoding. The input is the raw data collected in step 1. The output is the preprocessed data set. For example, missing values are complemented with averages, work hours are normalized, and instruments used are one-hot encoded.

### Step 3: AI Model Training

The server uses the preprocessed data to train AI models. Specifically, machine learning libraries such as TensorFlow are used. The input is the preprocessed data set from step 2. The output is the trained AI model. Training can take several hours.

### Step 4: Input Work Data

Users enter new work data into the system. Specifically, the data is entered in real-time or processed in batches. Inputs are information such as the start time of the new work, the equipment used, and the worker's years of experience. The output is that these data are stored on the server.

### Step 5: OK/NG Judgment of Work

The server passes the new work data entered to the AI model to determine if the work is OK/NG. Specifically, the AI model evaluates the safety and efficiency of the work. The input is the new work data entered in step 4. The output is the result of the OK/NG judgment of the work. For example, a judgment such as “NG because the work time is too long” is made.

### Step 6: Feedback on Results

The server will provide feedback to the user on the results of the decision. Specifically, the system notifies the user and displays a dashboard. Input is the judgment result obtained in step 5. The output is the feedback information to the user. The user reviews the work plan based on the result. For example, they take measures such as “shortening the work time” or “changing the equipment used.”

### Example of Application 3

Next, example 3 of application of example of implement 3 will be described. In the following description, data processing device 12 is referred to as the “server” and headset-type terminal 314 is referred to as the “terminal.”

Conventional work support systems require workers to learn procedures, equipment images, and past accident cases in advance, but they do not acquire work data in real time or make OK/NG decisions for work based on past data. As a result, work efficiency and safety were not sufficiently improved. Furthermore, it was necessary to improve the accuracy of judgment when workers input operation screens and procedures to be performed by voice through smart glasses.

The specific processing by the specific processing unit 290 of the data processing device 12 in example of application 3 is realized by the following means.

In this invention, the server includes means to learn in advance the information required for the work (procedures, equipment images, past accident cases, etc.), means to input the operation screen and the procedures to be performed through the smart glasses by voice when performing the work, and means to judge whether the work is OK or NG and display the answer on the smart glasses, means using artificial intelligence that acquires work data in real time and judges whether the work is OK or NG based on past data and accident cases. This makes it possible to improve work efficiency and safety.

“Information necessary for the work” refers to information such as procedures, equipment images, and past accidents that are necessary for the work to be performed.

A “means of learning in advance” is a means of learning in advance the information needed to perform a task.

“Smart glasses” are eyeglass-shaped devices that can be worn by the operator to display an operating screen and the procedures to be performed.

The “operation screen” is the screen that the operator can see through the smart glasses.

A “procedure to be performed” is a specific procedure to be followed when performing a task.

The “voice input means” is a means for the operator to use his/her voice to input the operation screens and procedures to be performed.

The “means to determine OK/NG” is a means to determine whether the result of the work is appropriate or not.

“Means to obtain work data in real time” means a means to obtain data in real time while work is being performed.

“Historical data” refers to data on work performed in the past.

An “accident case” is a specific example of an accident that has occurred in the past.

“Artificial intelligence means” is a means of using artificial intelligence technology to determine if a task is OK/NG.

The following is an exemplary embodiment of this invention.

First, the server has the means to learn in advance the information necessary for the work (procedures, equipment images, past accidents, etc.). This means is done using artificial intelligence techniques. Specifically, machine learning libraries such as TensorFlow are used to learn past work data and accident cases to model work patterns.

Next, the user wears smart glasses when performing the task. Smart glasses are devices used to display operation screens and procedures to be performed, and have a means of voice input using voice recognition technology. When the user inputs operation instructions by voice, the voice data is sent to the server, which converts it into text data using voice recognition technology.

The server has the means to acquire work data in real time. Specifically, the progress of the work is monitored in real time through cameras and sensors mounted on the smart glasses. This data is transmitted to the server, which has a means of using artificial intelligence to determine if the work is OK or NG based on past data and accident cases; the AI model is built using machine learning libraries such as TensorFlow to determine the suitability of the work based on data acquired in real time.

The decision results are displayed on the smart glasses. This allows users to check the progress of the work in real time and make corrections as necessary. This improves work efficiency and safety.

As a concrete example, consider a case in which a robot is assembling parts in a factory.

In this case, cameras and sensors mounted on the robot acquire work data in real time and input the data to the AI model, which determines whether the work is OK or not based on past data and accident cases, and displays the results on the smart glasses in real time.

Examples of prompt sentences to be input to the generative AI model could include the following:

A robot is assembling parts in a factory. Please build an AI system to judge whether the work is OK or NG based on the work data acquired in real time, referring to past data and accident cases.”

The above is an exemplary embodiment of this invention.

The flow of the identification process in example of application 3 is described in FIG. 16.

### Step 1:

The server learns information necessary for the work (procedures, equipment images, past accident cases, etc.) in advance. Specifically, it uses machine learning libraries such as TensorFlow to learn past work data and accident cases to model patterns of work. The input is past work data and accident cases, and the output is the learned AI model.

### Step 2:

The user puts on the smart glasses and begins to work. Smart glasses are devices used to display operation screens and procedures to be performed. The input is the user's voice instructions, and the output is the operation screen and procedures displayed on the smart glasses.

### Step 3:

The user inputs operation instructions by voice. The smart glasses use voice recognition technology to convert the voice into text data, which is then sent to the server. The input is the user's voice instructions and the output is the text data.

### Step 4:

The server acquires work data in real time. The progress of the work is monitored in real time through cameras and sensors mounted on the smart glasses. The input is the real-time data from the cameras and sensors and the output is the work data sent to the server.

### Step 5:

The server inputs work data acquired in real time to the AI model and judges whether the work is OK or NG. The AI model judges the suitability of the work based on past data and accident cases. The input is work data acquired in real time, and the output is the result of OK/NG judgment of work.

### Step 6:

The server sends the decision results to the smart glasses and displays them to the user. This allows the user to check the progress of the work in real time and make corrections as necessary. The input is the OK/NG judgment result of the work, and the output is the judgment result displayed on the smart glasses.

These are the specific processing steps for implementing this invention.

Further, an emotion engine that estimates the user's emotion may be combined. In other words, the specific processing unit 290 may use the emotion identification model 59 to estimate the user's emotion and perform specific processing using the user's emotion.

### Example of Implement 1.″

One exemplary embodiment of this invention is a system that combines an emotion engine that recognizes the emotions of a worker. In this system, when a worker wears the smart glasses and performs a task, the emotion engine recognizes the emotion from the tone of the worker's voice and facial expression. For example, if the worker feels nervous, the system can adjust work instructions according to the worker's emotions, such as slowing the pace of the work.

### Example of Implement 2.″

The emotion engine can also take measures such as suspending work if the worker's emotions exceed a certain threshold. For example, if the system determines that the worker is overly stressed, it can pause the work and instruct the worker to take a break.

### Example of Implement 3.″

Furthermore, the emotion engine can record changes in the worker's emotions and analyze the data to find areas for improvement in the work. For example, if a worker tends to feel stress during a particular task, the system can suggest improvements, such as revising the procedures for that task.

The following is a description of the process flow for each example of implement.

### Example of Implement 1.″

Step 1: The worker wears the smart glasses.
Step 2: As the work begins, the emotion engine recognizes emotions from the tone of the worker's voice and facial expressions.
Step 3: The emotion engine adjusts the work instructions according to the worker's emotions. For example, if the worker feels nervous, the system adjusts the pace of the work by slowing it down. Example of implement 2.”
Step 1: The worker puts on the smart glasses and starts working.
Step 2: The emotion engine recognizes the worker's emotion and pauses the work if the emotion exceeds a certain threshold.
Step 3: After pausing the work, the system instructs the worker to take a break.

### Example of Implement 3.″

Step 1: The worker puts on the smart glasses and starts working.
Step 2: The emotion engine records changes in the worker's emotions.
Step 3: The system analyzes the recorded emotional data to find areas for improvement in the work. For example, if a worker tends to feel stressed by a particular task, the system will suggest improvements, such as revising the procedures for that task.

### Example 1

Next, example 1 of exemplary embodiment of implement will be described. In the following description, data processing device 12 is referred to as the “server” and headset-type terminal 314 is referred to as the “terminal.”

Conventional work support systems allow workers to learn information such as work procedures, equipment images, and past accident cases in advance, but they could not respond to emotional changes during work. As a result, it was difficult to provide appropriate instructions when workers felt tension or stress, which could reduce work efficiency and safety.

The specific processing by the specific processing unit 290 of the data processing device 12 in Example 1 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK/NG and display the answer on the smart glasses, means to recognize the operator's The system also includes means to recognize the emotion of the worker and adjust work instructions according to that emotion. This makes it possible to respond to changes in the worker's emotions and provide appropriate instructions.

“Information necessary for the work” is a generic term for data and materials necessary to perform the work, such as work procedures, equipment images, and past accident examples.

“Smart glasses” are a type of wearable device with a built-in display, camera, and microphone that is worn by the worker.

The “operation screen” is an interface on the smart glasses' display that contains information such as work procedures and instructions.

The term “voice input means” refers to technology that allows workers to input instructions and information through voice, and generally involves the use of voice recognition technology.

The “means to determine OK/NG” is an algorithm or program that analyzes the worker's voice input and work content and determines whether the results are correct or not.

The “means of recognizing emotions” refers to technology that analyzes a worker's tone of voice and facial expressions to identify emotions such as tension and stress.

A “means of adjusting work instructions” is an algorithm or program for modifying the pace of work or the content of instructions in response to recognized worker emotions.

### Exemplary Embodiment of the Invention

This invention is a system in which workers wear smart glasses and learn information such as work procedures, equipment images, and past accident cases in advance. The worker can check the operation screen through the smart glasses and input instructions by voice.

Combined with an emotion engine, the system also has the ability to recognize the operator's emotions and adjust work instructions.

### Hardware and Software Used

Server: A relational database such as MySQL is used to store information such as work procedures, equipment images, and past accidents.

Terminal (smart glasses): wearable devices such as Google Glass or Microsoft HoloLens.

Speech recognition software: converts speech into text using a given API.

Emotion recognition software: Use Microsoft Azure's Emotion API or a system that combines OpenCV and deep learning models.

Specific System Operation

1. the server stores information such as work procedures, equipment images, and past accident cases in a database. For example, the database will store text data of work procedures and equipment image files.

When the terminal (smart glasses) is worn by the worker, it connects to the server via Wi-Fi and requests necessary information. The server sends work procedures and equipment images to the terminal in response to the request. The terminal displays the received information on its display.

3. the user (worker) checks the information displayed through the smart glasses and inputs voice instructions such as “tell me the next step”. Smart Glass captures the voice using its built-in microphone and converts the voice into text using a predefined API.

4. the server receives the text data of voice instructions sent from the terminal and analyzes it using a script written in Python. For example, it determines if the instruction “Tell me the next step” is correct and generates an OK/NG result.

5. the terminal displays the result of the decision received from the server on its display. For example, it displays a message such as “The following procedure is OK.”

6. the emotion engine analyzes the user's tone of voice and facial expressions. It uses the camera and microphone built into the smart glasses to capture the user's facial expressions and tone of voice, and uses Microsoft Azure's Emotion API to recognize emotions.

7. the server adjusts work instructions based on the emotional data received from the emotion engine. For example, if the server recognizes that the user is nervous, it sends additional instructions to the terminal, such as “Proceed slowly.” The terminal displays this instruction on its display.

### Concrete Example

For example, consider a case where a user wears smart glasses to perform an inspection of equipment. The user inputs a voice instruction, “Tell me the next step. The server analyzes this voice instruction and displays the next step on the smart glasses display. At the same time, if the emotion engine senses tension in the user's tone of voice, the server will display additional instructions such as “Please proceed slowly.”

### Example of Prompt Text

Examples of prompt sentences to be input into the generative AI model could include the following:

A worker is wearing smart glasses and inspecting equipment. The worker enters voice instructions for the next step. The server analyzes this voice instruction and displays the next step on the Smart Glasses display. At the same time, if the emotion engine detects tension in the worker's tone of voice, the server displays additional instructions to slow down the pace of the work.”

By inputting this prompt statement into a generative AI model, the system's behavior can be simulated.

The flow of the identification process in Example 1 is described in FIG. 17.

### Step 1:

The server stores the information in a database.

Input: information on work procedures, equipment images, past accidents, etc.

Processing: The server stores this information in a relational database such as MySQL. Specifically, the database stores text data of work procedures and image files of equipment.

Output: Information stored in the database.

### Step 2:

The terminal retrieves information from the server and displays it on the display.

Input: Information such as work procedures and equipment images stored on the server.

Processing: When the terminal (smart glasses) is worn by the user, it connects to the server via Wi-Fi and requests necessary information. The server sends work procedures and equipment images to the terminal in response to the request.

Output: Work procedures and equipment images displayed on the terminal's display.

### Step 3:

The user enters voice instructions.

Input: User voice instructions (e.g., “Tell me the next step”).

Processing: Smart Glasses captures voice using the built-in microphone and converts voice to text using a predefined API.

Output: Voice instructions converted to text.

### Step 4:

The server analyzes the voice instructions and determines whether the work is OK or NG.

Input: Voice instructions converted to text.

Processing: The server receives text data of voice instructions sent from the terminal and analyzes it using a script written in Python. For example, it determines if the instruction “Tell me the next step” is correct and generates an OK/NG result.

Output: OK/NG decision result.

### Step 5:

The terminal displays the results of the decision on its display.

Input: OK/NG judgment results received from the server.

Processing: The terminal displays the result of the decision received from the server on its display. For example, the terminal displays a message such as “The next step is OK.”

Output: The result of the decision shown on the terminal's display.

### Step 6:

The emotion engine recognizes the user's emotions.

Input: Tone of voice and facial expression of the user.

Processing: Capture the user's facial expressions and tone of voice using the smart glasses' built-in camera and microphone, and recognize emotions using Microsoft Azure's Emotion API.

Output: Recognized emotion data.

### Step 7:

The server adjusts work orders according to emotion.

Input: Emotion data received from the emotion engine.

Processing: The server adjusts work instructions based on the emotional data received from the emotion engine. For example, if a user is perceived as nervous, the server will send additional instructions to the terminal, such as “proceed slowly.”

Output: Adjusted work instructions shown on the terminal display.

### Example of Application 1

Next, example of application 1 of example of implement 1 will be described. In the following description, data processing device 12 is referred to as the “server” and headset-type terminal 314 is referred to as the “terminal.”

Conventional work support systems allow workers to learn information such as work procedures, equipment images, and past accident cases in advance, but lack support that takes into account their emotional state during work. As a result, the system may not be able to respond appropriately when the worker feels tension or stress, which may reduce work efficiency and safety. In addition, OK/NG judgment of operations by voice input also does not take emotional states into account, which may increase the psychological burden on the worker.

The specific processing by the specific processing unit 290 of the data processing device 12 in example of application 1 is realized by the following means. In this invention, the server includes means for learning information necessary for the work (procedures, equipment images, past accident cases, etc.) in advance, means for inputting the operation screen and procedures to be performed by voice through the smart glasses when performing the work, means for judging whether the work is OK or NG and displaying the answer on the smart glasses, means for recognizing the emotion of the worker, means for adjusting the pace and instructions according to the emotion of the worker The system also includes means to recognize the emotions of the worker, and means to adjust the pace of the work and instructions according to the worker's emotions. This enables appropriate support that takes into account the emotional state of the worker, and is expected to improve work efficiency and safety.

“Information necessary for work” refers to information necessary for smooth and safe operations, such as work procedures, equipment images, and past accidents.

The “means to learn in advance” is a means for workers to learn in advance the information necessary for their work, and this includes learning systems using artificial intelligence.

“Smart glasses” are wearable devices worn by the operator that provide a visual display of the operating screen and procedures to be performed.

The “means for voice input of operation screens and procedures to be performed” is a means for operators to input operation screens and procedures to be performed using voice, and voice recognition technology can be used.

The “means for judging OK/NG and displaying the answer on the smart glasses” is a means for judging whether the work is OK or NG based on the worker's voice input and displaying the result on the smart glasses' display.

The “emotion recognition means” is a means to recognize emotions from the tone of voice and facial expressions of the worker, and an emotion recognition engine can be used.

The “means for adjusting the pace of work and instructions” is a means for adjusting the pace of work and instructions according to the emotions of the worker.

An exemplary embodiment of this invention is an application that is installed on a factory robot. The following is an exemplary embodiment of this application.

### Hardware and Software Used

Hardware: smart glasses (e.g., wearable devices), factory robots (e.g., robot arms)

Software: Emotion recognition engine (e.g., emotion recognition software), speech recognition engine (e.g., speech recognition software), display software (e.g., display software).

### Data Processing and Data Arithmetic

### Voice Input Processing: 1.

The user inputs voice instructions into the smart glasses.

Convert speech into text using a speech recognition engine.

Analyze the converted text and determine if the operation is OK/NG.

### 2. Emotion Recognition Processing

Capture the user's facial expressions and tone of voice using the smart glasses' camera and microphone.

Use an emotion recognition engine to recognize the user's emotions.

Adjust the pace of work and instructions based on perceived emotions.

### 3. Processing of the Display:

The OK/NG results of the operation and the adjusted instructions are displayed on the smart glasses display.

Use display software to present the information in a visually pleasing manner.

### Concrete Example

For example, when a user performs maintenance on a robot arm, the user wears the smart glasses and performs the following operations:

1. the user voice inputs “tell me the next step”.

2. speech recognition engine converts speech into text and displays next steps

3. if the user is nervous, the emotion recognition engine detects this and adjusts the instructions to slow down the pace of the work.

4. the Smart Glass display will show “Please proceed slowly to the next step.

### Example of Prompt Text

Examples of prompt sentences to be entered into the generative AI model are as follows:

Design a smart glasses application to learn maintenance procedures for a “factory robot.

Include the ability for the user to enter spoken instructions and use an emotion recognition engine to recognize the user's emotions and adjust the pace of work and instructions. Hardware to be used is a wearable device and robot arm; software is voice recognition software, emotion recognition software, and display software.”

In this way, smart glass applications can be implemented for efficient and safe operation and maintenance of factory robots.

The flow of the identification process in Example of Application 1 is described in FIG. 18.

### Step 1:

The user inputs voice instructions into the smart glasses. The voice input is captured through the Smart Glasses' microphone.

### Step 2:

The server uses a speech recognition engine to convert the captured speech into text. The input is the speech data and the output is the text data.

### Step 3:

The server analyzes the converted text and judges whether the operation is OK or NG. The input is the text data and the output is the OK/NG judgment result.

### Step 4:

The server uses the camera and microphone on the smart glasses to capture the user's facial expressions and tone of voice. Input is camera video and voice data.

### Step 5:

The server uses an emotion recognition engine to recognize the user's emotions from captured facial expressions and tone of voice. The input is the camera video and voice data, and the output is the emotion data.

### Step 6:

The server adjusts the pace of work and instructions based on the recognized emotions. The input is the emotion data and the output is the adjusted instructions.

### Step 7:

The server displays the OK/NG results of the operation and the adjusted instructions on the smart glasses display. The input is the OK/NG results and adjusted instructions, and the output is the display.

### Step 8:

The user reviews the information displayed on the smart glasses display and proceeds to the next step. The input is the display indication and the output is the user's next action.

### Example 2

Next, example 2 of exemplary embodiment of implement will be described. In the following description, data processing device 12 is referred to as the “server” and headset-type terminal 314 is referred to as the “terminal.”

In conventional maintenance work, workers are required to accurately understand and properly execute procedures, but errors in procedures and worker stress sometimes resulted in reduced work efficiency. In addition, worker health and safety were not adequately ensured because there was no system that monitored workers' emotional states in real time and instructed them to take a break at the appropriate time.

The specific processing unit 290 of the data processing device 12 in Example 2 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK or NG and display the answer on the smart glasses, and means to monitor the user The system also includes means for monitoring the emotional state of the user and, if the emotional state exceeds a certain threshold, suspending the work and instructing the user to take a break. This allows the worker to proceed with the work while checking the accuracy of the procedure, and also allows the user to take an appropriate break if he/she feels excessively stressed.

“Information necessary for the work” refers to the data and knowledge required to perform maintenance work accurately and efficiently, including procedures, equipment images, and past accident examples.

“Smart glasses” refers to wearable devices with displays and voice input capabilities that allow workers to view and input information hands-free.

The term “voice input means” refers to techniques and devices that allow operators to use their voice to input information on operating screens and procedures to be performed, and includes voice recognition technology.

The term “means to determine OK/NG” refers to a technique or device that evaluates whether an input procedure or operation is correct and outputs the results.

The term “means of monitoring emotional states” refers to techniques and devices used to measure and evaluate workers' stress levels and fatigue in real time.

“Means for suspending work and instructing workers to take a break when a certain threshold is exceeded” refers to techniques or devices for suspending work and instructing workers to take a break when the evaluation results of the emotional state exceed a set criterion.

The term “artificial intelligence” refers to technologies and systems that use machine learning and data analysis to automatically learn the information needed to perform a task and make decisions.

The term “speech recognition technology” refers to technologies and systems for converting speech into text data, enabling voice input.

This invention is a system that uses smart glasses to allow workers to voice input procedures when performing maintenance tasks, determine the accuracy of those procedures, and also monitor the emotional state of the worker. The system is implemented using the following hardware and software:

### Hardware and Software Used

### Hardware: Smart Glasses

Software: Speech recognition system, emotion engine, generative AI model

Specific System Operation

1. the user puts on the smart glasses. The smart glasses are activated and connected to the system.

2. the user inputs the maintenance procedure by voice. For example, the user speaks “change engine oil”.

The terminal (smart glasses) activates the speech recognition system and converts the input speech into text data. Specifically, speech recognition software (e.g., a given API) is used.

4. the server receives the text data and determines if the input procedure is correct using the generated AI model. For example, a generative AI model (e.g., GPT-4) evaluates whether the procedure “change engine oil” is correct.

The server sends the judgment result to the smart glasses display. The terminal (smart glasses) displays the judgment result on its display. For example, the result “correct” is displayed.

6. the terminal (smart glasses) monitors the user's emotional state using built-in sensors. The emotional engine evaluates the user's stress level and fatigue.

7. the server receives the evaluation results of the emotion engine and pauses the work if the user's emotion exceeds a certain threshold. The terminal (smart glasses) shows the message “Please take a break” on the display. For example, if the system determines that the user is excessively stressed, the system displays “Please take a break.”

### Concrete Example

### Example 1: Entering Maintenance Work Procedures

The user voice inputs “change engine oil”.

The voice recognition system in the smart glasses converts the text data into “change engine oil.

The server determines if this procedure is “correct” using a generative AI model.

The server displays the “correct” result on the smart glasses display.

The user checks the display and continues working.

### Example 2: Work Stoppage by the Emotion Engine

The emotional engine determines that the user is overly stressed while working.

The emotional engine pauses the work and displays the message “Please take a break” on the smart glasses' display.

The user follows the instructions and takes a break.

### Example of Prompt Text

Enter the procedure for changing the engine oil audibly. The system determines the accuracy of the procedure and shows the result on the display. Also, if you experience undue stress during the procedure, the system will pause the operation and ask you to take a break.”

In this way, users can proceed with their work with peace of mind, checking to see if their own work is correct. In addition, if the user feels excessive stress, the system will prompt him or her to take an appropriate break, thereby improving the safety and efficiency of the work.

The flow of the identification process in Example 2 is described in FIG. 19.

### Step 1:

The user puts on the smart glasses. The smart glasses are activated and connected to the system.

Input: Wearing Smart Glasses

Output: System connection completion message

Specific operation: Smart Glasses is activated and connected to the server via Wi-Fi or Bluetooth. The message “System connection complete” appears on the display.

### Step 2:

The user voice inputs the procedure for a maintenance task. For example, he/she speaks, “Change the engine oil.”

Input: Voice input (e.g., “change engine oil”)

Output: Audio data

Specific operation: The smart glasses' microphone captures voice and stores it as voice data.

### Step 3:

The terminal (smart glasses) activates the voice recognition system and converts the input voice into text data.

Input: Audio data

Output: Text data (e.g., “change engine oil”)

Specific behavior: Speech recognition software (e.g., a given API) analyzes speech data and generates corresponding text data.

### Step 4:

The server receives the text data and determines if the input procedure is correct using the data generation model.

Input: Text data (e.g., “change engine oil”)

Output: Judgment result (e.g., “correct”)

Specific behavior: The server uses a data generation model (e.g., GPT-4) to analyze the contents of the text data and evaluate the accuracy of the procedure.

### Step 5:

The server sends the judgment result to the smart glasses display. The terminal (smart glasses) displays the judgment result on its display.

Input: Judgment result (e.g., “correct”)

Output: Displayed (e.g., “correct”)

Specific operation: The server sends the judgment results to the smart glasses, and the smart glasses display the results on the display.

### Step 6:

The terminal (smart glasses) monitors the user's emotional state using built-in sensors.

Input: Biological data (e.g., heart rate, skin electrical response)

Output: Results of emotional state assessment (e.g., stress level)

Specific operation: Sensors in the smart glasses collect the user's biometric data, and the emotion engine analyzes the data to evaluate the emotional state.

### Step 7:

The server receives the evaluation results of the emotion engine and pauses the work if the user's emotion exceeds a certain threshold. The terminal (smart glasses) displays the message “Please take a break” on the display.

Input: Result of emotional state assessment (e.g., high stress)

Output: Break instruction message (e.g., “Please take a break”)

Specific operation: When the server receives the evaluation results from the emotion engine and determines that the stress level is high, it sends a break instruction message to the smart glasses and displays it on the display.

### Example of Application 2

Next, example of application 2 of example of implement 2 will be described. In the following description, data processing device 12 is referred to as the “server” and headset-type terminal 314 is referred to as the “terminal.”

In conventional maintenance work, workers are required to accurately understand and properly execute procedures, but accidents and mistakes can occur due to errors in procedures and worker stress. In addition, there is a problem of reduced work efficiency and safety due to the lack of a system that monitors the emotional state of workers in real time and prompts them to take a break at the appropriate time. To solve these problems, a system that checks the accuracy of work procedures and monitors the emotional state of workers is needed.

The specific processing by the specific processing unit 290 of the data processing device 12 in example of application 2 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK or not and display the answer on the smart glasses, means to monitor the worker's The system also includes means to monitor the emotional state of the worker and pause the work if the worker feels excessive stress, and means to instruct the worker to take a break. This makes it possible to proceed with the work while checking the accuracy of the work procedures, and to monitor the emotional state of the worker in real time and prompt the worker to take a break at the appropriate time.

“Information necessary for the work” refers to information such as procedures, equipment images, and past accidents that are required to perform maintenance work.

The “means of learning” is a means of learning in advance the information necessary for a task, which is done using artificial intelligence.

The “voice input means” is a means for the operator to voice input the operation screen and procedures to be performed through the smart glasses.

The “means for judging OK/NG” is a means for judging whether the entered work procedure is correct and displaying the result on the smart glasses.

The “means to monitor the emotional state” is a means to monitor the worker's emotional state in real time and pause the work if he/she feels excessively stressed.

A “means of instructing a worker to take a break” is a means of instructing a worker to pause work and take a break when he/she feels undue stress.

The system for implementing this invention consists of the following components.

First, the worker wears smart glasses to perform maintenance work. The smart glasses are equipped with a microphone and a camera, which can provide audio and video input.

### Hardware and Software Used

Hardware: smart glasses (e.g., Google Glass), microphone, camera

### Software: Prescribed API, Microsoft Azure Emotion API

### Data Processing and Data Arithmetic

### Voice Input and Recognition

1. voice input: the operator inputs the maintenance procedure by voice through the microphone of the smart glasses.

Speech Recognition: The server converts speech into text using a predefined API. This text is used to verify the accuracy of the work procedure.

### Procedure Evaluation

Procedure determination: The server determines if the converted text is a correct procedure. This determination is made by checking against a pre-trained database of work procedures.

### Emotional State Monitoring

4. emotion analysis: Acquire facial images of the worker through the Smart Glasses camera and analyze the emotional state using the Microsoft Azure Emotion API. Particular attention will be paid to stress levels that exceed a certain threshold.

### Result Display and Break Instructions

5. result display: The result of the decision and the emotional state are displayed on the smart glasses display. If the work procedure is correct, “Correct procedure” is displayed; if there is an error, “Incorrect procedure” is displayed.

6. break instruction: If the worker feels undue stress, the system pauses the work and instructs the worker to take a break.

### Concrete Example

Voice input: “Next, remove the screws.”

Procedure result: “Correct procedure.

Emotional analysis result: “The worker is under undue stress. Tell them to pause work and take a break.”

### Example of Prompt Text

Voice input: “Next, remove the screws.”

Procedure result: “Correct procedure.

Emotional analysis result: “The worker is under undue stress. Tell them to pause work and take a break.”

In this way, work can proceed while confirming the accuracy of work procedures, and the emotional state of the worker can be monitored in real time to prompt a break at the appropriate time. This improves work efficiency and safety.

The flow of the identification process in example of application 2 is described in FIG. 20.

### Step 1:

The user puts on the smart glasses and begins a maintenance task. The user voice inputs the work procedure through the microphone of the smart glasses. The input voice data is captured by the microphone of the Smart Glasses.

### Step 2:

The server receives voice data sent from the smart glasses. The received voice data is sent to a predefined API, which converts the voice to text data. The input is voice data and the output is text data.

### Step 3:

The server matches the converted text data against a pre-trained database of work procedures. As a result of the cross-checking, the server determines whether the input procedure is correct or not. The input is the text data and the output is the judgment result regarding the correctness of the procedure.

### Step 4:

The server receives the user's facial image acquired through the smart glasses camera. The received face image is sent to the Microsoft Azure Emotion API to analyze the user's emotional state. The input is the face image data and the output is the result of the emotional state analysis.

### Step 5:

The server integrates the results of the determination of the procedure and the analysis of the emotional state and displays them on the smart glasses' display. If the procedure is correct, it displays “The procedure is correct,” and if there is an error, it displays “There is an error in the procedure. If the user is under undue stress, the display will indicate “Please ask the user to pause the work and take a break. The input is the judgment and analysis results, and the output is the message shown on the display.

### Step 6:

The user chooses whether to continue working or take a break according to the message displayed on the smart glasses display. If the user takes a break, the system pauses the work and prompts the user to take a break. The input is the message displayed on the display and the output is the user's action.

### Example 3

Next, example 3 of exemplary embodiment of implement will be described. In the following description, data processing device 12 is referred to as the “server” and headset-type terminal 314 is referred to as the “terminal.”

Conventional work support systems have the ability to determine the accuracy of a worker's movements and procedures, but could not provide feedback that took into account the worker's emotions and stress level. As a result, the worker's emotional burden increased, which could reduce work efficiency and safety. In addition, it was difficult to quickly find areas for improvement in work because the system did not sufficiently collect and analyze the real-time OK/NG judgment of work and emotional data.

The specific processing by the specific processing unit 290 of the data processing device 12 in Example 3 is realized by the following means.

In this invention, the server includes means for learning in advance the information required for the work (procedures, equipment images, past accident cases, etc.), means for inputting the operation screen and the procedures to be performed by voice through a visual device when performing the work, means for judging whether the work is OK/NG and displaying the answer on the visual device, means for The system includes means for collecting and analyzing emotional data, and means for suggesting improvements to the work based on the collected emotional data. This makes it possible to improve work efficiency and safety by providing feedback that takes into account the worker's emotions and stress level.

“Information necessary for the work” refers to data necessary to perform the work accurately and safely, such as procedures, equipment images, and past accidents.

A “visual device” is a device that a worker wears to visually confirm the operation screen and procedures to be performed, and includes smart glasses.

The term “voice input means” refers to technology that allows operators to input operation screens and procedures to be performed using voice, and includes voice recognition technology.

The “OK/NG judgment method” is a technique for evaluating the accuracy and appropriateness of work and feeding the results back to the operator.

Emotional data collection means technology for detecting and collecting data on workers' emotions and stress levels.

The “emotional data analysis method” is a technology for analyzing collected emotional data and evaluating changes in workers' emotions and stress levels.

The “means of suggesting improvements in work” is a technique for suggesting measures to improve work procedures and the environment based on the results of emotional data analysis.

This invention is a system to improve the efficiency and safety of workers, and is implemented by clarifying the roles of the server, terminal, and user.

### Server Role

The server provides a means to learn in advance the information required for the work (e.g., procedures, equipment images, past accident cases, etc.). Specifically, the server uses a database management system such as MySQL to collect and store past work data and accident cases. Next, AI models are trained based on the collected data; machine learning frameworks such as TensorFlow are used for the AI models.

The server will perform the following processes:

1. retrieve historical work data and accident cases from the database

2. preprocess the acquired data and convert it into a format suitable for AI models.

3. train AI models using preprocessed data.

4. save the trained AI model and use it for OK/NG decision of the work.

### Role of the Terminal

The terminal collects data on the work performed by the worker in real time and transmits it to the server. The terminal is equipped with hardware such as cameras and sensors, which are used to collect work data. The collected data is temporarily stored in the terminal and periodically uploaded to the server.

The terminal performs the following processes:

1. collect work data using cameras and sensors.

2. temporarily store the collected data.

3. periodically transmit the stored data to the server.

### Role of the User

Users receive feedback provided by the system to help them improve their work. For example, if the system gives a NG decision for a particular task, the user can check the reason and review the work procedure. Also, if the affective engine detects stress in the worker, the user can use that information to improve the work environment.

The user shall do the following:

1. review feedback from the system.

2. review work procedures and environment based on feedback.

3. implement the improvements and again receive feedback on the system.

### Concrete Example

For example, a factory worker is assembling parts. The server trains an AI model based on past assembly data and accident cases, and the terminal collects data by capturing the worker's movements with a camera; the AI model judges whether the work is OK or NG in real time, and notifies the user of the reason if the work is NG. The emotion engine analyzes the worker's facial expression and provides information to the user if the worker is feeling stress.

### Example of Prompt Text

Please design a system that trains AI models based on past work data and accident cases, and determines whether work is OK or NG in real time. Also add a function to analyze the worker's emotions and provide information if they are feeling stressed.”

In this way, the roles of the server, terminal, and user are clarified, and the flow of data processing using specific hardware and software is explained to facilitate understanding of the overall system. The flow of specific processing in Example 3 is explained using FIG. 21.

### Step 1:

### Data Collection

The server collects historical work data and accident cases. Input includes data from each work station in the plant. This includes worker movement logs, sensor data from the work environment, and past accident reports. The server stores these data in a database such as MySQL. As a specific action, the server connects to the database and stores the collected data.

### Step 2:

### Data Preprocessing

The server preprocesses the collected data. As input, there is the raw data collected in step 1. Specific data processing includes completion of missing values, removal of anomalous values, and normalization of data. As output, a dataset in a format suitable for AI models is obtained. As a specific action, the server uses a Python library to clean the data and store the preprocessed data in a new table.

### Step 3:

### AI Model Training

The server trains the AI model using the preprocessed data. As input, there is the data set preprocessed in step 2. As specific data operations, a machine learning framework such as TensorFlow is used to build and train the model. As output, a trained AI model is obtained. As a specific operation, the server inputs training data to TensorFlow, trains the model, and saves the model when training is complete.

### Step 4:

### Real-Time Data Collection and Transmission

The terminal collects data on the work performed by the worker in real time and transmits it to the server. Inputs include data on the worker's movements and the work environment. As specific data collection, data is collected using cameras and sensors and stored temporarily. As output, the collected data is transmitted to the server. As specific operations, the terminal takes pictures of the worker's movements with a camera, collects data on the work environment with a sensor, and periodically transmits the data to the server.

### Step 5:

### OK/NG Judgment of Work

The server inputs the real-time data received into the AI model to determine if the work is OK/NG. As input, there is the real-time data collected in step 4. As specific data operation, data is input to the AI model to obtain the judgment result. As output, OK/NG judgment results are obtained. As specific operations, the server inputs the received data into the AI model, analyzes the output results of the model, judges OK/NG, and sends the judgment results to the terminal.

### Step 6:

### Emotional Data Collection and Analysis

The terminal collects the worker's emotional data and sends it to the server. Inputs include the worker's facial expressions and voice data. As specific data collection, data is collected using cameras and microphones and analyzed by the emotion engine. As output, the analyzed emotion data is sent to the server. As specific operations, the terminal captures the worker's facial expressions with a camera, records the worker's voice with a microphone, analyzes the data with the emotion engine, detects changes in emotion, and sends the data to the server.

### Step 7:

### Providing Feedback

Users receive feedback provided by the system to help them improve their work. Input includes the results of the OK/NG decision in Step 5 and the emotional data in Step 6. As specific feedback, the user is given suggestions for revising work procedures and improving the environment. As output, the improvement measures are implemented and the system again receives feedback. As a specific action, the user checks the feedback on the terminal screen, reviews the work procedures and environment based on the feedback, executes the improvement measures, and receives the system feedback again.

### Example of Application 3

Next, example 3 of application of example of implement 3 will be described. In the following description, data processing device 12 is referred to as the “server” and headset-type terminal 314 is referred to as the “terminal.”

Conventional work support systems did not provide sufficiently accurate judgments to improve work efficiency and safety, and did not take into account workers' emotions and stress in proposing improvements. This caused a problem of accumulated stress for workers, resulting in a decrease in work efficiency.

The specific processing by the specific processing unit 290 of the data processing device 12 in example of application 3 is realized by the following means. In this invention, the server has the means to learn in advance the information necessary for the work (procedures, equipment images, past accident cases, etc.), the means to input the operation screen and the procedures to be performed by voice through the smart glasses when performing the work, the means to judge whether the work is OK or NG and display the answer on the smart glasses, the means to collect the emotion data of the worker and to record and analyze the changes in the emotion, the means to propose the improvement of the work procedures based on the emotion data and the work data, and the means to improve the work procedures based on the emotion data. The system includes means to collect emotional data of the worker, record and analyze changes in emotions, and suggest improvements to the work procedure based on the emotional and work data. This enables not only to improve the efficiency and safety of the work, but also to reduce the stress of the workers and to improve the work procedures.

“Information necessary for the work” refers to the data and knowledge required to perform the work, such as work procedures, equipment images, and past accident examples.

The term “means of learning” refers to methods and devices that use artificial intelligence to learn in advance the information necessary for a task.

“Smart glasses” refers to a glasses-type device worn by the worker that provides a visual display of the operating screen and procedures to be performed.

The term “voice input means” refers to methods and devices that allow operators to use their voice to input information on operating screens and procedures to be performed.

The term “means for determining OK/NG” refers to methods and devices for determining the appropriateness of work and displaying the results on smart glasses.

“Emotional data” refers to data indicating the emotional state of the worker, such as the worker's heart rate and skin electrical response.

“Means for recording and analyzing changes in emotions” refers to methods and devices for collecting workers' emotional data, recording and analyzing those changes.

The term “means for suggesting improvements in work procedures” refers to methods and devices for finding and suggesting improvements in work procedures based on emotional and operational data.

The system for implementing this invention consists of the following components. First, the server uses artificial intelligence (AI) to learn in advance the information necessary for the work (procedures, equipment images, past accident cases, etc.). Specifically, it learns patterns based on past work data and accident cases, and builds a model to determine whether work is OK or NG.

Next, smart glasses are used as the terminal. The smart glasses are worn by the worker and provide a visual display of the operation screen and procedures to be performed. The worker can use voice recognition technology to input the operation screen and procedures to be performed by voice. This allows the operator to perform operations without using his or her hands, thereby improving work efficiency.

In addition, the server collects emotional data from the worker, recording and analyzing changes in emotions. Emotional data includes heart rate and skin electrical responses. These data are collected in real time using an emotion engine at. The emotion engine analyzes the emotional state of the worker and alerts them when stress is elevated.

Finally, the server suggests improvements in work procedures based on the emotional and work data. This will reduce the stress of workers and improve the efficiency of work procedures.

As a concrete example, consider the case of assembling parts in a factory. The server learns from past assembly operation data and accident cases, and builds a model to judge whether the operation is OK or NG. The worker wears smart glasses and inputs operation procedures by voice. The smart glasses visually display the operation screen and procedures so that the worker can perform the operation without using his/her hands. The emotion engine collects the worker's heart rate and skin electrical response in real time and alerts the worker when stress is elevated. The server suggests improvements to work procedures based on the emotional and operational data.

Examples of prompt statements may include the following:

Please create a program that uses current work data and emotion data as inputs to determine if a task is OK/NG and alerts the user if necessary. The work data will include position and speed data, and the emotion data will include heart rate and skin electrical response; the AI model will use a Random Forest classifier, and the emotion engine will use the EmotionEngine class.”

In this way, the exemplary embodiment of the invention can be shown in detail.

The flow of the identification process in example of application 3 is described in FIG. 22.

### Step 1:

The server collects information necessary for the work (procedures, equipment images, past accident cases, etc.) and learns using artificial intelligence (AI). Specifically, using past work data and accident cases as input, the system learns patterns and builds a model to determine whether work is OK or NG. As output, a learned AI model is obtained.

### Step 2:

The user puts on the smart glasses and begins to work. The smart glasses visually display the operation screen and the procedure to be performed. As input, it receives the work procedure data provided by the server, and as output, it provides visual instructions to the user.

### Step 3:

The user uses voice recognition technology to input the operating procedures by voice. Smart Glass converts the voice input into text data and sends it to the server. Receive the user's voice data as input and generate text data as output.

### Step 4:

The server receives text data sent from the smart glasses and judges whether the work is OK or NG using a learned AI model. It uses the text data and the trained AI model as input and data generation model as output to determine if the task is OK or NG.

### Step 5:

The server sends the OK/NG decision results of the work to the smart glasses and displays them visually to the user. Receive the OK/NG decision results as input and provide visual feedback to the user as output.

### Step 6:

The server uses an emotion engine to collect real-time emotional data (e.g., heart rate, skin electrical response, etc.) from the worker. It receives data from emotion sensors as input and generates emotion data as output.

### Step 7:

The server analyzes the collected emotional data and evaluates the stress level of the worker. It uses the emotional data as input and generates the results of the stress level assessment as output.

### Step 8:

The server issues an alert and notifies the smart glasses if the stress level is high. It receives the results of the stress level assessment as input and generates an alert notification as output.

### Step 9:

The server proposes improvements to work procedures based on emotion and work data. It uses emotion and work data as input and generates improvement suggestions as output.

### Step 10:

The server sends suggestions for improving work procedures to the smart glasses and provides a visual display to the user. Receive suggestions for improvement as input and provide visual feedback to the user as output.

The specific processing unit 290 transmits the results of the specific processing to the headset-type terminal 314. At headset-type terminal 314, control unit 46A causes speaker 240 and display 343 to output the results of the specific processing. Microphone 238 acquires audio indicating user input to the results of the specific processing. The control unit 46A transmits the voice data indicating the user input acquired by the microphone 238 to the data processing device 12. In the data processing device 12, the specific processing unit 290 acquires the voice data.

The data generation model 58 is the so-called Generative AI (Artificial Intelligence). De

An example of a data generation model 58 is a generated AI such as ChatGPT (Internet search <URL: https://openai.com/blog/chatgpt>). The data generation model 58 is

The data is obtained by having a neural network perform deep learning on a neural network. A prompt containing instructions is input to the data generation model 58, and data for inference such as voice data indicating voice, text data indicating text, and image data indicating images are input to the model 58. The data generation model 58 infers the input data for inference according to the instructions given by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the headset-type terminal 314.

### Fourth Exemplary Embodiment

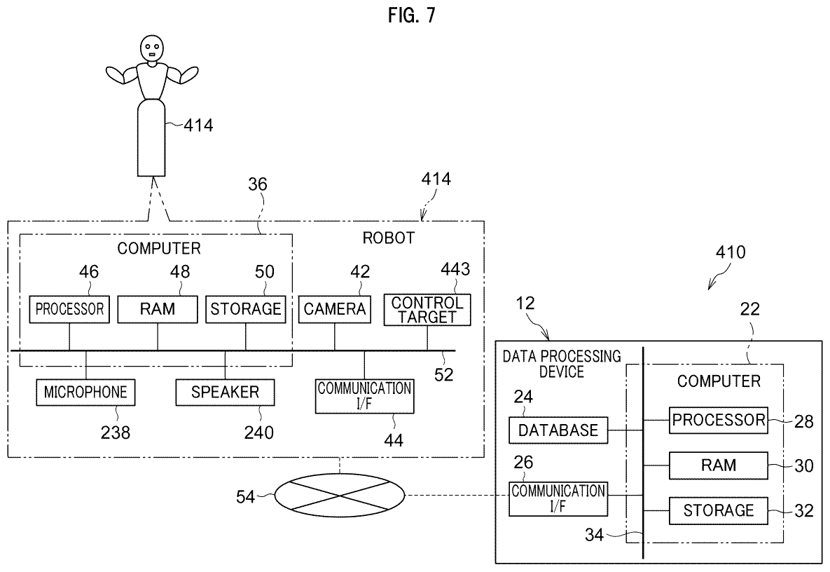

FIG. 7 shows an example of implement of a data processing system 410 for the fourth exemplary embodiment.

As shown in FIG. 7, the data processing system 410 has a data processing device 12 and a robot 414. An example of the data processing device 12 is a server.

The data processing device 12 has a computer 22, a database 24, and a communication I/F 26. Computer 22 is an example of a “computer” in the context of the present disclosure. Computer 22 has a processor 28, RAM 30, and storage 32. The processor 28, RAM 30, and storage 32 are connected to a bus 34. The database 24 and the communication I/F 26 are also connected to the bus 34. The communication I/F 26 is connected to a network 54. An example of a network 54 is a Wide Area Network (WAN) and/or a Local Area Network (LAN).

Robot 414 has computer 36, microphone 238, speaker 240, camera 42, communication I/F 44, and control target 443. The computer 36 has a processor 46, RAM 48, and storage 50.

Processor 46, RAM 48, and storage 50 are connected to bus 52. The microphone 238, speaker 240, camera 42, and control target 443 are also connected to the bus 52.

Microphone 238 accepts the voice emitted by user 20 and receives instructions, etc., from user 20. The microphone 238 captures the voice emitted by the user 20, converts the captured voice into voice data, and outputs the data to the processor 46. Speaker 240 is used to receive the audio data from the pro

Outputs audio as instructed by Sessor 46.

Camera 42 is a compact digital camera equipped with an optical system, such as a lens, aperture, and shutter, and an image sensor, such as a CMOS (Complementary Metal-Oxide-Semiconductor) image sensor or CCD (Charge Coupled Device) image sensor. It is a small digital camera equipped with an image sensor such as a CMOS (Complementary Metal-Oxide-Semiconductor) image sensor or CCD (Charge-Coupled Device) image sensor, and captures images of the surroundings of the user 20 (for example, an image range defined by an angle of view equivalent to the field of view of a typical healthy person).

The communication I/F 44 is connected to the network 54. The communication I/Fs 44 and 26 are responsible for transferring and receiving various information between the processor 46 and the processor 28 via the network 54. The transfer of various information between the processor 46 and the processor 28 using the communication I/Fs 44 and 26 is performed in a secure manner.

The control target 443 includes the display unit, the LEDs in the eyes, and the motors that drive the arms, hands, and feet, etc. The posture and gestures of robot 414 are controlled by controlling the motors of the arms, hands, and feet, etc. Some of the emotions of the robot 414 can be expressed by controlling these motors. The facial expressions of the robot 414 can also be expressed by controlling the light emission state of the LEDs in the eyes of the robot 414.

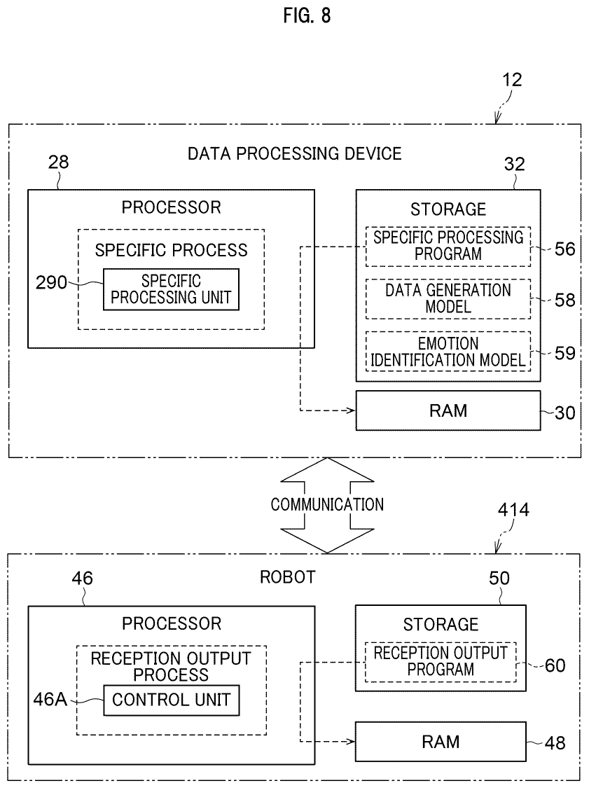

FIG. 8 shows an example of the key functions of the data processing device 12 and robot 414. As shown in FIG. 8, in data processing device 12, specific processing is performed by processor 28. The storage 32 contains a specific processing program 56.

The specific processing program 56 is an example of a “program” for the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on RAM 30.

The data generation model 58 and emotion identification model 59 are stored in storage 32. The data generation model 58 and emotion identification model 59 are used by the specific processing unit 290.

In robot 414, the reception output process is performed by processor 46. The reception output program 60 is stored in the storage 50. The processor 46 reads the reception output program 60 from the storage 50 and executes the read reception output program 60 on the RAM 48. The reception output process is realized by the processor 46 operating as the control unit 46A according to the reception output program 60 executed by the processor 46 on RAM 48.

Next, the specific processing by the specific processing unit 290 of the data processing device 12 is described.

### Example of Implement 1.″

One exemplary embodiment of this invention is a system in which workers wear smart glasses and learn in advance information such as work procedures, equipment images, and past accidents. The worker can view the operation screen through the smart glasses and can input voice instructions. The system determines whether work is OK or NG based on the worker's voice input and displays the results on the smart glasses' display.

### Example of Implement 2.″

As a concrete example, consider the case where a worker performs maintenance work on equipment. The worker wears smart glasses and inputs the maintenance work procedure by voice. The system will then listen to the input

The smart glasses display the results of the procedure. In this way, the operator can proceed with his/her work while confirming whether his/her work is correct or not.

### Example of Implement 3.″

The system can also use artificial intelligence to learn work information. The artificial intelligence learns patterns from past work data and accident cases, and judges whether work is OK/NG based on these patterns. This allows the system's judgment accuracy to improve over time, further improving the worker's work efficiency and safety.

The following is a description of the process flow for each example of implement.

### Example of Implement 1.”

Step 1: The worker wears the smart glasses.
Step 2: Smart glasses learn the information necessary for the work (procedures, equipment images, past accidents, etc.) in advance.
Step 3: The operator can view the operation screen through smart glasses and input instructions by voice.
Step 4: The system determines if the work is OK/NG based on the worker's voice input and displays the results on the smart glasses display.

### Example of Implement 2.″

Step 1: When a worker performs maintenance work on equipment, he or she first puts on the smart glasses.
Step 2: The operator voice-enters the maintenance procedure.
Step 3: The system determines if the entered procedure is correct and displays the result on the smart glasses display.
Step 4: Workers proceed based on system feedback.

### Example of Implement 3.″

Step 1: The system learns work information using artificial intelligence.
Step 2: Artificial intelligence learns patterns from past work data and accident cases.
Step 3: Based on the learned patterns, the system determines if the work is OK/NG.
Step 4: The results of the decision are displayed on the smart glasses display, and the worker proceeds based on the feedback.

### Example 1

Next, example 1 of exemplary embodiment of implement will be described. In the following description, data processing device 12 is referred to as the “server” and robot 414 is referred to as the “terminal.”

In conventional work support systems, it was difficult for workers to efficiently learn information such as procedures, equipment images, and past accident cases, and to receive appropriate instructions during work. There were also issues with the accuracy of voice input instructions and the speed of OK/NG decisions for work. This could reduce work efficiency and safety.

The specific processing by the specific processing unit 290 of the data processing device 12 in Example 1 is realized by the following means. In this invention, the server has the following means: a means to learn information necessary for the work (procedures, equipment images, past accident cases, etc.) in advance; a means to input the operation screen and procedures to be performed by voice through the smart glasses when performing the work; a means to judge whether the work is OK or NG and display the answer on the smart glasses; a means to analyze voice data is analyzed and converted into text, and a prompt sentence is generated using a generation AI model to determine the OK/NG of the task. This enables the operator to efficiently learn information, improve the accuracy of voice input instructions, and quickly determine the OK/NG of the work.

“Information necessary for the work” refers to knowledge and data necessary to perform the work, such as procedures, equipment images, and past accident examples.

A “means of learning” is a method or device by which a worker learns in advance the information necessary to perform a task.

“Smart glasses” are wearable devices that are worn by workers to display operational screens and information.

The “operation screen” is a screen displayed on the smart glasses that shows information such as work procedures and instructions.

A “means of voice input” is a method or device that allows a worker to input instructions or information using voice.

“Means to determine OK/NG” is a method or device used to evaluate the progress or results of work and determine if it is appropriate or not.

“Means for analyzing speech data and converting it to text” refers to methods and devices for converting speech data to text using speech recognition technology.

The “Generative AI Model” is a model that uses artificial intelligence to generate prompt sentences and determine if the work is OK/NG.

A “prompt sentence” is an instruction sentence to be input into the generated AI model, and is used as the basis for the OK/NG judgment of the work.

### Exemplary Embodiment of the Invention

This invention is a system in which workers wear smart glasses and learn information such as work procedures, equipment images, and past accident cases in advance. The worker can view the operation screen through the smart glasses and can input voice instructions. The system determines whether work is OK or NG based on the worker's voice input and displays the results on the smart glasses' display.

### 1. Program Generation

The server generates a program for workers to wear smart glasses to learn information such as work procedures, equipment images, and past accident cases in advance. This program includes a function that allows the worker to view the operation screen through the smart glasses and input instructions by voice.

### Explanation of Program Processing

The server installs the generated program in the smart glasses. When worn by a worker, the smart glasses display information such as work procedures, equipment images, and past accident examples. The worker can view this information through the Smart Glasses' display.

When a worker inputs voice instructions, the smart glasses transmit the voice data to the server. The server converts the voice data into text using voice recognition software (e.g., speech recognition technology). It then uses a generative AI model (e.g., artificial intelligence model) to generate prompt sentences to determine whether the input instructions are OK/NG for the task.

The server inputs the generated prompt sentences to the AI model and obtains the results to determine if the work is OK/NG. The acquired results are sent to the smart glasses and displayed on the smart glasses' display.

3. examples of specific examples and prompt sentences

As a concrete example, consider the case where a worker enters voice instructions, “Please tell me the next work procedure.” In this case, the server generates the following prompt sentence:

### Example of a Prompt Statement:

The worker wants to know what the next step is. “Please tell me what the next step is.”

The server inputs this prompt sentence to the generative AI model to obtain the next work procedure. The retrieved work procedure is displayed on the smart glasses display.

In this way, workers can check information such as work procedures, equipment images, and past accident cases through smart glasses, and judge whether work is OK or NG by inputting voice instructions.

The flow of the identification process in Example 1 is described in FIG. 11.

### Step 1:

### Smart Glass Activation and Connection

The user puts on the smart glasses and turns them on.

The terminal (smart glasses) connects to the server through Wi-Fi.

Input: Smart Glass power on, Wi-Fi connection information

Output: Connection established with server

### Step 2:

### Display of Work Procedures and Information

The server recognizes the worker's ID and sends information to the smart glasses, including relevant work procedures, equipment images, and past accidents.

The terminal displays the received information on its display. For example, a list of work procedures and images of equipment are displayed.

Input: Worker's ID, relevant information

Output: Work procedures and equipment images displayed on smart glasses

### Step 3:

### Input of Voice Instructions

The user enters voice instructions into the smart glasses. For example, he/she says, “Please tell me the next step in the workflow.”

Input: User's voice instructions

Output: Audio data

### Step 4:

### Transmission and Analysis of Voice Data

The terminal sends the user's voice data to the server.

The server uses speech recognition software (e.g., speech recognition technology) to convert voice data into text.

Input: Voice data

Output: Text data

### Step 5:

### OK/NG Judgment of Work

The server generates prompt statements based on the converted text. For example, “The worker wants to know the next work procedure. Please tell me what the next step is.” The server generates the prompt sentence “The worker wants to know the next step.”

The server inputs this prompt statement to the generating AI model (e.g., artificial intelligence model) to obtain the next work procedure and the OK/NG decision for the work.

Input: text data, prompt statements

Output: Work procedures and OK/NG decisions

### Step 6:

### Display of Judgment Results

The server sends the retrieved results to the smart glasses.

The terminal displays the results received on its display. For example, “The next work step is to install part A.” or “Work is OK.” will be displayed.

Input: work procedures and OK/NG decisions

Output: Results displayed on smart glasses

### Example of Application 1

Next, example of application 1 of example of implement 1 will be described. In the following description, the data processing device 12 is referred to as the “server” and the robot 414 is referred to as the “terminal.”

In conventional factory operations, workers spent a lot of time and effort to check procedures and equipment conditions. In addition, it was difficult to refer to past accident cases, and work safety was not sufficiently ensured. Furthermore, the lack of a means to report and properly evaluate the progress of work in real time reduced work efficiency. To solve these problems, there is a need for a system that allows workers to work efficiently and safely using smart glasses.

The specific processing by the specific processing unit 290 of the data processing device 12 in example of application 1 is realized by the following means.

In this invention, the server has means to learn in advance the information necessary for the work (procedures, equipment images, past accident cases, etc.), means to input the operation screen and the procedures to be performed by voice through the smart glasses when performing the work, means to judge whether the work is OK or NG and display the answer on the smart glasses, means to display the real-time status of the equipment The system includes means to display the real-time status of the equipment, means to display past accident cases and alert the operator, means to report the progress of the work based on voice input, means to judge whether the work is OK or NG based on the progress of the work, and means to display the results on the smart glasses display. This enables the worker to obtain the necessary information in real time and perform the work efficiently and safely.

“Information necessary for the work” refers to information necessary to perform the work, such as work procedures, equipment images, and past accidents.

A “means of learning in advance” is a means of acquiring and understanding the information needed to perform a task in advance.

“Smart glasses” are eyeglass-shaped devices worn by workers to display information.

The “operation screen” is the interface that the operator can see through the smart glasses.

A “voice input means” is a means by which a worker inputs instructions or information using voice.

The “means to determine OK/NG” is a means to evaluate the progress and results of the work and to determine if they are appropriate or not.

The “means of displaying the answer on the smart glasses” is a means of displaying the judgment result on the smart glasses' display.

“Means for displaying the real-time status of equipment” means a means for displaying the current status of equipment in real time.

The “means of displaying past accident cases and alerting the operator” is a means of displaying past accident cases and alerting the operator.

A “means for reporting work progress based on voice input” means a means for reporting work progress based on a worker's voice input.

The “means to determine whether work is OK/NG based on the progress of the work” is a means to evaluate the progress of the work and to determine whether the work is being performed properly.

The “means for displaying on the smart glasses display” is a means for displaying the judgment results and other information on the smart glasses display.

The system for implementing this invention allows workers to wear smart glasses and check information such as work procedures, equipment conditions, and past accidents in real time. An exemplary embodiment of this system is described below.

### Hardware and Software Used

Smart glasses: A glasses-type device worn by the worker and used to display information.

Microphone: Device used to capture the operator's voice input.

Server: A computer system that manages the information needed to do a job and processes voice input.

speech_recognition library: Software for converting spoken input into text.

smart_glasses_display module: custom software for displaying information on smart glasses displays.

factory_system module: Custom software to obtain work procedures, equipment status, and past accident cases from the factory system and determine if work is OK/NG.

### System Operation

1. display of work procedures: The server displays the necessary procedures for a task on the Smart Glasses' display. This allows the operator to see, in real time, what needs to be done next.

Confirmation of equipment status: The server obtains the real-time status of the equipment and displays it on the smart glasses. This allows workers to proceed with their work while keeping track of the current status of the equipment.

3. display of past accidents: The server displays past accidents on the smart glasses to alert the operator. This allows workers to refer to past mistakes and work safely.

4. capturing voice input: A worker enters spoken instructions through a microphone. The server converts the voice into text using the speech_recognition library.

5. work progress reporting: Based on the worker's voice input, the server reports the progress of the work. This allows the worker to report progress without using his/her hands.

6. work OK/NG judgment: The server judges work OK/NG based on voice input using the factory_system module.

Display of results: The results of the evaluation are displayed on the Smart Glasses' display. This allows the operator to check the evaluation of the work in real time.

### Concrete Example

When a worker wears the smart glasses and performs maintenance work on equipment, the following steps are used in the application:

1. voice input to the smart glasses, “Display the next work procedure”.

2. voice input to the smart glasses, “Check the condition of the equipment.

3. voice input to Smart Glasses, “Show past accident cases.

4. when the work is completed, voice input “work completed”.

The server determines whether the work is OK or NG and displays the results on the smart glasses.

Example of Prompt Text

Show next steps.

“Check the condition of the equipment.”

“View past accidents.”

“Work completed.”

Thus, the use of smart glasses can significantly improve work efficiency and safety in the factory.

The flow of the identification process in Example of Application 1 is described in FIG. 12.

### Step 1:

The server learns in advance the information needed for the work (procedures, equipment images, past accidents, etc.). This involves acquiring data from the factory system and using artificial intelligence to organize and analyze the information. The input is data from the factory system, and the output is the organized and analyzed work procedures, equipment images, and past accident cases.

### Step 2:

The user puts on the smart glasses and starts working. The server displays the work procedure on the smart glasses display. The input is the work procedure data from the server and the output is the work procedure displayed on the smart glasses display.

### Step 3:

The user inputs spoken instructions through a microphone. The server converts the voice into text using the speech_recognition library. The input is the user's voice instructions and the output is the instructions in text format.

### Step 4:

The server obtains the real-time status of the equipment based on the text form instructions and displays it on the smart glasses. The input is the text-format instruction, and the output is the real-time status of the facility displayed on the smart glasses.

### Step 5:

The server retrieves past accident cases and displays them on the smart glasses. The input is the user's voice instructions, and the output is the past accident cases displayed on the smart glasses display.

### Step 6:

A user reports the progress of his/her work by voice. The server converts the voice into text using the speech_recognition library and records the work progress. The input is the user's voice report and the output is the progress report in text format.

### Step 7:

The server judges the work OK/NG based on the progress report in text format. The input is the progress report in text format and the output is the OK/NG judgment result of the work.

### Step 8:

The server displays the decision results on the smart glasses display. The input is the OK/NG judgment result of the work, and the output is the judgment result displayed on the smart glasses display.

### Example 2

Next, example 2 of exemplary embodiment of implement will be described. In the following description, the data processing device 12 is referred to as the “server” and the robot 414 is referred to as the “terminal.”

In conventional maintenance work, workers are required to accurately grasp and execute procedures, but it is sometimes difficult to check procedures and determine their accuracy. In addition, workers need to use their hands to check the procedures during the work, which is a problem that reduces work efficiency. Furthermore, even when voice input is used, accurate analysis of voice data and determination of procedures is difficult, and real-time feedback may not be obtained. To solve these problems, there is a need for a system that uses voice input to confirm procedures and provide real-time feedback

The specific processing unit 290 of the data processing device 12 in Example 2 is realized by the following means.

In this invention, the server has means to learn in advance the information necessary for the work (procedures, equipment images, past accident cases, etc.), means to input the operation screen and the procedures to be performed through the smart glasses by voice when performing the work, means to judge whether the work is OK or NG and display the answer on the smart glasses, means to convert voice means to convert the data into text data, means to analyze the text data to determine the accuracy of the procedure, means to transmit the results of the determination to the smart glasses, and means to display the results of the determination on the smart glasses' display. This allows the operator to check the procedure using voice input and receive real-time feedback while accurately performing the maintenance task.

“Information necessary for the work” refers to information necessary to perform maintenance work, such as procedures, equipment images, and past accidents.

The “means of learning” are the methods and techniques used to obtain and understand the information needed for a task in advance.

“Smart glasses” are wearable devices with built-in displays and microphones that enable voice input and information display.

The “operation screen” is a screen on the smart glasses' display that allows the user to review work procedures and other information.

The term “voice input means” refers to methods and techniques that allow operators to use their voice to input information about operating screens and procedures to be performed.

“Means to determine OK/NG” is a method or technique to determine if an input procedure is correct.

The “means of displaying the answers” is the method or technique used to display the judgment results on the smart glasses' display.

“Means for converting voice data to text data” refers to methods and techniques for converting voice input to text format.

“Means for analyzing text data to determine the accuracy of a procedure” refers to methods and techniques for analyzing text data and determining whether the entered procedure is correct.

“Means for transmitting judgment results to smart glasses” refers to methods and techniques for transmitting judgment results of procedure accuracy to smart glasses.

The “means for displaying the judgment result on the smart glasses display” is a method or technique for displaying the judgment result on the smart glasses display.

### Exemplary Embodiment of the Invention

This invention is a system that allows workers to voice input procedures using smart glasses when performing maintenance work on equipment, and to determine the accuracy of those procedures in real time. An exemplary embodiment of this system is described below.

### Hardware and Software Used

Smart Glasses: Wearable devices with built-in displays and microphones that allow voice input and information display.

Server: A computer system that analyzes audio data, determines procedures, and transmits the results.

Speech recognition technology for converting voice data to text data.

Generative AI model (e.g., OpenAI's GPT-4): an artificial intelligence model for analyzing textual data and determining the accuracy of procedures.

### System Operation

### 1. Voice Input: 1.

The user wears the smart glasses and voice inputs maintenance procedures. For example, the user voice inputs a procedure such as “remove the filter.”

### 2. Transmission of Voice Data: (1)

The terminal (smart glasses) captures audio data through a built-in microphone and sends the data to the server. Wi-Fi and Bluetooth are used for communication.

### 3. Audio Data Conversion

The server converts the received voice data into text data using a predefined API. This API provides highly accurate speech recognition.

### 4. Procedure Determination:

The server uses a generation AI model (e.g., OpenAI's GPT-4) to determine if the maintenance procedures retrieved as text data are correct. This determination includes a process of checking against a predefined database of correct procedures.

### Transmission of Judgment Result: 5.

The server determines the accuracy of the procedure and sends the results to the smart glasses. Wi-Fi and Bluetooth are again used for communication.

### 6. Display of Results:

The terminal (smart glasses) displays the received decision on its display. For example, “The procedure is correct. Please proceed to the next step.” and a message such as “The procedure is correct.”

### Concrete Example

As a concrete example, consider the case where a worker changes the filter of an air conditioner.

1. the user puts on the smart glasses and voice-types “remove filter”.

The terminal (smart glasses) sends this voice data to the server.

The server converts the voice data into text data “remove filter” using the specified API.

4. the server uses the data generation AI model to determine if this text data is the correct procedure. For example, it will check to see if the procedure “remove filter” exists in the database.

5. the server sends the judgment result “the procedure is correct” to the smart glasses.

6. the terminal (smart glasses) displays the result of this decision on its display and tells the user, “The procedure is correct. Please proceed to the next step.” and informs the user, “Please proceed to the next step.”

### Example of Prompt Text

User: “Remove the filter.”

Server: “The procedure is correct. Please proceed to the next step.”

User: “Install new filter”

Server: “The procedure is correct. Maintenance work has been completed.”

In this way, users can accurately proceed with maintenance tasks while receiving real-time feedback.

The flow of the identification process in Example 2 is described in FIG. 13.

### Program Processing Flow

### Step 1: Voice Input

The user wears the smart glasses and voice inputs maintenance procedures. For example, the user voice inputs a procedure such as “remove the filter.”

Input: User's voice instructions

Output: Audio data captured by the Smart Glass microphone

### Step 2: Transmission of Voice Data

The terminal (smart glasses) sends the captured voice data to the server through the built-in microphone. Wi-Fi and Bluetooth are used for communication.

Input: Audio data captured by the Smart Glass microphone

Output: Audio data sent to server

### Step 3: Convert Audio Data

The server converts the received voice data into text data using a predefined API. This API provides highly accurate speech recognition.

Input: Audio data sent to the server

Output: text data (e.g., “remove filter”)

### Step 4: Determination of Procedure

The server uses a generation AI model (e.g., OpenAI's GPT-4) to determine if the maintenance procedures retrieved as text data are correct. This determination includes a process of checking against a predefined database of correct procedures.

Input: text data (e.g., “remove filter”)

Output: Judgment result (e.g., “The procedure is correct.”)

Step 5: Transmission of judgment results

The server determines the accuracy of the procedure and sends the results to the smart glasses. Wi-Fi and Bluetooth are again used for communication.

Input: Judgment result (e.g., “The procedure is correct.”)

Output: Judgment results sent to Smart Glass

### Step 6: Display Results

The terminal (smart glasses) displays the received decision on its display. For example, “The procedure is correct. Please proceed to the next step.” and so on.

Input: Judgment results sent to Smart Glass

Output: A message on the Smart Glass display (e.g., “The procedure is correct. Please proceed to the next step.”)

### Examples of Specific Actions

User: Speech: “Remove filter”.

Terminal (smart glasses): Transmits voice data to the server.

Server: Converts voice data to text data using a specified API.

6. server: analyze text data using the data generation model to determine the accuracy of the procedure.

Server: Transmits judgment results to smart glasses.

terminal (smart glasses): the result of the decision is shown on the display and the message “The procedure is correct. Please proceed to the next step. and informs the user.

In this way, users can accurately proceed with maintenance tasks while receiving real-time feedback.

### Example of Application 2

Next, example of application 2 of example of implement 2 will be described. In the following description, data processing device 12 is referred to as the “server” and robot 414 is referred to as the “terminal.”

In conventional maintenance work, operators are required to accurately grasp and implement procedures, but lack of a means to confirm procedures and the accuracy of work in real time can lead to work errors and loss of efficiency. In addition, there is a need for a system that allows workers to voice input procedures and immediately check their accuracy. The challenge is to improve work efficiency and accuracy by this

The specific processing by the specific processing unit 290 of the data processing device 12 in example of application 2 is realized by the following means.

In this invention, the server includes means to learn in advance the information required for the work (procedures, equipment images, past accident cases, etc.), means to input the operation screen and the procedures to be performed through the smart glasses by voice when performing the work, means to judge whether the work is OK/NG and display the answer on the smart glasses, and means to display the voice means for judging the inputted procedure in real time and displaying the result on the smart glasses display. This allows the operator to efficiently proceed with maintenance work while confirming the accuracy of the work in real time.

“Information necessary for the work” refers to information required to perform maintenance work, such as procedures, equipment images, and past accident examples.

The “means of learning” is a means of learning in advance the information necessary for a task, which is done using artificial intelligence.

“Smart glasses” are eyeglass-shaped devices worn by the operator that display an operation screen and the procedures to be performed, and accept voice input.

The “operation screen” is a screen displayed on the smart glasses that the operator refers to when performing maintenance tasks.

A “voice input means” is a means for a worker to input maintenance procedures using voice, and is performed using voice recognition technology.

The “means to determine OK/NG” is a means to determine if the entered maintenance procedure is correct or not.

The “means of displaying the answers” is a means for displaying the judgment results on the smart glasses' display.

The “real-time judging means” is a means for immediately judging the voice-input procedure and displaying the results in real time.

The “display” is a display device mounted on the smart glasses that shows the judgment results and operation screens.

The system for implementing this invention is such that when a worker wears the smart glasses and performs a maintenance task, the system inputs the procedure by voice, determines in real time whether the procedure is correct, and displays the result on the smart glasses' display.

### System Configuration

The system consists of the following major components:

Smart glasses: These are eyeglass-shaped devices worn by the operator and equipped with a display that shows the operation screen and judgment results. They are also equipped with a microphone that accepts voice input.

2. server: processes the input procedure using speech recognition technology and artificial intelligence to determine the input procedure.

3. speech recognition software: Software for converting voice input into text, e.g., using Google's speech recognition API.

4. artificial intelligence model: This model is used to learn the information required for a task in advance and to determine whether the input procedure is correct or not.

### Program Processing

The server operates as follows:

1. acquisition of voice input: the operator's voice is acquired through the microphone of the smart glasses.

2. speech recognition: Acquired speech is converted into text using speech recognition software.

3. procedure determination: The converted text is input into the artificial intelligence model to determine if the procedure is correct.

4. display of the result: The result of the judgment is displayed on the smart glasses display.

### Hardware and Software Used

Hardware: Smart glasses, microphone
Software: Python, SpeechRecognition library, Smart Glass SDK, artificial intelligence models (e.g., TensorFlow)

### Concrete Example

For example, when a technician performs maintenance work on a robot, he or she can voice-activate the robot, remove the cover, and inspect the internal components. This voice is captured through the microphone of the smart glasses and converted into text by the voice recognition software. The converted text is sent to the server, where an artificial intelligence model determines the accuracy of the procedure. The result of the judgment is shown on the smart glasses' display as “The procedure is correct.”

### Example of Prompt Text

Turn off the robot, remove the cover, and inspect the internal components.

In this way, workers can efficiently proceed with maintenance work while checking the accuracy of the work in real time.

The flow of the identification process in example of application 2 is described in FIG. 14.

### Step 1:

The user puts on the smart glasses and begins the maintenance procedure. The user voice inputs the maintenance procedure into the microphone of the smart glasses. The voice input is a specific procedure, for example, “Turn off the robot, remove the cover, and inspect the internal parts.” Input: User's voice. Output: voice data.

### Step 2:

The smart glasses send the acquired voice data to the server. The server uses speech recognition software (e.g., Google's speech recognition API) to convert the voice data into text data. Input: voice data. Output: text data.

### Step 3:

The server inputs the converted text data to the artificial intelligence model. The artificial intelligence model checks the data against a database of maintenance procedures learned in advance to determine if the input procedure is correct. Input: text data. Output: Judgment result (correct/wrong).

### Step 4:

The server sends the judgment results to the smart glasses. The smart glass displays the judgment result on its display. For example, messages such as “The procedure is correct” or “The procedure is incorrect. Please reconfirm.” Messages such as “The procedure is correct” or “The procedure is incorrect, please reconfirm.” Input: Judgment result. Output: Message shown on the display.

### Step 5:

The user should review the results of the determination on the smart glasses display and modify the procedure as necessary. If the correct procedure is displayed, the user continues working. Input: A message shown on the display. Output: User action (modify the procedure or continue working).

In this way, users can check the accuracy of maintenance procedures in real time.

### Example 3

Next, example 3 of exemplary embodiment of implement will be described. In the following description, the data processing device 12 is referred to as the “server” and the robot 414 is referred to as the “terminal.”

Conventional work support systems required operators to manually determine the safety and efficiency of work, which entailed a high risk of work errors and accidents. In addition, there was a lack of means to effectively utilize past accident cases and work data, and work improvements and safety measures were not sufficiently implemented. Furthermore, it was difficult to provide real-time work support, which placed a heavy burden on workers.

The specific processing by the specific processing unit 290 of the data processing device 12 in Example 3 is realized by the following means.

In this invention, the server includes means for acquiring past work data and accident cases from a database and pre-processing them, means for training an artificial intelligence model using the pre-processed data, and means for inputting new work data and using the artificial intelligence model to determine whether work is OK or NG. This makes it possible to effectively utilize past data and automatically determine the safety and efficiency of work in real time.

“Information necessary for the work” refers to the data and knowledge required to perform the work, such as procedures, equipment images, and past accident examples.

“Smart glasses” refers to wearable devices that can be worn by workers to visually display operating screens and procedures to be performed.

The term “voice input means” refers to technology that allows operators to use voice to give operating instructions or input data.

The term “means to determine OK/NG” refers to technology used to evaluate the safety and efficiency of work and determine the results as OK or NG.

The term “database” refers to an information management system that systematically stores past work data and accident cases and allows retrieval and retrieval as needed.

The term “means of preprocessing” refers to technology that converts collected data into a format suitable for artificial intelligence models by completing missing values, normalization, feature extraction, and other processing.

The term “artificial intelligence model” refers to a model that uses machine learning algorithms to learn data and perform a specific task (in this case, the OK/NG decision for a task).

The term “means to train” refers to techniques for training artificial intelligence models using preprocessed data to improve their performance.

“New work data” refers to information about current or future work, on the basis of which the artificial intelligence model determines whether the work is OK or NG.

The term “means to provide feedback” refers to technology that notifies users of the results of judgments made by the artificial intelligence model and encourages them to improve their work or take safety measures.

This invention is a system to improve the safety and efficiency of operations and can be implemented as follows:

First, users use a development environment such as Python or TensorFlow to generate a program for the system. The program includes code to build an artificial intelligence (AI) model and to learn from historical work data and accident cases.

The server retrieves past work data and accident cases provided by users from a database (e.g., MySQL). Next, the server preprocesses these data and converts them into a format suitable for AI models. Specifically, data cleaning, normalization, and feature extraction are performed.

The server then trains the AI model using a machine learning library such as TensorFlow. Once training is complete, the server receives new work data as input and uses the AI model to determine whether the work is OK or NG.

As a concrete example, consider the case of factory work data. A user inputs past work data (e.g., work hours, equipment used, years of experience of workers) and accident cases (e.g., types, causes, and effects of accidents) into the system. The server learns these data and determines whether the work is safe or not when new work data is input.

### Example of a Prompt Statement:

Based on historical work data and case studies of accidents, determine if current work is safe.”

This system is expected to improve the efficiency and safety of workers. The flow of the identification process in Example 3 is described in FIG. 15.

### Step 1: Data Collection

Users upload past work data and accident cases to the system. Specifically, the data is extracted from a CSV file or database. Input is information such as work hours, equipment used, operator's years of experience, type of accident, cause, and impact. The output is that these data are stored on the server.

### Step 2: Data Preprocessing

The server preprocesses the collected data. Specifically, it completes missing values, normalizes data, and performs categorical data encoding. The input is the raw data collected in step 1. The output is the preprocessed data set. For example, missing values are complemented with averages, work hours are normalized, and instruments used are one-hot encoded.

### Step 3: AI Model Training

The server uses the preprocessed data to train AI models. Specifically, machine learning libraries such as TensorFlow are used. The input is the preprocessed data set from step 2. The output is the trained AI model. Training can take several hours.

### Step 4: Input Work Data

Users enter new work data into the system. Specifically, the data is entered in real-time or processed in batches. Inputs are information such as the start time of the new work, the equipment used, and the worker's years of experience. The output is that these data are stored on the server.

### Step 5: OK/NG Judgment of Work

The server passes the new work data entered to the AI model to determine if the work is OK/NG. Specifically, the AI model evaluates the safety and efficiency of the work. The input is the new work data entered in step 4. The output is the result of the OK/NG judgment of the work. For example, a judgment such as “NG because the work time is too long” is made.

### Step 6: Feedback on Results

The server will provide feedback to the user on the results of the decision. Specifically, the system notifies the user and displays a dashboard. Input is the judgment result obtained in step 5. The output is the feedback information to the user. The user reviews the work plan based on the result. For example, they take measures such as “shortening the work time” or “changing the equipment used.”

### Example of Application 3

Next, example 3 of application of example of implement 3 will be described. In the following description, data processing device 12 is referred to as the “server” and robot 414 is referred to as the “terminal.”

Conventional work support systems require workers to learn procedures, equipment images, and past accident cases in advance, but they do not acquire work data in real time or make OK/NG decisions for work based on past data. As a result, work efficiency and safety were not sufficiently improved. Furthermore, it was necessary to improve the accuracy of judgment when workers input operation screens and procedures to be performed by voice through smart glasses.

The specific processing by the specific processing unit 290 of the data processing device 12 in example of application 3 is realized by the following means.

In this invention, the server includes means to learn in advance the information necessary for the work (procedures, equipment images, past accident cases, etc.), means to input the operation screen and the procedures to be performed through the smart glasses by voice when performing the work, and means to judge whether the work is OK or NG and display the answer on the smart glasses, means using artificial intelligence that acquires work data in real time and judges whether the work is OK or NG based on past data and accident cases. This makes it possible to improve work efficiency and safety.

“Information necessary for the work” refers to information such as procedures, equipment images, and past accidents that are necessary for the work to be performed.

A “means of learning in advance” is a means of learning in advance the information needed to perform a task.

“Smart glasses” are eyeglass-shaped devices that can be worn by the operator to display an operating screen and the procedures to be performed.

The “operation screen” is the screen that the operator can see through the smart glasses.

A “procedure to be performed” is a specific procedure to be followed when performing a task.

The “voice input means” is a means for the operator to use his/her voice to input the operation screens and procedures to be performed.

The “means to determine OK/NG” is a means to determine whether the result of the work is appropriate or not.

“Means to obtain work data in real time” means a means to obtain data in real time while work is being performed.

“Historical data” refers to data on work performed in the past.

An “accident case” is a specific example of an accident that has occurred in the past.

“Artificial intelligence means” is a means of using artificial intelligence technology to determine if a task is OK/NG.

The following is an exemplary embodiment of this invention.

First, the server has the means to learn in advance the information necessary for the work (procedures, equipment images, past accidents, etc.). This means is done using artificial intelligence techniques. Specifically, machine learning libraries such as TensorFlow are used to learn past work data and accident cases to model work patterns.

Next, the user wears smart glasses when performing the task. Smart glasses are devices used to display operation screens and procedures to be performed, and have a means of voice input using voice recognition technology. When the user inputs operation instructions by voice, the voice data is sent to the server, which converts it into text data using voice recognition technology.

The server has the means to acquire work data in real time. Specifically, the progress of the work is monitored in real time through cameras and sensors mounted on the smart glasses. This data is transmitted to the server, which has a means of using artificial intelligence to determine if the work is OK or NG based on past data and accident cases; the AI model is built using machine learning libraries such as TensorFlow to determine the suitability of the work based on data acquired in real time.

The decision results are displayed on the smart glasses. This allows users to check the progress of the work in real time and make corrections as necessary. This improves work efficiency and safety.

As a concrete example, consider a case in which a robot is assembling parts in a factory.

In this case, cameras and sensors mounted on the robot acquire work data in real time and input the data from to the AI model, which determines whether the work is OK or not based on past data and accident cases, and displays the results on the smart glasses in real time.

Examples of prompt sentences to be input to the generative AI model could include the following:

A robot is assembling parts in a factory. Please build an AI system to judge whether the work is OK or NG based on the work data acquired in real time, referring to past data and accident cases.”

The above is an exemplary embodiment of this invention.

The flow of the identification process in example of application 3 is described in FIG. 16.

### Step 1:

The server learns information necessary for the work (procedures, equipment images, past accident cases, etc.) in advance. Specifically, it uses machine learning libraries such as TensorFlow to learn past work data and accident cases to model patterns of work. The input is past work data and accident cases, and the output is the learned AI model.

### Step 2:

The user puts on the smart glasses and begins to work. Smart glasses are devices used to display operation screens and procedures to be performed. The input is the user's voice instructions, and the output is the operation screen and procedures displayed on the smart glasses.

### Step 3:

The user inputs operation instructions by voice. The smart glasses use voice recognition technology to convert the voice into text data, which is then sent to the server. The input is the user's voice instructions and the output is the text data.

### Step 4:

The server acquires work data in real time. The progress of the work is monitored in real time through cameras and sensors mounted on the smart glasses. The input is the real-time data from the cameras and sensors, and the output is the work data sent to the server.

### Step 5:

The server inputs work data acquired in real time to the AI model and judges whether the work is OK or NG. The AI model judges the suitability of the work based on past data and accident cases. The input is work data acquired in real time, and the output is the result of OK/NG judgment of work.

### Step 6:

The server sends the decision results to the smart glasses and displays them to the user. This allows the user to check the progress of the work in real time and make corrections as necessary. The input is the OK/NG judgment result of the work, and the output is the judgment result displayed on the smart glasses.

These are the specific processing steps for implementing this invention.

Further, an emotion engine that estimates the user's emotion may be combined. In other words, the specific processing unit 290 may use the emotion identification model 59 to estimate the user's emotion and perform specific processing using the user's emotion.

### Example of Implement 1.″

One exemplary embodiment of this invention is a system that combines an emotion engine that recognizes the emotions of a worker. In this system, when a worker wears the smart glasses and performs a task, the emotion engine recognizes the emotion from the tone of the worker's voice and facial expression. For example, if the worker feels nervous, the system can adjust work instructions according to the worker's emotions, such as slowing the pace of the work.

### Example of Implement 2.″

The emotion engine can also take measures such as suspending work if the worker's emotions exceed a certain threshold. For example, if the system determines that the worker is overly stressed, it can pause the work and instruct the worker to take a break.

### Example of Implement 3.″

In addition, the emotion engine records changes in the worker's emotions and analyzes the data,

It is also possible to find areas for improvement in the work. For example, if a worker tends to feel stress in a particular task, it is possible to suggest improvements, such as reviewing the procedures for that task.

The following is a description of the process flow for each example of implement.

### Example of Implement 1.″

Step 1: The worker wears the smart glasses.
Step 2: As the work begins, the emotion engine recognizes emotions from the tone of the worker's voice and facial expressions.
Step 3: The emotion engine adjusts the work instructions according to the worker's emotions. For example, if the worker feels nervous, the system adjusts the pace of the work by slowing it down. Example of implement 2.”
Step 1: The worker puts on the smart glasses and starts working.
Step 2: The emotion engine recognizes the worker's emotion and pauses the work if the emotion exceeds a certain threshold.
Step 3: After pausing the work, the system instructs the worker to take a break.

### Example of Implement 3.″

Step 1: The worker puts on the smart glasses and starts working.
Step 2: The emotion engine records changes in the worker's emotions.
Step 3: The system analyzes the recorded emotional data to find areas for improvement in the work. For example, if a worker tends to feel stressed by a particular task, the system will suggest improvements, such as revising the procedures for that task.

### Example 1

Next, example 1 of exemplary embodiment of implement will be described. In the following description, data processing device 12 is referred to as the “server” and robot 414 is referred to as the “terminal.”

Conventional work support systems allow workers to learn information such as work procedures, equipment images, and past accident cases in advance, but they could not respond to emotional changes during work. As a result, it was difficult to provide appropriate instructions when workers felt tension or stress, which could reduce work efficiency and safety.

The specific processing by the specific processing unit 290 of the data processing device 12 in Example 1 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK/NG and display the answer on the smart glasses, means to recognize the operator's The system also includes means to recognize the emotion of the worker and adjust work instructions according to that emotion. This makes it possible to respond to changes in the worker's emotions and provide appropriate instructions.

“Information necessary for the work” is a generic term for data and materials necessary to perform the work, such as work procedures, equipment images, and past accident examples.

“Smart glasses” are a type of wearable device with a built-in display, camera, and microphone that is worn by the worker.

The “operation screen” is an interface on the smart glasses' display that contains information such as work procedures and instructions.

The term “voice input means” refers to technology that allows workers to input instructions and information through voice, and generally involves the use of voice recognition technology.

The “means to determine OK/NG” is an algorithm or program that analyzes the worker's voice input and work content to determine whether the results are correct or not.

The “means of recognizing emotions” refers to technology that analyzes a worker's tone of voice and facial expressions to identify emotions such as tension and stress.

A “means of adjusting work instructions” is an algorithm or program for modifying the pace of work or the content of instructions in response to recognized worker emotions.

### Exemplary Embodiment of the Invention

This invention is a system in which workers wear smart glasses and learn information such as work procedures, equipment images, and past accident cases in advance. The worker can check the operation screen through the smart glasses and input instructions by voice.

Combined with an emotion engine, the system also has the ability to recognize the operator's emotions and adjust work instructions.

### Hardware and Software Used

Server: A relational database such as MySQL is used to store information such as work procedures, equipment images, and past accidents.

Terminal (smart glasses): wearable devices such as Google Glass or Microsoft HoloLens.

Speech recognition software: converts speech into text using a given API.

nEmotion recognition software: Use Microsoft Azure's Emotion API or a system that combines OpenCV and deep learning models.

Specific System Operation

1. the server stores information such as work procedures, equipment images, and past accident cases in a database. For example, the database will store text data of work procedures and equipment image files.

When the terminal (smart glasses) is worn by the worker, it connects to the server via Wi-Fi and requests necessary information. The server sends work procedures and equipment images to the terminal in response to the request. The terminal displays the received information on its display.

3. the user (worker) checks the information displayed through the smart glasses and inputs voice instructions such as “tell me the next step”. Smart Glass captures the voice using its built-in microphone and converts the voice into text using a predefined API.

4. the server receives the text data of voice instructions sent from the terminal and analyzes it using a script written in Python. For example, it determines if the instruction “Tell me the next step” is correct and generates an OK/NG result.

5. the terminal displays the result of the decision received from the server on its display. For example, it displays a message such as “The following procedure is OK.”

6. the emotion engine analyzes the user's tone of voice and facial expressions. It uses the camera and microphone built into the smart glasses to capture the user's facial expressions and tone of voice, and uses Microsoft Azure's Emotion API to recognize emotions.

7. the server adjusts work instructions based on the emotional data received from the emotion engine. For example, if the server recognizes that the user is nervous, it sends additional instructions to the terminal, such as “Proceed slowly.” The terminal displays this instruction on its display.

### Concrete Example

For example, consider a case where a user wears smart glasses to perform an inspection of equipment. The user inputs a voice instruction, “Tell me the next step. The server analyzes this voice instruction and displays the next step on the smart glasses display. At the same time, if the emotion engine senses tension in the user's tone of voice, the server will display additional instructions such as “Please proceed slowly.”

### Example of Prompt Text

Examples of prompt sentences to be input into the generative AI model could include the following:

A worker is wearing smart glasses and inspecting equipment. The worker enters voice instructions for the next step. The server analyzes this voice instruction and displays the next step on the Smart Glasses display. At the same time, if the emotion engine detects tension in the worker's tone of voice, the server displays additional instructions to slow down the pace of the work.”

By inputting this prompt statement into a generative AI model, the system's behavior can be simulated.

The flow of the identification process in Example 1 is described in FIG. 17.

### Step 1:

The server stores the information in a database.

Input: information on work procedures, equipment images, past accidents, etc.

Processing: The server stores this information in a relational database such as MySQL.

Specifically, the database stores text data of work procedures and image files of equipment.

Output: Information stored in the database.

### Step 2:

The terminal retrieves information from the server and displays it on the display.

Input: Information such as work procedures and equipment images stored on the server.

Processing: When the terminal (smart glasses) is worn by the user, it connects to the server via Wi-Fi and requests necessary information. The server sends work procedures and equipment images to the terminal in response to the request.

Output: Work procedures and equipment images displayed on the terminal's display.

### Step 3:

The user enters voice instructions.

Input: User voice instructions (e.g., “Tell me the next step”).

Processing: Smart Glasses captures voice using the built-in microphone and converts voice to text using a predefined API.

Output: Voice instructions converted to text.

### Step 4:

The server analyzes the voice instructions and determines whether the work is OK or NG.

Input: Voice instructions converted to text.

Processing: The server receives text data of voice instructions sent from the terminal and analyzes it using a script written in Python. For example, it determines if the instruction “Tell me the next step” is correct and generates an OK/NG result.

Output: OK/NG decision result.

### Step 5:

The terminal displays the results of the decision on its display.

Input: OK/NG judgment results received from the server.

Processing: The terminal displays the result of the decision received from the server on its display. For example, the terminal displays a message such as “The next step is OK.

Output: The result of the decision shown on the terminal's display.

### Step 6:

The emotion engine recognizes the user's emotions.

Input: Tone of voice and facial expression of the user.

Processing: Capture the user's facial expressions and tone of voice using the smart glasses' built-in camera and microphone, and recognize emotions using Microsoft Azure's Emotion API.

Output: Recognized emotion data.

### Step 7:

The server adjusts work orders according to emotion.

Input: Emotion data received from the emotion engine.

Processing: The server adjusts work instructions based on the emotional data received from the emotion engine. For example, if a user is perceived as nervous, the server will send additional instructions to the terminal, such as “proceed slowly.”

Output: Adjusted work instructions shown on the terminal display.

### Example of Application 1

Next, example of application 1 of example of implement 1 will be described. In the following description, the data processing device 12 is referred to as the “server” and the robot 414 is referred to as the “terminal.”

Conventional work support systems allow workers to learn information such as work procedures, equipment images, and past accident cases in advance, but lack support that takes into account their emotional state during work. As a result, the system may not be able to respond appropriately when the worker feels tension or stress, which may reduce work efficiency and safety. In addition, OK/NG judgment of operations by voice input also does not take emotional states into account, which may increase the psychological burden on the worker.

The specific processing by the specific processing unit 290 of the data processing device 12 in example of application 1 is realized by the following means. In this invention, the server includes means for learning information necessary for the work (procedures, equipment images, past accident cases, etc.) in advance, means for inputting the operation screen and procedures to be performed by voice through the smart glasses when performing the work, means for judging whether the work is OK or NG and displaying the answer on the smart glasses, means for recognizing the emotion of the worker, means for adjusting the pace and instructions according to the emotion of the worker The system also includes means to recognize the emotions of the worker, and means to adjust the pace of the work and instructions according to the worker's emotions. This enables appropriate support that takes into account the emotional state of the worker, and is expected to improve work efficiency and safety.

Information necessary for work” refers to information necessary for smooth and safe operations, such as work procedures, equipment images, and past accidents.

The “means to learn in advance” is a means for workers to learn in advance the information necessary for their work, and this includes learning systems using artificial intelligence.

Smart glasses” are wearable devices worn by the operator that provide a visual display of the operating screen and procedures to be performed.

The “means for voice input of operation screens and procedures to be performed” is a means for operators to input operation screens and procedures to be performed using voice, and voice recognition technology can be used.

The “means for judging OK/NG and displaying the answer on the smart glasses” is a means for judging whether the work is OK or NG based on the worker's voice input and displaying the result on the smart glasses' display.

The “emotion recognition means” is a means to recognize emotions from the tone of voice and facial expressions of the worker, and an emotion recognition engine can be used.

The “means for adjusting the pace of work and instructions” is a means for adjusting the pace of work and instructions according to the emotions of the worker.

An exemplary embodiment of this invention is an application that is installed on a factory robot. The following is an exemplary embodiment of this application.

### Hardware and Software Used

Hardware: smart glasses (e.g., wearable devices), factory robots (e.g., robot arms)

Software: Emotion recognition engine (e.g., emotion recognition software), speech recognition engine (e.g., speech recognition software), display software (e.g., display software)

### Data Processing and Data Arithmetic

### Voice Input Processing: 1.

The user inputs voice instructions into the smart glasses.

Convert speech into text using a speech recognition engine.

Analyze the converted text and determine if the operation is OK/NG.

### 2. Emotion Recognition Processing

Capture the user's facial expressions and tone of voice using the smart glasses' camera and microphone.

Use an emotion recognition engine to recognize the user's emotions.

Adjust the pace of work and instructions based on perceived emotions.

### 3. Processing of the Display:

The OK/NG results of the operation and the adjusted instructions are displayed on the smart glasses display.

Use display software to present the information in a visually pleasing manner.

### Concrete Example

For example, when a user performs maintenance on a robot arm, the user wears the smart glasses and performs the following operations

1. the user voice inputs “tell me the next step”.

2. speech recognition engine converts speech into text and displays next steps

3. if the user is nervous, the emotion recognition engine detects this and adjusts the instructions to slow down the pace of the work.

4. the Smart Glass display will show “Please proceed slowly to the next step.”

### Example of Prompt Text

Examples of prompt sentences to be entered into the generative AI model are as follows

Design a smart glasses application to learn maintenance procedures for a “factory robot.

Include the ability for the user to enter spoken instructions and use an emotion recognition engine to recognize the user's emotions and adjust the pace of work and instructions. Hardware to be used is a wearable device and robot arm; software is voice recognition software, emotion recognition software, and display software.”

In this way, smart glass applications can be implemented for efficient and safe operation and maintenance of factory robots.

The flow of the identification process in Example of Application 1 is described in FIG. 18.

### Step 1:

The user inputs voice instructions into the smart glasses. The voice input is captured through the Smart Glasses' microphone.

### Step 2:

The server uses a speech recognition engine to convert the captured speech into text. The input is the speech data and the output is the text data.

### Step 3:

The server analyzes the converted text and judges whether the operation is OK or NG. The input is the text data and the output is the OK/NG judgment result.

### Step 4:

The server uses the camera and microphone on the smart glasses to capture the user's facial expressions and tone of voice. Input is camera video and voice data.

### Step 5:

The server uses an emotion recognition engine to recognize the user's emotions from captured facial expressions and tone of voice. The input is the camera video and voice data, and the output is the emotion data.

### Step 6:

The server adjusts the pace of work and instructions based on the recognized emotions. The input is the emotion data and the output is the adjusted instructions.

### Step 7:

The server displays the OK/NG results of the operation and the adjusted instructions on the smart glasses display. The input is the OK/NG results and adjusted instructions, and the output is the display.

### Step 8:

The user reviews the information displayed on the smart glasses display and proceeds to the next step. The input is the display indication and the output is the user's next action.

### Example 2

Next, example 2 of exemplary embodiment of implement will be described. In the following description, the data processing device 12 is referred to as the “server” and the robot 414 is referred to as the “terminal.”

In conventional maintenance work, workers are required to accurately understand and properly execute procedures, but errors in procedures and worker stress sometimes resulted in reduced work efficiency. In addition, worker health and safety were not adequately ensured because there was no system that monitored workers' emotional states in real time and instructed them to take a break at the appropriate time.

The specific processing unit 290 of the data processing device 12 in Example 2 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK or not and display the answer on the smart glasses, and means to monitor the user The system also includes means for monitoring the emotional state of the user and, if the emotional state exceeds a certain threshold, suspending the work and instructing the user to take a break. This allows the worker to proceed with the work while checking the accuracy of the procedure, and also allows the user to take an appropriate break if he/she feels excessively stressed.

“Information necessary for the work” refers to the data and knowledge required to perform maintenance work accurately and efficiently, including procedures, equipment images, and past accident examples.

“Smart glasses” refers to wearable devices with displays and voice input capabilities that allow workers to view and input information hands-free.

The term “voice input means” refers to techniques and devices that allow operators to use their voice to input information on operating screens and procedures to be performed, and includes voice recognition technology.

The term “means to determine OK/NG” refers to a technique or device that evaluates whether an input procedure or operation is correct and outputs the results.

The term “means of monitoring emotional states” refers to techniques and devices used to measure and evaluate workers' stress levels and fatigue in real time.

“Means for suspending work and instructing workers to take a break when a certain threshold is exceeded” refers to techniques or devices for suspending work and instructing workers to take a break when the evaluation results of the emotional state exceed a set criterion.

The term “artificial intelligence” refers to technologies and systems that use machine learning and data analysis to automatically learn the information needed to perform a task and make decisions.

The term “speech recognition technology” refers to technologies and systems for converting speech into text data, enabling voice input.

This invention is a system that uses smart glasses to voice input procedures, determine the accuracy of those procedures, and also monitor the emotional state of the worker as he or she performs maintenance tasks. The system is implemented using the following hardware and software:

### Hardware and Software Used

### Hardware: Smart Glasses

Software: Speech recognition system, emotion engine, generative AI model

Specific System Operation

1. the user puts on the smart glasses. The smart glasses are activated and connected to the system.

2. the user inputs the maintenance procedure by voice. For example, the user speaks “change engine oil”.

The terminal (smart glasses) activates the speech recognition system and converts the input speech into text data. Specifically, speech recognition software (e.g., a given API) is used.

4. the server receives the text data and determines if the input procedure is correct using the generated AI model. For example, a generative AI model (e.g., GPT-4) evaluates whether the procedure “change engine oil” is correct.

The server sends the judgment result to the smart glasses display. The terminal (smart glasses) displays the judgment result on its display. For example, the result “correct” is displayed.

6. the terminal (smart glasses) monitors the user's emotional state using built-in sensors. The emotional engine evaluates the user's stress level and fatigue.

7. the server receives the evaluation results of the emotion engine and pauses the work if the user's emotion exceeds a certain threshold. The terminal (smart glasses) shows the message “Please take a break” on the display. For example, if the system determines that the user is excessively stressed, the system displays “Please take a break.”

### Concrete Example

### Example 1: Entering Maintenance Work Procedures

The user voice inputs “change engine oil”.

The voice recognition system in the smart glasses converts the text data into “change engine oil.”

The server determines if this procedure is “correct” using a generative AI model.

The server displays the “correct” result on the smart glasses display.

The user checks the display and continues working.

### Example 2: Work Stoppage by the Emotion Engine

The emotional engine determines that the user is overly stressed while working.

The emotional engine pauses the work and displays the message “Please take a break” on the smart glasses' display.

The user follows the instructions and takes a break.

### Example of Prompt Text

Enter the procedure for changing the engine oil audibly. The system determines the accuracy of the procedure and shows the result on the display. Also, if you experience undue stress during the procedure, the system will pause the operation and ask you to take a break.”

In this way, users can proceed with their work with peace of mind, checking to see if their own work is correct. In addition, if the user feels excessive stress, the system will prompt him or her to take an appropriate break, thereby improving the safety and efficiency of the work.

The flow of the identification process in Example 2 is described in FIG. 19.

### Step 1:

The user puts on the smart glasses. The smart glasses are activated and connected to the system.

Input: Wearing Smart Glasses

Output: System connection completion message

Specific operation: Smart Glasses is activated and connected to the server via Wi-Fi or Bluetooth. The message “System connection complete” appears on the display.

### Step 2:

The user voice inputs the procedure for a maintenance task. For example, he/she speaks, “Change the engine oil.”

Input: Voice input (e.g., “change engine oil”)

Output: Audio data

Specific operation: The smart glasses' microphone captures voice and stores it as voice data.

### Step 3:

The terminal (smart glasses) activates the voice recognition system and converts the input voice into text data.

Input: Audio data

Output: Text data (e.g., “change engine oil”)

Specific behavior: Speech recognition software (e.g., a given API) analyzes speech data and generates corresponding text data.

### Step 4:

The server receives the text data and determines if the input procedure is correct using the data generation model.

Input: Text data (e.g., “change engine oil”)

Output: Judgment result (e.g., “correct”)

Specific behavior: The server uses a data generation model (e.g., GPT-4) to analyze the contents of the text data and evaluate the accuracy of the procedure.

### Step 5:

The server sends the judgment result to the smart glasses display. The terminal (smart glasses) displays the judgment result on its display.

Input: Judgment result (e.g., “correct”)

Output: Displayed (e.g., “correct”)

Specific operation: The server sends the judgment results to the smart glasses, and the smart glasses display the results on the display.

### Step 6:

The terminal (smart glasses) monitors the user's emotional state using built-in sensors.

Input: Biological data (e.g., heart rate, skin electrical response)

Output: Results of emotional state assessment (e.g., stress level)

Specific operation: Sensors in the smart glasses collect the user's biometric data, and the emotion engine analyzes the data to evaluate the emotional state.

### Step 7:

The server receives the evaluation results of the emotion engine and pauses the work if the user's emotion exceeds a certain threshold. The terminal (smart glasses) displays the message “Please take a break” on the display.

Input: Result of emotional state assessment (e.g., high stress)

Output: Break instruction message (e.g., “Please take a break”)

Specific operation: When the server receives the evaluation results from the emotion engine and determines that the stress level is high, it sends a break instruction message to the smart glasses and displays it on the display.

### Example of Application 2

Next, example of application 2 of example of implement 2 will be described. In the following description, the data processing device 12 is referred to as the “server” and the robot 414 is referred to as the “terminal.”

In conventional maintenance work, workers are required to accurately understand and properly execute procedures, but accidents and mistakes can occur due to errors in procedures and worker stress. In addition, there is a lack of a system that monitors the emotional state of workers in real time and prompts them to take a break at the appropriate time, which is a problem that reduces work efficiency and safety. To solve these problems, a system is needed to check the accuracy of work procedures and monitor the emotional state of workers

The specific processing by the specific processing unit 290 of the data processing device 12 in example of application 2 is realized by the following means.

In this invention, the server includes means to learn in advance the information necessary for the work (procedures, equipment images, past accident cases, etc.), means to input the operation screen and the procedures to be performed by voice through the smart glasses when performing the work, means to judge whether the work is OK or not and display the answer on the smart glasses, means to monitor the worker's The system also includes means to monitor the emotional state of the worker and pause the work if the worker feels excessive stress, and means to instruct the worker to take a break. This makes it possible to proceed with the work while checking the accuracy of the work procedures, and to monitor the emotional state of the worker in real time and prompt the worker to take a break at the appropriate time.

“Information necessary for the work” refers to information such as procedures, equipment images, and past accidents that are required to perform maintenance work.

The “means of learning” is a means of learning in advance the information necessary for a task, which is done using artificial intelligence.

The “voice input means” is a means for the operator to voice input the operation screen and procedures to be performed through the smart glasses.

The “means for judging OK/NG” is a means for judging whether the entered work procedure is correct and displaying the result on the smart glasses.

The “means to monitor the emotional state” is a means to monitor the worker's emotional state in real time and pause the work if he/she feels excessively stressed.

A “means of instructing a worker to take a break” is a means of instructing a worker to pause work and take a break when he/she feels undue stress.

The system for implementing this invention consists of the following components.

First, the worker wears smart glasses to perform maintenance work. The smart glasses are equipped with a microphone and a camera, which can provide audio and video input.

### Hardware and Software Used

Hardware: smart glasses (e.g., Google Glass), microphone, camera

### Software: Prescribed API, Microsoft Azure Emotion API

### Data Processing and Data Arithmetic

### Voice Input and Recognition

1. voice input: the operator inputs the maintenance procedure by voice through the microphone of the smart glasses.

Speech Recognition: The server converts speech into text using a predefined API. This text is used to verify the accuracy of the work procedure.

### Procedure Evaluation

Procedure determination: The server determines if the converted text is a correct procedure. This determination is made by checking against a pre-trained database of work procedures.

### Emotional State Monitoring

4. emotion analysis: Acquire facial images of the worker through the Smart Glasses camera and analyze the emotional state using the Microsoft Azure Emotion API. Particular attention will be paid to stress levels that exceed a certain threshold.

### Result Display and Break Instructions

5. result display: The result of the decision and the emotional state are displayed on the smart glasses display. If the work procedure is correct, “Correct procedure” is displayed; if there is an error, “Incorrect procedure” is displayed.

6. break instruction: If the worker feels undue stress, the system pauses the work and instructs the worker to take a break.

### Concrete Example

Voice input: “Next, remove the screws.”

Procedure result: “Correct procedure.”

Emotional analysis result: “The worker is under undue stress. Tell them to pause work and take a break.”

### Example of Prompt Text

Voice input: “Next, remove the screws.”

Procedure result: “Correct procedure.”

Emotional analysis result: “The worker is under undue stress. Tell them to pause work and take a break.”

In this way, work can proceed while confirming the accuracy of work procedures, and the emotional state of the worker can be monitored in real time to prompt a break at the appropriate time. This improves work efficiency and safety.

The flow of the identification process in example of application 2 is described in FIG. 20.

### Step 1:

The user puts on the smart glasses and begins a maintenance task. The user voice inputs the work procedure through the microphone of the smart glasses. The input voice data is captured by the microphone of the Smart Glasses.

### Step 2:

The server receives voice data sent from the smart glasses. The received voice data is sent to a predefined API, which converts the voice to text data. The input is voice data and the output is text data.

### Step 3:

The server matches the converted text data against a pre-trained database of work procedures. As a result of the cross-checking, the server determines whether the input procedure is correct or not. The input is the text data and the output is the judgment result regarding the correctness of the procedure.

### Step 4:

The server receives the user's facial image acquired through the smart glasses camera. The received face image is sent to the Microsoft Azure Emotion API to analyze the user's emotional state. The input is the face image data and the output is the result of the emotional state analysis.

### Step 5:

The server integrates the results of the determination of the procedure and the analysis of the emotional state and displays them on the smart glasses' display. If the procedure is correct, it displays “The procedure is correct,” and if there is an error, it displays “There is an error in the procedure. If the user is under undue stress, the display will indicate “Please ask the user to pause the work and take a break. The input is the judgment and analysis results, and the output is the message shown on the display.

### Step 6:

The user chooses whether to continue working or take a break according to the message displayed on the smart glasses display. If the user takes a break, the system pauses the work and prompts the user to take a break. The input is the message displayed on the display and the output is the user's action.

### Example 3

Next, example 3 of exemplary embodiment of implement will be described. In the following description, the data processing device 12 is referred to as the “server” and the robot 414 is referred to as the “terminal.”

Conventional work support systems have the ability to determine the accuracy of a worker's movements and procedures, but could not provide feedback that took into account the worker's emotions and stress level. As a result, the worker's emotional burden increased, which could reduce work efficiency and safety. In addition, it was difficult to quickly find areas for improvement in work because the system did not sufficiently collect and analyze the real-time OK/NG judgment of work and emotional data.

The specific processing unit 290 of the data processing device 12 in Example 3 is realized by the following means.

In this invention, the server includes means for learning in advance the information required for the work (procedures, equipment images, past accident cases, etc.), means for inputting the operation screen and the procedures to be performed by voice through a visual device when performing the work, means for judging whether the work is OK/NG and displaying the answer on the visual device, means for The system includes means for collecting and analyzing emotional data, and means for suggesting improvements to the work based on the collected emotional data. This makes it possible to improve work efficiency and safety by providing feedback that takes into account the worker's emotions and stress level.

“Information necessary for the work” refers to data necessary to perform the work accurately and safely, such as procedures, equipment images, and past accidents.

A “visual device” is a device that a worker wears to visually confirm the operation screen and procedures to be performed, and includes smart glasses.

The term “voice input means” refers to technology that allows operators to input operation screens and procedures to be performed using voice, and includes voice recognition technology.

The “OK/NG judgment method” is a technique for evaluating the accuracy and appropriateness of work and feeding the results back to the operator.

Emotional data collection means technology for detecting and collecting data on workers' emotions and stress levels.

The “emotional data analysis means” is technology for analyzing collected emotional data and evaluating changes in workers' emotions and stress levels.

The “means of suggesting improvements in work” is a technique for suggesting measures to improve work procedures and the environment based on the results of emotional data analysis.

This invention is a system to improve the efficiency and safety of workers, and is implemented by clarifying the roles of the server, terminal, and user.

### Server Role

The server provides a means to learn in advance the information required for the work (e.g., procedures, equipment images, past accident cases, etc.). Specifically, the server uses a database management system such as MySQL to collect and store past work data and accident cases. It then trains an AI model on based on the collected data; the AI model uses a machine learning framework such as TensorFlow.

The server will perform the following processes:

1. retrieve historical work data and accident cases from the database

2. preprocess the acquired data and convert it into a format suitable for AI models.

3. train AI models using preprocessed data.

4. save the trained AI model and use it for OK/NG decision of the work.

### Role of the Terminal

The terminal collects data on the work performed by the worker in real time and transmits it to the server. The terminal is equipped with hardware such as cameras and sensors, which are used to collect work data. The collected data is temporarily stored in the terminal and periodically uploaded to the server.

The terminal performs the following processes

1. collect work data using cameras and sensors.

2. temporarily store the collected data.

3. periodically transmit the stored data to the server.

### Role of the User

Users receive feedback provided by the system to help them improve their work. For example, if the system gives a NG decision for a particular task, the user can check the reason and review the work procedure. Also, if the affective engine detects stress in a worker, the user can use that information to improve the work environment.

The user shall do the following:

1. review feedback from the system.

2. review work procedures and environment based on feedback.

3. implement the improvements and again receive feedback on the system.

### Concrete Example

For example, a factory worker is assembling parts. The server trains an AI model based on past assembly data and accident cases, and the terminal collects data by capturing the worker's movements with a camera; the AI model judges whether the work is OK or NG in real time, and notifies the user of the reason if the work is NG. The emotion engine analyzes the worker's facial expression and provides information to the user if the worker is feeling stress.

### Example of Prompt Text

Please design a system that trains AI models based on past work data and accident cases, and determines whether work is OK or NG in real time. Also add a function to analyze the worker's emotions and provide information if they are feeling stressed.”

In this way, the roles of the server, terminal, and user are clarified, and the flow of data processing using specific hardware and software is explained to facilitate understanding of the overall system. The flow of specific processing in Example 3 is explained using FIG. 21.

### Step 1:

### Data Collection

The server collects historical work data and accident cases. Input includes data from each work station in the plant. This includes worker movement logs, sensor data from the work environment, and past accident reports. The server stores these data in a database such as MySQL. As a specific action, the server connects to the database and stores the collected data.

### Step 2:

### Data Preprocessing

The server preprocesses the collected data. As input, there is the raw data collected in step 1. Specific data processing includes completion of missing values, removal of anomalous values, and normalization of data. As output, a dataset in a format suitable for AI models is obtained. As a specific action, the server uses a Python library to clean the data and store the preprocessed data in a new table.

### Step 3:

### AI Model Training

The server trains the AI model using the preprocessed data. As input, there is the preprocessed data set from step 2. As specific data operations, a machine learning framework such as TensorFlow is used to build and train the model. As output, a trained AI model is obtained. As a specific operation, the server inputs training data to TensorFlow, trains the model, and saves the model when training is complete.

### Step 4:

### Real-Time Data Collection and Transmission

The terminal collects data on the work performed by the worker in real time and transmits it to the server. Inputs include data on the worker's movements and the work environment. As specific data collection, data is collected using cameras and sensors and stored temporarily. As output, the collected data is transmitted to the server. As specific operations, the terminal takes pictures of the worker's movements with a camera, collects data on the work environment with a sensor, and periodically transmits the data to the server.

### Step 5:

### OK/NG Judgment of Work

The server inputs the real-time data received into the AI model to determine if the work is OK/NG. As input, there is the real-time data collected in step 4. As specific data operation, data is input to the AI model to obtain the judgment result. As output, OK/NG judgment results are obtained. As specific operations, the server inputs the received data into the AI model, analyzes the output results of the model, judges OK/NG, and sends the judgment results to the terminal.

### Step 6:

### Emotional Data Collection and Aanalysis

The terminal collects the worker's emotional data and sends it to the server. Inputs include the worker's facial expressions and voice data. As specific data collection, data is collected using cameras and microphones and analyzed by the emotion engine. As output, the analyzed emotion data is sent to the server. As specific operations, the terminal captures the worker's facial expressions with a camera, records the worker's voice with a microphone, analyzes the data with the emotion engine, detects changes in emotion, and sends the data to the server.

### Step 7:

### Providing Feedback

Users receive feedback provided by the system to help them improve their work. Input includes the results of the OK/NG decision in Step 5 and the emotional data in Step 6. As specific feedback, the user is provided with suggestions for revising work procedures and improving the environment. As output, the improvement measures are implemented and the system again receives feedback. As a specific action, the user checks the feedback on the terminal screen, reviews the work procedures and environment based on the feedback, executes the improvement measures, and receives the system feedback again.

### Example of Application 3

Next, example 3 of application of example of implement 3 will be described. In the following description, data processing device 12 is referred to as the “server” and robot 414 is referred to as the “terminal.”

Conventional work support systems did not provide sufficiently accurate judgments to improve work efficiency and safety, and did not take into account workers' emotions and stress in proposing improvements. This caused a problem of accumulated stress for workers, resulting in a decrease in work efficiency.

The specific processing by the specific processing unit 290 of the data processing device 12 in example of application 3 is realized by the following means. In this invention, the server has the means to learn in advance the information necessary for the work (procedures, equipment images, past accident cases, etc.), the means to input the operation screen and the procedures to be performed by voice through the smart glasses when performing the work, the means to judge whether the work is OK or NG and display the answer on the smart glasses, the means to collect the emotion data of the worker and to record and analyze the changes in the emotion, the means to propose the improvement of the work procedures based on the emotion data and the work data, and the means to improve the work procedures based on the emotion data. The system includes means to collect emotional data of the worker, record and analyze changes in emotions, and suggest improvements to the work procedure based on the emotional and work data. This enables not only to improve the efficiency and safety of the work, but also to reduce the stress of the workers and to improve the work procedures.

“Information necessary for the work” refers to the data and knowledge required to perform the work, such as work procedures, equipment images, and past accident examples.

The term “means of learning” refers to methods and devices that use artificial intelligence to learn in advance the information necessary for a task.

“Smart glasses” refers to a glasses-type device worn by the worker that provides a visual display of the operating screen and procedures to be performed.

The term “voice input means” refers to methods and devices that allow operators to use their voice to input information on operating screens and procedures to be performed.

The term “means for determining OK/NG” refers to methods and devices for determining the appropriateness of work and displaying the results on smart glasses.

“Emotional data” refers to data indicating the emotional state of the worker, such as the worker's heart rate and skin electrical response.

“Means for recording and analyzing changes in emotions” refers to methods and devices for collecting workers' emotional data, recording and analyzing those changes.

The term “means for suggesting improvements in work procedures” refers to methods and devices for finding and suggesting improvements in work procedures based on emotional and operational data.

The system for implementing this invention has the following structure. First, the server uses artificial intelligence (AI) to learn in advance the information necessary for the work (procedures, equipment images, past accident cases, etc.). Specifically, it learns patterns based on past work data and accident cases, and builds a model to determine whether work is OK or NG.

Next, smart glasses are used as the terminal. The smart glasses are worn by the worker and provide a visual display of the operation screen and procedures to be performed. The worker can use voice recognition technology to input the operation screen and procedures to be performed by voice. This allows the operator to perform operations without using his or her hands, thereby improving work efficiency.

In addition, the server collects emotional data from the worker, recording and analyzing changes in emotions. Emotional data includes heart rate and skin electrical response. These data are collected in real time using an emotion engine. The emotion engine analyzes the worker's emotional state and alerts the worker if stress is elevated.

Finally, the server suggests improvements to work procedures based on the emotional and work data. This will reduce the stress of workers and improve the efficiency of work procedures.

As a concrete example, consider the case of assembling parts in a factory. The server learns from past assembly operation data and accident cases, and builds a model to judge whether the operation is OK or NG. The worker wears smart glasses and inputs operation procedures by voice. The smart glasses visually display the operation screen and procedures so that the worker can perform the operation without using his/her hands. The emotion engine collects the worker's heart rate and skin electrical response in real time and alerts the worker when stress is elevated. The server suggests improvements to work procedures based on the emotional and operational data.

Examples of prompt statements may include the following

Please create a program that uses the current work data and emotion data as inputs to determine if the work is OK or NG and alerts the user if necessary. The work data will include position and speed data, and the emotion data will include heart rate and skin electrical response; the AI model will use a Random Forest classifier, and the emotion engine will use the EmotionEngine class.”

In this way, the exemplary embodiment of the invention can be shown in detail.

The flow of the identification process in example of application 3 is described in FIG. 22.

### Step 1:

The server collects information necessary for the work (procedures, equipment images, past accident cases, etc.) and learns using artificial intelligence (AI). Specifically, using past work data and accident cases as input, the system learns patterns and builds a model to determine whether work is OK or NG. As output, a learned AI model is obtained.

### Step 2:

The user puts on the smart glasses and begins to work. The smart glasses visually display the operation screen and the procedure to be performed. As input, it receives the work procedure data provided by the server, and as output, it provides visual instructions to the user.

### Step 3:

The user uses voice recognition technology to input the operating procedures by voice. Smart Glass converts the voice input into text data and sends it to the server. Receive the user's voice data as input and generate text data as output.

### Step 4:

The server receives text data sent from the smart glasses and judges whether the work is OK or NG using a learned AI model. It uses the text data and the trained AI model as input and data generation model as output to determine if the task is OK or NG.

### Step 5:

The server sends the OK/NG decision results of the work to the smart glasses and displays them visually to the user. Receive the OK/NG decision results as input and provide visual feedback to the user as output.

### Step 6:

The server uses an emotion engine to collect emotional data (e.g., heart rate, skin electrical response, etc.) from the worker in real time. It receives data from emotion sensors as input and generates emotion data as output.

### Step 7:

The server analyzes the collected emotional data and evaluates the stress level of the worker. It uses the emotional data as input and generates the results of the stress level assessment as output.

### Step 8:

The server issues an alert and notifies the smart glasses if the stress level is high. It receives the results of the stress level assessment as input and generates an alert notification as output.

### Step 9:

The server proposes improvements to work procedures based on emotion and work data. It uses emotion and work data as input and generates improvement suggestions as output.

### Step 10:

The server sends suggestions for improving work procedures to the smart glasses and provides a visual display to the user. Receive suggestions for improvement as input and provide visual feedback to the user as output.

The specific processing unit 290 sends the results of the specific processing to the robot 414. In robot 414, control unit 46A causes speaker 240 and control target 443 to output the results of specific processing. Microphone 238 acquires audio indicating user input to the result of the specific processing. The control unit 46A transmits the audio data indicating the user input acquired by the microphone 238 to the data processing device 12. In data processing device 12, specific processing unit 290 acquires the voice data.

The data generation model 58 is the so-called Generative AI (Artificial Intelligence). De

An example of a data generation model 58 is a generated AI such as ChatGPT (Internet search <URL: https://openai.com/blog/chatgpt>). The data generation model 58 is

The data is obtained by having a neural network perform deep learning on a neural network. Prompts containing instructions are input to the data generation model 58, and data for inference, such as voice data indicating voice, text data indicating text, and image data indicating images, are input to the model 58. The data generation model 58 infers the input data for inference according to the instructions indicated by the prompts, and outputs the results of the inference in data formats such as voice data and text data. Here, reasoning refers to, for example, analysis, classification, prediction, and/or summarization.

Another example of generative AI is Gemini (Internet search <URL: https://gemini.google.com/?hl=ja>).

In the above exemplary embodiment, an example of implement in which the specific processing is performed by the data processing device 12 is given, but the technology of the present disclosure is not limited to this, and the specific processing may be performed by the robot 414.

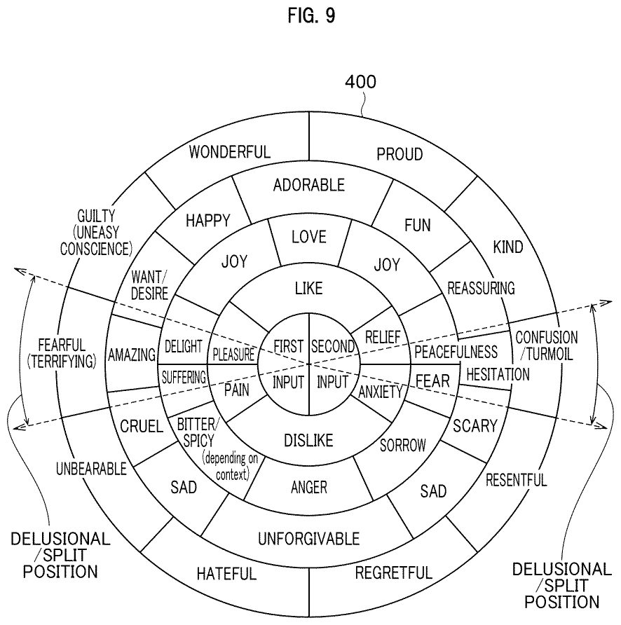

The emotion identification model 59 as the emotion engine may determine the user's emotion according to a specific mapping. Specifically, the emotion identification model 59 may determine the user's emotion according to a particular mapping, the emotion map (see FIG. 9). The emotion identification model 59 may similarly determine the robot's emotion, and the specific processing unit 290 may perform the identification process using the robot's emotion.

FIG. 9 shows an emotion map 400 in which multiple emotions are mapped. In emotion map 400, the emotions are arranged in concentric circles radiating from the center. The closer to the center of the concentric circles, the more primitive state emotions are arranged. The more outward of the concentric circles are placed the emotions that represent states of mind and actions that arise from the state of mind. Emotion is a concept that includes emotional and mental states. On the left side of the concentric circles are the emotions that are generally generated from the reactions that occur in the brain. On the right side of the concentric circles are the emotions that are generally induced by situational judgments. On the upper and lower sides of the concentric circles are the emotions that are generally generated from the reactions that occur in the brain and are guided by situational judgments. In addition, “pleasant” emotions are placed on the upper side of the concentric circles, and “unpleasant” emotions are placed on the lower side. Thus, in emotion map 400, multiple emotions are mapped based on the structure in which emotions are generated, and emotions that tend to occur simultaneously are mapped close together.

These emotions are distributed in the 3 o'clock direction of the emotion map 400 and usually move back and forth between relief and anxiety. In the right half of the emotion map 400, situational awareness predominates over internal sensations, resulting in a calm impression.

Since the inside of the emotion map 400 represents the mind and the outside of the emotion map 400 represents behavior, the further outside of the emotion map 400, the more visible the emotion becomes (expressed in behavior).

Here, human emotions are based on various balances such as posture and blood glucose level, and when these balances move away from the ideal, they are unpleasant, and when they move closer to the ideal, they are pleasant. In robots, cars, motorcycles, etc., emotions can also be created based on various balances such as posture and battery level, with the state of discomfort when these balances move away from the ideal and pleasure when they move closer to the ideal. An emotion map may be generated based on, for example, Dr. Mitsuyoshi's emotion map (Research on Speech Emotion Recognition and Brain Physiological Signal Analysis System for Emotions, The University of Tokushima, PhD thesis: https://ci.nii.ac.jp/naid/500000375379). In the left half of the emotion map, emotions belonging to a region called “reaction,” in which the senses predominate, are lined up. In the right half of the emotion map, emotions belonging to the “situation” domain, in which situational awareness predominates, are lined up.

The emotion map defines two emotions that facilitate learning: one is the emotion around the middle of negative “repentance” or “remorse” on the situational side. That is, when the robot experiences negative emotions such as “I don't want to feel this way again” or “I don't want to be scolded again. The other emotion is around the positive “greed” on the reaction side. In other words, it is when the robot has a positive feeling of “wanting more” or “wanting to know more.”

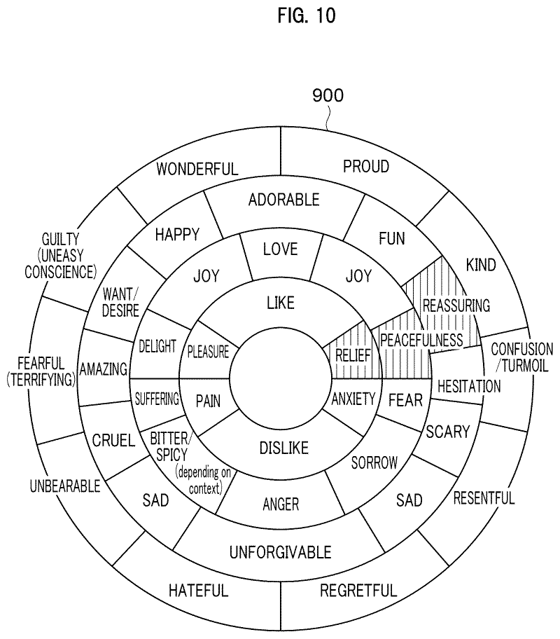

The emotion identification model 59 determines the user's emotion by inputting the user input into a neural network that has been trained in advance and obtaining an emotion value indicating each emotion shown in the emotion map 400. This neural network is pre-trained based on a plurality of training data, which are combinations of user input and emotion values indicating each emotion shown in the emotion map 400. This neural network is also learned so that emotions that are placed close to each other have close values, as shown in the emotion map 900 in FIG. 10. FIG. 10 shows an example in which multiple emotions, such as “safe,” “peaceful,” and “reassuring,” have close emotion values.

In the above exemplary embodiment, an example of implement in which specific processing is performed by one computer 22 is given, but the technology of the present disclosure is not limited to this, and distributed processing for specific processing may be performed by multiple computers including computer 22.

In the above exemplary embodiment, an example of implement in which specific processing program 56 is stored in storage 32 is described, but the technology of the present disclosure is not limited to this. For example, if the specific processing program 56 is stored in a portable computer-readable

The program 56 may be stored in a non-transitory storage medium. The specific processing program 56 stored in the non-transitory storage medium is installed in the computer 22 of the data processing device 12. Processor 28 performs specific processing according to specific processing program 56.

The specific processing program 56 may be stored on a server or other storage device connected to the data processing device 12 via network 54, and the specific processing program 56 may be downloaded and installed on the computer 22 at the request of the data processing device 12.

It is not necessary to have all of the specific processing program 56 stored in a server or other storage device connected to the data processing device 12 via network 54, or to have all of the specific processing program 56 stored in storage 32, but a portion of the specific processing program 56 may be stored.

The following various processors can be used as hardware resources that execute the specific processing. Processors include, for example, CPUs, which are general-purpose processors that function as hardware resources that execute specific processing programs by executing software, i.e., programs. A processor can also be, for example, a field-programmable gate array (FPGA), programmable logic device (PLD), or application-specific integrated circuit (ASIC). designed specifically to perform a particular process.

The most common type of processor is a dedicated electric circuit, which is a processor that has a circuit configuration that has been designed to be used in a specific process. Any processor has a memory built in or connected to it, and any processor performs a specific process by using the memory.

The hardware resource that executes the specific processing may consist of one of these various processors or a combination of two or more processors of the same or different types (e.g., a combination of multiple FPGAs or a CPU and an FPGA). The hardware resource that performs the specific processing may be a single processor.

An example of implementing a single processor is, first, a form in which one processor is composed of a combination of one or more CPUs and software, and this processor functions as a hardware resource that executes a specific process. Second, there is a form that uses a processor that realizes the functions of the entire system, including multiple hardware resources that execute specific processing, in a single IC chip, as typified by a system-on-a-chip (SoC). Thus, the specific processing is realized using one or more of the various processors mentioned above as hardware resources.

Furthermore, the hardware structure of these various processors can be more specifically an electric circuit that combines circuit elements such as semiconductor devices.

In addition, the above specific process is only an example. Therefore, it goes without saying that unnecessary steps may be deleted, new steps may be added, or the order of processing may be replaced to the extent that it does not deviate from the main purpose.

The descriptions and illustrations shown above are detailed descriptions of portions pertaining to the technology of the present disclosure and are only examples of the technology of the present disclosure. For example, the above description of the configuration, functions, actions, and effects is a description of one example of the configuration, functions, actions, and effects of the portion pertaining to the technology of the disclosure. Therefore, it goes without saying that unnecessary portions may be deleted, new elements may be added, or new elements may be substituted for the above description and illustration to the extent that it does not depart from the main purpose of the technology of the present disclosure. In addition, in order to avoid confusion and to facilitate understanding of the parts pertaining to the technology of the present disclosure, explanations regarding technical common sense, etc. that do not require particular explanation to enable implementation of the technology of the present disclosure have been omitted from the descriptions and illustrations shown above.

All references, patent applications, and technical standards described herein are incorporated by reference herein to the same extent that individual references, patent applications, and technical standards are specifically and individually noted as being incorporated by reference.

With respect to the above exemplary embodiments, the following is further disclosed:

(Claim 1)

The system includes means to learn in advance the information required for the work (procedures, equipment images, past accident cases, etc.), means to input the operation screen and the procedures to be performed by voice through the smart glasses when performing the work, and means to judge whether the work is OK or NG and display the answer on the smart glasses.

(Claim 2)

The system of claim 1, wherein the means for learning is performed using artificial intelligence.

(Claim 3)

The system of claim 1, wherein the voice input means is performed using voice recognition technology.

(Claim 4)

The system of claim 1, wherein the system further includes an emotion engine that recognizes the emotions of the worker.

(Claim 5)

The system of claim 4, wherein the emotion engine recognizes emotions from the tone of voice and facial expressions of the worker.

(Claim 6)

The system of claim 4, wherein the emotion engine adjusts work instructions based on the worker's emotions.

### Example 1.″

(Claim 1)

A means of learning in advance the information required for the work (procedures, equipment images, past accidents, etc.),

A means of voice input of the operating screen and the procedure to be carried out through the smart glasses when performing a task. and

A means to determine if the work is OK/NG and display the answer on the smart glasses, Means for analyzing voice data and converting it to text,

A means to generate prompt sentences using a generative AI model and determine if the work is OK/NG,

The system includes.

(Claim 2)

The system of claim 1, wherein the means for learning is performed using artificial intelligence.

(Claim 3)

The system of claim 1, wherein the voice input means is performed using voice recognition technology.

### Example of Application 1.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means of displaying the real-time status of the facility,

A means of displaying past accident examples and alerting the public,

A means of reporting work progress based on voice input,

Means to determine if the work is OK/NG based on the progress of the work, means of displaying the results on the smart glasses display,

The system includes.

(Claim 2)

The system of claim 1, wherein the means for learning is performed using artificial intelligence.

(Claim 3)

The system of claim 1, wherein the voice input means is performed using voice recognition technology.

### Example 2.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means of converting voice data into text data,

A means of analyzing the text data to determine the accuracy of the procedure,

A means of transmitting the results of the determination to the smart glasses, means of displaying the results of the determination on the smart glasses display,

The system includes.

(Claim 2)

The system of claim 1, wherein the means for learning is performed using artificial intelligence.

(Claim 3)

The system of claim 1, wherein the voice input means is performed using voice recognition technology.

### Example of Application 2.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means of determining the voice input procedure in real time and displaying the results on the smart glasses display,

The system includes.

(Claim 2)

The system of claim 1, wherein the means for learning is performed using artificial intelligence.

(Claim 3)

The system of claim 1, wherein the voice input means is performed using voice recognition technology.

### Example 3.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means of obtaining past work data and accident cases from the database and performing pre-processing, means of training an artificial intelligence model using the preprocessed data,

A means to input new work data and determine if the work is OK/NG using an artificial intelligence model,

The system includes means to provide feedback to the user on the results of the decision.

(Claim 2)

The system of claim 1, wherein the means for learning is performed using artificial intelligence.

(Claim 3)

The system of claim 1, wherein the voice input means is performed using voice recognition technology.

### Example of Application 3.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means using artificial intelligence that acquires work data in real time and determines whether work is OK/NG based on past data and accident cases,

The system includes.

(Claim 2)

The system of claim 1, wherein the means for learning is performed using artificial intelligence.

(Claim 3)

The system of claim 1, wherein the voice input means is performed using voice recognition technology.

Example 1 for the combined emotional engine.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means of recognizing the emotions of the worker and adjusting the work instructions accordingly,

The system includes.

(Claim 2)

The system of claim 1, wherein the means for learning is performed using machine learning.

(Claim 3)

The system of claim 1, wherein the voice input means is performed using voice recognition technology.

Example of application 1 when combined with the Emotional Engine.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses, Emotion recognition means to recognize the emotions of the worker,

A means of adjusting the pace of work and instructions according to the emotions of the worker,

The system includes.

(Claim 2)

The system of claim 1, wherein the means for learning is performed using artificial intelligence.

(Claim 3)

The system of claim 1, wherein the voice input means is performed using voice recognition technology.

Example 2 for the combined emotional engine.″

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means to monitor the user's emotional state and, if a certain threshold is exceeded, to pause the work and instruct the user to take a break,

The system includes.

(Claim 2)

The system of claim 1, wherein the means for learning is performed using artificial intelligence.

(Claim 3)

The system of claim 1, wherein the voice input means is performed using voice recognition technology.

Example of application 2 when combined with an “emotional engine.”

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means to monitor the emotional state of the worker and pause the work if he/she feels excessively stressed,

A means of instructing the worker to take a break,

The system includes.

(Claim 2)

The system of claim 1, wherein the means for learning is performed using artificial intelligence.

(Claim 3)

The system of claim 1, wherein the voice input means is performed using voice recognition technology.

Example 3 for the combined emotional engine.”

(Claim 1)

A means of learning in advance the information required for the work (procedures, equipment images, past accidents, etc.),

A means of voice input of operation screens and procedures to be carried out through a visual device when performing tasks,

A means of determining whether the work is OK/NG and displaying the answer on the visual device,

A means of collecting and analyzing the emotional data of the workers,

A means of suggesting improvements to the work based on the collected emotional data,

The system includes.

(Claim 2)

The system of claim 1, wherein the means for learning is performed using artificial intelligence.

(Claim 3)

The system of claim 1, wherein the voice input means is performed using voice recognition technology.

An example of application 3 when combined with an “emotional engine.”

(Claim 1)

A means of learning in advance the information required for the work (procedures, equipment images, past accidents, etc.),

A means of voice input of operation screens and procedures to be carried out through the smart glasses when performing tasks,

A means to determine if the work is OK/NG and display the answer on the smart glasses,

A means of collecting emotional data from workers and recording and analyzing changes in their emotions,

A means of suggesting improvements in work procedures based on emotional and work data,

The system includes.

(Claim 2)

The system of claim 1, wherein the means for learning is performed using artificial intelligence.

(Claim 3)

The system of claim 1, wherein the voice input means is performed using voice recognition technology.

1. A system comprising:
a processor configured to:
display, on smart glasses worn by an operator and for work to be performed by the operator, work procedures and equipment images
receive, from the operator, requests for:
condition of equipment associated with the work, and
past accident cases:
display, on the smart glasses in response to the requests:
information regarding the condition of the equipment associated with the work, and
information regarding the past accident cases, wherein the past accident cases are associated with past mistakes and comprise specific examples of accidents that occurred in the past;
receive voice input from the operator regarding a work task to be performed;
generate prompt sentences based on the content of the voice input from the operator to output the next work procedure;
input the generated prompt sentences into a generative AI model to generate the next work steps;
display the generated next work steps on the smart glasses;
use an emotion engine to recognize the operator's emotions from tone of voice and facial expressions, wherein the emotions comprise the operator being nervous; and
based on the recognized emotions of the operator comprising the operator being nervous, adjust work instructions by slowing a pace of the work.

2. (canceled)

3. The system of claim 1, wherein the processor is further configured to:
use the emotion engine to recognize the operator's emotions from tone of voice and facial expressions; and
instruct the operator to stop working and take a break based on the operator's emotions exceeding a predetermined threshold.

4. The system of claim 1, wherein the processor is configured to:
receive voice input, from the operator, indicating the work is completed;
display, on the smart glasses, an indication of whether the work has been performed properly, wherein the indication comprises an indication that a time for performance of the work was too long.

5. The system of claim 1, wherein the processor is configured to determine, based in part on information associated with the past accident cases, whether performance of the work was satisfactory.

6. The system of claim 1, wherein the processor is configured to display, on the smart glasses, a real-time status of the equipment associated with the work.

7. The system of claim 1, wherein the processor is configured to receive, via voice input from the operator, reporting of progress of the work.

8. The system of claim 1, wherein the processor is configured to:
receive voice input from the operator indicating a work procedure;
validate the indicated work procedure against a database of procedures; and
display, on the smart glasses and based on the validation, an indication that the work procedure is correct and an indication to proceed with the work procedure.

9. The system of claim 1, wherein the processor is configured to:
receive voice input from the operator indicating a work procedure;
check the indicated work procedure against a database of procedures; and
display, on the smart glasses and based on the checking of the indicated work procedure, an indication that the work procedure is incorrect.
